(19) United States
(12) Patent Application Publication
(10) Pub. No.: US 2010/0279244 A1
(43) Pub. Date: Nov. 4, 2010

(54) METHOD OF REMOVING AN ARCHWIRE FROM AN ORTHODONTIC BRACKET AND WIRE DISENGAGEMENT INSTRUMENTS FOR APPLYING SUCH METHOD

(76) Inventor: James A. NICHOLSON, Hattiesburg, MS (US)

Correspondence Address: DOWELL & DOWELL P.C., 103 Oronoco St., Suite 220, Alexandria, VA, 22314, US

(21) Appl. No.: 12/762,105

(22) Filed: Apr. 16, 2010

Related U.S. Application Data
(63) Continuation-in-part of application No. 12/320,036, filed on Jan. 15, 2009.
(60) Provisional application No. 61/021,274, filed on Jan. 15, 2008.

(51) Int. Cl. A61C 7/04; A61C 7/02

(52) U.S. Cl. 433/4; 433/3; 433/24

(57) ABSTRACT

A method for removing an archwire from a slot of an orthodontic bracket having at least one retentive component involving creating a gap either between portions of a retentive component or between the retentive component and another component of the bracket and removing the archwire from the slot through the gap. The present invention is also directed to wire disengagement tools. Each tool includes a handle and a head portion which engages the retentive component. When the orthodontist applies a force, such as a rotational or plier-like motion, to the handle of the tool, the head portion exerts a force on the retentive portion to create a gap between portions of the retentive component or between the retentive component and another component of the orthodontic bracket. Each tool also includes a side arm, which lifts the archwire from the slot through the gap created by the head portion.

### CROSS-REFERENCE TO RELATED APPLICATIONS

This application is a continuation-in-part of U.S. patent application Ser. No. 12/320,036, filed Jan. 15, 2009, and entitled “Wire Disengagement Instrument,” which claims priority to U.S. provisional application No. 61/021,274, filed Jan. 15, 2008, and entitled “Wire Disengagement Instrument,” and this application incorporates by reference herein the subject matter of these applications in their entirety.

### BACKGROUND OF THE INVENTION

1. Field of the Invention

This invention is generally directed to an orthodontic method for removing an archwire from an archwire slot of a bracket and orthodontic instruments for applying such a method to remove an archwire from a bracket. More specifically, the present invention is directed to an orthodontic method and instruments for removing a wire from a bracket having at least one retentive component, such as a clip, latch, or portion of the bracket, namely a tie wing, made from a shape memory material.

2. Brief Description of Related Art

The traditional orthodontic appliance system consists of brackets that are attached directly to a patient's teeth and an archwire that is secured in an archwire slot of each bracket generally by the use of elastomeric and/or metallic ligatures. A new self-ligating orthodontic system, which has become increasingly popular, consists of brackets that do not require the use of elastomeric and/or metallic ligatures to secure and hold an archwire in the archwire slot of a bracket. The new system employs brackets with self-contained retentive mechanisms, such as clips or latches, that make it possible for an orthodontist to place the archwire into the brackets more quickly in a less complicated manner. While the additional components, namely the self-contained clips or latches, make these brackets larger, bulky, and cumbersome to use in the tight confines of a crowed malocclusion that is often seen in orthodontic cases, many orthodontists find the use of self-ligating brackets with clips and latches to be an improvement over conventional orthodontic systems.

Another recent improvement in orthodontic appliances has been the introduction of orthodontic brackets including shape memory materials that can flex to receive and hold an archwire. These self-ligating brackets include at least one retentive component, usually a tie wing, which is at least partially made from a shape memory material and as a result, the bracket construction is smaller and a more compact functional design. The placement of an archwire into an archwire slot of the at least partially formed shape memory self-ligating bracket is accomplished more easily because the archwire exerts a wedge-type lateral force against beveled inner flanges of the head portions of the tie wing posts of each of bracket tie wings which causes the posts to flex laterally and outwardly to receive and retain the archwire into the archwire slot. The tie wing posts then return to their original predetermined position, thereby retaining the archwire in the archwire slot. Specifically, the undersides of the inner portions of the tie wing flanges extend longitudinally along the length of the archwire slot of the tie wing to form a roof of the archwire slot to hold the archwire in the archwire slot.

While the new orthodontic systems which have replaced the conventional elastomeric and metallic ligatures with new and improved retentive components, such as clips, latches, and shape memory materials, these self-ligating systems do present certain drawbacks. For example, with reference to a bracket utilizing at least one clip to secure an archwire, while it is often easy to place an archwire into the clip, it is quite difficult to remove the archwire due to the shape of the clip. Similarly, with regard to a bracket having at least one latch to secure an archwire, the size and bulk of the latch makes it difficult to insert and remove the archwire to and from the archwire slot. As a further example in regard to a bracket having a self-contained retentive component at least partially formed from a shape memory material, the ability of the tie wing flanges to return to their original positions and cover the archwire slot makes it difficult for an orthodontist to disengage and remove the archwire to adjust and/or replace the archwire at the appropriate time during the orthodontic treatment. Specifically, if the orthodontist attempts to pull the archwire vertically out of the archwire slot, the pressure that would be required to deflect the tie wing flanges outwardly from their original positions will cause pain and discomfort to the patient. Not only can this force result in pain and even injury to the patient, it also creates a risk that a bond securing the bracket to the patient's tooth may be broken, thereby dislodging the bracket from the tooth.

### SUMMARY OF THE INVENTION

The present invention is directed to a method for removing an archwire from an archwire slot of an orthodontic bracket having at least one retentive component, such as a clip, latch, or portion of the bracket, namely a tie wing, made from a shape memory material, involving creating a gap either between portions of a retentive component or between the retentive component and another component of the orthodontic bracket and removing the archwire from the archwire slot through the gap. To create the gap and lift the archwire from the slot, the present invention is also directed to orthodontic instruments, namely wire disengagement tools. Each tool includes a handle designed to fit comfortably in the hand of an orthodontist and a head portion which engages the at least one retentive portion of an orthodontic bracket. When the orthodontist applies a force, such as a rotational or plier-like motion, to the handle, the head portion exerts a wedge-like force on the retentive portion to create a gap between portions of the retentive component, for example between the arms of a clip, or between the retentive component and another component of the orthodontic bracket. Each tool also includes a side arm, which lifts the archwire from the archwire slot through the gap created by the head portion.

As a result of the present method and orthodontic instruments, an orthodontist can more easily remove an archwire from a bracket because the method and instruments do not just apply a vertical force to extract the wire from the bracket, but rather first separate the retentive portion of a bracket and then lift the archwire through the separation. Further, this new orthodontic method and wire disengagement instruments will make the removal of the archwire from self-ligating bracket systems a smooth, efficient, and much simpler process and will significantly enhance and improve the orthodontic experience and treatment for both the orthodontist and patients.

### BRIEF DESCRIPTION OF THE DRAWINGS

A better understanding of the invention will be had with reference to the attached drawings wherein:

FIG. 1 is a front perspective view of a twin bracket embodiment showing opposing tie wings being flexed outwardly from their original positions as an archwire is inserted therebetween into an archwire slot;

FIG. 1A is a front perspective view of the twin bracket embodiment illustrated in FIG. 1 showing the opposing tie wings in their original positions covering the archwire slot and the archwire therein;

FIG. 2 is a front perspective view of a twin bracket embodiment illustrated in FIG. 1 showing the opposing tie wings being flexed outwardly from their original positions to create a gap between the inner flanges of the tie wings above the archwire slot;

FIG. 2A is a front perspective view of the twin bracket embodiment illustrated in FIG. 1 showing the archwire being lifted through the gap between the inner flanges of the tie wings;

FIG. 2B is a side view of a twin bracket embodiment illustrated in FIG. 2 showing the opposing tie wings being flexed outwardly from their original positions to create a gap between the inner flanges of the tie wings above the archwire slot;

FIG. 2C is a side view of the twin bracket embodiment illustrated in FIG. 2A showing the archwire being lifted through the gap between the inner flanges of the tie wings;

FIG. 2D is a front perspective view of a twin bracket embodiment illustrated in FIG. 1 showing the side arms of retentive clips being flexed outwardly from their original positions to create a gap between side arms of each clip above the archwire slot;

FIG. 2E is a front perspective view of the twin bracket embodiment illustrated in FIG. 1 showing the archwire being lifted through the gap between the side arms of each of the retentive clips;

FIG. 2F is a side view of a twin bracket embodiment illustrated in FIG. 2D showing the side arms of retentive clips being flexed outwardly from their original positions to create a gap between side arms of each clip above the archwire slot;

FIG. 2G is a side view of the twin bracket embodiment illustrated in FIG. 2E showing the archwire being lifted through the gap between the side arms of each of the retentive clips;

FIG. 2H is a side view of a twin bracket embodiment illustrated in FIG. 1 showing one tie wing post of each of the opposing tie wings being flexed outwardly from its original position to create a gap between each flexible tie wing post and the remainder of the bracket above the archwire slot;

FIG. 2I is a side view of the twin bracket embodiment illustrated in FIG. 1 showing the archwire being lifted through the gap between the flexible tie wing post and the remainder of the bracket;

FIG. 3 is a front perspective view of the twin bracket embodiment illustrated in FIG. 1 showing the wire disengagement tool of the present invention engaging the bracket;

FIG. 3A is a side view of the wire disengagement tool illustrated in FIG. 3;

FIG. 3B is a side view of the wire disengagement tool illustrated in FIG. 3A showing the wire disengagement tool of the present invention engaging an archwire retained in an archwire slot of the bracket;

FIG. 4 is a front perspective view of the wire disengagement tool of FIG. 3 engaging the bracket, wherein the wire disengagement tool includes a grasping means on a side arm;

FIG. 4A is a side view of the wire disengagement tool illustrated in FIG. 4;

FIG. 4B is a side view of the wire disengagement tool illustrated in FIG. 4A showing the wire disengagement tool of the present invention engaging an archwire retained in an archwire slot of the bracket;

FIG. 5 is a front perspective view of the wire disengagement tool of FIG. 3 engaging the bracket, wherein a head portion of the center arm of the wire disengagement tool has a triangular cross-section;

FIG. 5A is a side view of the wire disengagement tool illustrated in FIG. 5;

FIG. 5B is a side view of the wire disengagement tool illustrated in FIG. 5A showing the wire disengagement tool of the present invention engaging an archwire retained in an archwire slot of the bracket;

FIG. 6 is a front perspective view of the wire disengagement tool of FIG. 3 engaging the bracket, wherein the head portion of the center arm of the wire disengagement tool has a triangular cross-section;

FIG. 6A is a side view of the wire disengagement tool illustrated in FIG. 6;

FIG. 6B is a side view of the wire disengagement tool illustrated in FIG. 6A showing the wire disengagement tool of the present invention engaging an archwire retained in an archwire slot of the bracket;

FIG. 7 is a front perspective view of the wire disengagement tool of the FIG. 3 engaging the bracket, wherein the head portion of the center arm of the wire disengagement tool has a generally V-shaped cross-section;

FIG. 7A is a side view of the wire disengagement tool illustrated in FIG. 7;

FIG. 7B is a side view of the wire disengagement tool illustrated in FIG. 7A showing the wire disengagement tool of the present invention engaging an archwire retained in an archwire slot of the bracket;

FIG. 8 is a front perspective view of the wire disengagement tool of the FIG. 3 engaging the bracket, wherein the head portion of the center arm of the wire disengagement tool has a generally V-shaped cross-section;

FIG. 8A is a side view of the wire disengagement tool illustrated in FIG. 8;

FIG. 8B is a side view of the wire disengagement tool illustrated in FIG. 8A showing the wire disengagement tool of the present invention engaging an archwire retained in an archwire slot of the bracket;

FIG. 9 is a side view the head portion of the center arm of the wire disengagement tool of the present invention, wherein the head portion has a toothed engaging surface comprising a plurality of teeth each having a triangular cross-section;

FIG. 9A is a side view of the had portion of the center arm of the wire disengagement tool of the present invention, wherein the head portion has a toothed engaging surface comprising a plurality of teeth each having a rectangular cross-section;

FIG. 9B is a top view of the toothed engaging surface of the wire disengagement tool illustrated in FIG. 9A;

FIG. 10 is a side view of the head portion of the center arm of the wire disengagement tool of the present invention, wherein the head portion has a padded engaging surface;

FIG. 11 is a front perspective view of the wire disengagement tool of FIG. 3 engaging the bracket, wherein head portion of the center arm of the wire disengagement tool has a concave surface;

FIG. 11A is a front perspective view of the wire disengagement tool of FIG. 11 engaging the bracket, wherein the wire disengagement tool includes a grasping means on a side arm;

FIG. 12 is a side view of the wire disengagement tool illustrated in FIG. 11;

FIG. 12A is a side view of the wire disengagement tool illustrated in FIG. 12 showing the wire disengagement tool of the present invention engaging an archwire retained in an archwire slot of the bracket;

FIG. 12B is a side view of the wire disengagement tool illustrated in FIG. 11A;

FIG. 12C is a side view of the wire disengagement tool illustrated in FIG. 12B showing the wire disengagement tool of the present invention engaging an archwire retained in an archwire slot of the bracket;

FIG. 12D is a side view of the wire disengagement tool of FIG. 11 engaging the bracket, wherein the wire disengagement tool includes a positioning means with a rectangular cross-section on a side arm;

FIG. 12E is a side view of the wire disengagement tool illustrated in FIG. 12D showing the wire disengagement tool of the present invention engaging an archwire retained in an archwire slot of the bracket;

FIG. 12F is a side view of the wire disengagement tool illustrated in FIG. 11 engaging the bracket, wherein the wire disengagement tool includes a positioning means with a generally V-shaped cross-section on a side arm;

FIG. 12G is a side view of the wire disengagement tool illustrated in FIG. 12F showing the wire disengagement tool of the present invention engaging an archwire retained in an archwire slot of the bracket;

FIG. 13 is a front perspective view of an alternate embodiment of the wire disengagement tool of the present invention, wherein the center arm approaches an orthodontic bracket in a direction that is approximately 45° to the bracket base;

FIG. 14 is a side view of the wire disengagement tool illustrated in FIG. 13 engaging a bracket;

FIG. 14A is a side view of the wire disengagement tool illustrated in FIG. 14 showing the wire disengagement tool of the present invention engaging an archwire retained in an archwire slot of the bracket;

FIG. 15 is a front perspective view of an alternate embodiment of the wire disengagement tool of the present invention, wherein the center arm approaches an orthodontic bracket in a direction that is perpendicular to the bracket base;

FIG. 16 is a side view of the wire disengagement tool illustrated in FIG. 15 engaging a bracket;

FIG. 16A is a side view of the wire disengagement tool illustrated in FIG. 16 showing the wire disengagement tool of the present invention engaging an archwire retained in an archwire slot of the bracket;

FIG. 16B is a side view of the wire disengagement tool of FIG. 15 engaging the bracket, wherein the side arms include a third arm portion;

FIG. 16C is a side view of the wire disengagement tool illustrated in FIG. 16B showing the wire disengagement tool of the present invention engaging an archwire retained in an archwire slot of the bracket;

FIG. 17 is a front perspective view of another embodiment of the wire disengagement tool of the present invention;

FIG. 17A is a front perspective view of the wire disengagement tool illustrated in FIG. 17, wherein the head portion has an increased thickness at each end;

FIG. 17B is a front perspective view of the wire disengagement tool illustrated in FIG. 17, wherein the head portion has a tapered increased thickness at each end;

FIG. 17C is a front perspective view of the wire disengagement tool illustrated in FIG. 17, wherein the handle extends generally parallel to the head portion;

FIG. 17D is a front perspective view of the wire disengagement tool illustrated in FIG. 17, wherein the handle extends generally perpendicularly to the head portion and is bent;

FIG. 17E is a front perspective view of the wire disengagement tool illustrated in FIG. 17, wherein the handle is a loop and the side arms include a third arm portion;

FIG. 17F is a front perspective view of the wire disengagement tool illustrated in FIG. 17, wherein the handle is a hollow rectangular that extends in the same plane as the head portion and the side arms include a third arm portion;

FIG. 17G is a front perspective view of the wire disengagement tool illustrated in FIG. 17, wherein the handle is a hollow rectangular that extends in a different plane that the head portion and the side arms include a third arm portion;

FIG. 18 is a front perspective view of the wire disengagement tool illustrated in FIG. 17 engaging a bracket;

FIG. 18A is a front perspective view of the wire disengagement tool illustrated in FIG. 17 showing the wire disengagement tool of the present invention engaging an archwire retained in an archwire slot of the bracket;

FIG. 19 is a side view of the wire disengagement tool illustrated in FIG. 17 engaging a bracket, wherein the side arms approach the bracket from a first direction and are generally parallel to the bracket base;

FIG. 19A is a side view of the wire disengagement tool illustrated in FIG. 17 showing the wire disengagement tool of the present invention engaging an archwire retained in an archwire slot of the bracket;

FIG. 19B is a side view of the wire disengagement tool illustrated in FIG. 17 engaging a bracket, wherein the side arms are at approximately a 45° angle to the bracket base;

FIG. 19C is a side view of the wire disengagement tool illustrated in FIG. 19B showing the wire disengagement tool of the present invention engaging an archwire retained in an archwire slot of the bracket;

FIG. 19D is a side view of the wire disengagement tool illustrated in FIG. 17 engaging a bracket, wherein the side arms approach the bracket from a second direction opposite the first direction and are generally parallel to the bracket base;

FIG. 19E is a side view of the wire disengagement tool illustrated in FIG. 19D showing the wire disengagement tool of the present invention engaging an archwire retained in an archwire slot of the bracket;

FIG. 19F is a side view of the wire disengagement tool illustrated in FIG. 19, wherein the side arm includes a grasping means;

FIG. 19G is a side view of the wire disengagement tool illustrated in FIG. 19F showing the wire disengagement tool of the present invention engaging an archwire retained in an archwire slot of the bracket;

FIG. 19H is a side view of the wire disengagement tool illustrated in FIG. 17 engaging a bracket, wherein the side arms are generally perpendicular to the bracket base;

FIG. 19I is a side view of the wire disengagement tool illustrated in FIG. 19H showing the wire disengagement tool of the present invention engaging an archwire retained in an archwire slot of the bracket;

FIG. 19J is a side view of the wire disengagement tool illustrated in FIG. 19E engaging a bracket, wherein the side arms are at generally perpendicular to the bracket base;

FIG. 19K is a side view of the wire disengagement tool illustrated in FIG. 19J showing the wire disengagement tool of the present invention engaging an archwire retained in an archwire slot of the bracket by rotating the tool in a first direction;

FIG. 19L is a side view of the wire disengagement tool illustrated in FIG. 19J showing the wire disengagement tool of the present invention engaging an archwire retained in an archwire slot of the bracket by rotating the tool in a second direction that is opposite the first direction;

FIG. 19M is a side view of the wire disengagement tool illustrated in FIG. 19E engaging a bracket, wherein the side arms are at generally perpendicular to the bracket base;

FIG. 19N is a side view of the wire disengagement tool illustrated in FIG. 19J showing the wire disengagement tool of the present invention engaging an archwire retained in an archwire slot of the bracket by rotating the tool in a first direction;

FIG. 20 is a front perspective view of the wire disengagement tool illustrated in FIG. 17 engaging a bracket, wherein head portion of the wire disengagement tool has a concave surface;

FIG. 20A is a front perspective view of the wire disengagement tool illustrated in FIG. 20 showing the wire disengagement tool of the present invention engaging an archwire retained in an archwire slot of the bracket;

FIG. 21 is a side view of the wire disengagement tool illustrated in FIG. 20 engaging a bracket, wherein the side arms approach the bracket from a first direction and are generally parallel to the bracket base;

FIG. 21A is a side view of the wire disengagement tool illustrated in FIG. 20 showing the wire disengagement tool of the present invention engaging an archwire retained in an archwire slot of the bracket;

FIG. 21B is a side view of the wire disengagement tool illustrated in FIG. 20 engaging a bracket, wherein the side arms are at approximately a 45° angle to the bracket base;

FIG. 21C is a side view of the wire disengagement tool illustrated in FIG. 21B showing the wire disengagement tool of the present invention engaging an archwire retained in an archwire slot of the bracket;

FIG. 21D is a side view of the wire disengagement tool illustrated in FIG. 20 engaging a bracket, wherein the side arms approach the bracket from a second direction opposite the first direction and are generally parallel to the bracket base;

FIG. 21E is a side view of the wire disengagement tool illustrated in FIG. 21D showing the wire disengagement tool of the present invention engaging an archwire retained in an archwire slot of the bracket;

FIG. 22 is a front perspective view of another embodiment of the wire disengagement tool of the present invention;

FIG. 23 is a front perspective view of the wire disengagement tool illustrated in FIG. 22 engaging a bracket;

FIG. 23A is a front perspective view of the wire disengagement tool illustrated in FIG. 23 showing the wire disengagement tool of the present invention engaging an archwire retained in an archwire slot of the bracket;

FIG. 24 is a side view of the wire disengagement tool illustrated in FIG. 22 engaging a bracket, wherein the side arms approach the bracket from a first direction and are generally parallel to the bracket base;

FIG. 24A is a side view of the wire disengagement tool illustrated in FIG. 24 showing the wire disengagement tool of the present invention engaging an archwire retained in an archwire slot of the bracket;

FIG. 25 is a front perspective view of another embodiment of the wire disengagement tool of the present invention having a pivot bar in addition to the head portion;

FIG. 26 is a front perspective view of the wire disengagement tool illustrated in FIG. 25 engaging a bracket;

FIG. 26A is a front perspective view of the wire disengagement tool illustrated in FIG. 26 showing the wire disengagement tool of the present invention engaging an archwire retained in an archwire slot of the bracket;

FIG. 27 is a side view of the wire disengagement tool illustrated in FIG. 25 engaging a bracket, wherein the side arms approach the bracket from a first direction and are generally parallel to the bracket base;

FIG. 27A is a side view of the wire disengagement tool illustrated in FIG. 27 showing the wire disengagement tool of the present invention engaging an archwire retained in an archwire slot of the bracket;

FIG. 28 is a front perspective view of another embodiment of the wire disengagement tool of the present invention having a handle that extends perpendicularly to the head portion;

FIG. 28A is a front perspective view of the wire disengagement tool of FIG. 28 having a handle that extends parallel to the head portion;

FIG. 29 is a front perspective view of the wire disengagement tool illustrated in FIG. 28 engaging a bracket;

FIG. 29A is a front perspective view of the wire disengagement tool illustrated in FIG. 29 showing the wire disengagement tool of the present invention engaging an archwire retained in an archwire slot of the bracket;

FIG. 30 is a side view of the wire disengagement tool illustrated in FIG. 28 engaging a bracket, wherein the head portion has a concave surface;

FIG. 30A is a side view of the wire disengagement tool illustrated in FIG. 30 showing the wire disengagement tool of the present invention engaging an archwire retained in an archwire slot of the bracket;

FIG. 30B is a side view of the wire disengagement tool illustrated in FIG. 28 engaging a bracket, wherein the wire disengagement tool includes a positioning means with a V-shaped cross-section on a side arm;

FIG. 30C is a side view of the wire disengagement tool illustrated in FIG. 30B showing the wire disengagement tool of the present invention engaging an archwire retained in an archwire slot of the bracket;

FIG. 30D is a side view of the wire disengagement tool illustrated in FIG. 28 engaging a bracket, wherein the head portion has a square cross-section and a side arm includes a positioning means with a V-shaped cross-section;

FIG. 30E is a side view of the wire disengagement tool illustrated in FIG. 30D showing the wire disengagement tool of the present invention engaging an archwire retained in an archwire slot of the bracket;

FIG. 30F is a side view of the wire disengagement tool illustrated in FIG. 28 engaging a bracket, wherein the head portion has a rectangular cross-section and a side arm includes a positioning means with a V-shaped cross-section;

FIG. 30G is a side view of the wire disengagement tool illustrated in FIG. 30F showing the wire disengagement tool of the present invention engaging an archwire retained in an archwire slot of the bracket;

FIG. 30H is a side view of the wire disengagement tool illustrated in FIG. 28 engaging a bracket, wherein the head portion has a toothed engaging surface comprising a plurality of teeth each having a triangular cross-section and a side arm includes a positioning means with a V-shaped cross-section;

FIG. 30I is a side view of the wire disengagement tool illustrated in FIG. 30H showing the wire disengagement tool of the present invention engaging an archwire retained in an archwire slot of the bracket;

FIG. 30J is a side view of the wire disengagement tool illustrated in FIG. 28 engaging a bracket, wherein the head portion has a toothed engaging surface comprising a plurality of teeth each having a rectangular cross-section and a side arm includes a positioning means with a V-shaped cross-section;

FIG. 30K is a side view of the wire disengagement tool illustrated in FIG. 30J showing the wire disengagement tool of the present invention engaging an archwire retained in an archwire slot of the bracket;

FIG. 31 is a front perspective view of another embodiment of the wire disengagement tool of the present invention, wherein wire disengagement tool includes a grasping means on a side arm;

FIG. 32 is a front perspective view of the wire disengagement tool illustrated in FIG. 31 engaging a bracket;

FIG. 32A is a front perspective view of the wire disengagement tool illustrated in FIG. 32 showing the wire disengagement tool of the present invention engaging an archwire retained in an archwire slot of the bracket;

FIG. 33 is a side view of the wire disengagement tool illustrated in FIG. 31 engaging a bracket, wherein the head portion has a concave surface;

FIG. 33A is a side view of the wire disengagement tool illustrated in FIG. 33 showing the wire disengagement tool of the present invention engaging an archwire retained in an archwire slot of the bracket;

FIG. 33B is a side view of the wire disengagement tool illustrated in FIG. 31 engaging a bracket, wherein the wire disengagement tool includes a positioning means with a rectangular cross-section on a side arm;

FIG. 33C is a side view of the wire disengagement tool illustrated in FIG. 33B showing the wire disengagement tool of the present invention engaging an archwire retained in an archwire slot of the bracket;

FIG. 34 is a side view of the wire disengagement tool illustrated in FIG. 31 engaging a bracket, wherein the head portion is wedge-shaped;

FIG. 34A is a side view of the wire disengagement tool illustrated in FIG. 34 showing the wire disengagement tool of the present invention engaging an archwire retained in an archwire slot of the bracket;

FIG. 35 is a front perspective view of an alternate embodiment of the wire disengagement tool of the present invention, wherein the head portion has a concave surface and the center arm approaches an orthodontic bracket in a direction that is perpendicular to the bracket base;

FIG. 35A is a front perspective view of the wire disengagement tool of FIG. 28 having a handle that extends parallel to the head portion;

FIG. 36 is a front perspective view of the wire disengagement tool illustrated in FIG. 35 engaging a bracket;

FIG. 36A is a front perspective view of the wire disengagement tool illustrated in FIG. 36 showing the wire disengagement tool of the present invention engaging an archwire retained in an archwire slot of the bracket;

FIG. 37 is a side view of the wire disengagement tool illustrated in FIG. 35 engaging a bracket;

FIG. 37A is a side view of the wire disengagement tool illustrated in FIG. 37 showing the wire disengagement tool of the present invention engaging an archwire retained in an archwire slot of the bracket;

FIG. 37B is a side view of the wire disengagement tool illustrated in FIG. 35 engaging a bracket, wherein the wire disengagement tool includes a positioning means with a rectangular cross-section on a side arm;

FIG. 37C is a side view of the wire disengagement tool illustrated in FIG. 37B showing the wire disengagement tool of the present invention engaging an archwire retained in an archwire slot of the bracket;

FIG. 37D is a side view of the wire disengagement tool illustrated in FIG. 35 engaging a bracket, wherein the wire disengagement tool includes a positioning means with a V-shaped cross-section on a side arm;

FIG. 37E is a side view of the wire disengagement tool illustrated in FIG. 37D showing the wire disengagement tool of the present invention engaging an archwire retained in an archwire slot of the bracket;

FIG. 37F is a side view of the wire disengagement tool illustrated in FIG. 35 engaging a bracket, wherein the wire disengagement tool includes a positioning means with a V-shaped cross-section on a side arm and the head portion has a concave shape;

FIG. 37G is a side view of the wire disengagement tool illustrated in FIG. 37F showing the wire disengagement tool of the present invention engaging an archwire retained in an archwire slot of the bracket;

FIG. 38 is a side view of the wire disengagement tool illustrated in FIG. 35 engaging a bracket, wherein the wire disengagement tool includes a grasping means on a side arm and the head portion has a wedge shape;

FIG. 38A is a side view of the wire disengagement tool illustrated in FIG. 38 showing the wire disengagement tool of the present invention engaging an archwire retained in an archwire slot of the bracket;

FIG. 38B is a side view of the wire disengagement tool illustrated in FIG. 35 engaging a bracket, wherein the head portion has a truncated wedge shape;

FIG. 38C is a side view of the wire disengagement tool illustrated in FIG. 38B showing the wire disengagement tool of the present invention engaging an archwire retained in an archwire slot of the bracket;

FIG. 38D is a side view of the wire disengagement tool illustrated in FIG. 35 engaging a bracket, wherein the wire disengagement tool includes a grasping means on a side arm and the head portion has a truncated wedge shape;

FIG. 38E is a side view of the wire disengagement tool illustrated in FIG. 38D showing the wire disengagement tool of the present invention engaging an archwire retained in an archwire slot of the bracket;

FIG. 39 is a front perspective view of an alternate embodiment of the wire disengagement tool of the present invention, wherein the head portion has a concave surface and the center arm approaches an orthodontic bracket in a direction that is approximately 45° to the bracket base;

FIG. 39A is a front perspective view of the wire disengagement tool of FIG. 28 having a handle that extends parallel to the head portion;

FIG. 40 is a side view of the wire disengagement tool illustrated in FIG. 39 engaging a bracket;

FIG. 40A is a side view of the wire disengagement tool illustrated in FIG. 40 showing the wire disengagement tool of the present invention engaging an archwire retained in an archwire slot of the bracket;

FIG. 41 is a front perspective view of an alternate embodiment of the wire disengagement tool of the present invention, wherein the center arm approaches an orthodontic bracket in a direction that is perpendicular to the bracket base and has a concave surface;

FIG. 41A is a front perspective view of the wire disengagement tool of FIG. 41 having a split head portion;

FIG. 42 is a side view of the wire disengagement tool of FIG. 41 engaging the bracket, wherein the side arms include a third arm portion;

FIG. 42A is a side view of the wire disengagement tool illustrated in FIG. 42 showing the wire disengagement tool of the present invention engaging an archwire retained in an archwire slot of the bracket;

FIG. 42B is a side view of the wire disengagement tool of FIG. 41 engaging the bracket, wherein the side arms include a third arm portion and the head portion has a wedge shape with a triangular cross-section;

FIG. 42C is a side view of the wire disengagement tool illustrated in FIG. 42B showing the wire disengagement tool of the present invention engaging an archwire retained in an archwire slot of the bracket;

FIG. 42D is a side view of the wire disengagement tool of FIG. 41 engaging the bracket, wherein the side arms include a third arm portion and the head portion has a truncated wedge shape;

FIG. 42E is a side view of the wire disengagement tool illustrated in FIG. 42D showing the wire disengagement tool of the present invention engaging an archwire retained in an archwire slot of the bracket.

FIG. 43 is a front perspective view of an alternate embodiment of the wire disengagement tool of the present invention, wherein the center arm approaches an orthodontic bracket in a direction that is perpendicular to the bracket base and has projections on either end of the center arm for engaging clips and wherein the side arms have a positioning means with a V-shaped cross-section and include a third arm portion having a similar position means;

FIG. 44 is a side view of the wire disengagement tool of FIG. 43 engaging the bracket with retentive clips;

FIG. 44A is a side view of the wire disengagement tool illustrated in FIG. 44 showing the wire disengagement tool of the present invention engaging an archwire retained in an archwire slot of the bracket;

FIG. 44B is a side view of the wire disengagement tool of FIG. 43 engaging the bracket; wherein the head portion has a toothed engaging surface comprising a plurality of teeth each having a triangular cross-section;

FIG. 44C is a side view of the wire disengagement tool illustrated in FIG. 44B showing the wire disengagement tool of the present invention engaging an archwire retained in an archwire slot of the bracket;

FIG. 44D is a side view of the wire disengagement tool of FIG. 43 engaging the bracket; wherein the head portion has a toothed engaging surface comprising a plurality of teeth each having a rectangular cross-section; and

FIG. 44E is a side view of the wire disengagement tool illustrated in FIG. 44D showing the wire disengagement tool of the present invention engaging an archwire retained in an archwire slot of the bracket.

### DETAILED DESCRIPTION OF THE PREFERRED EMBODIMENT

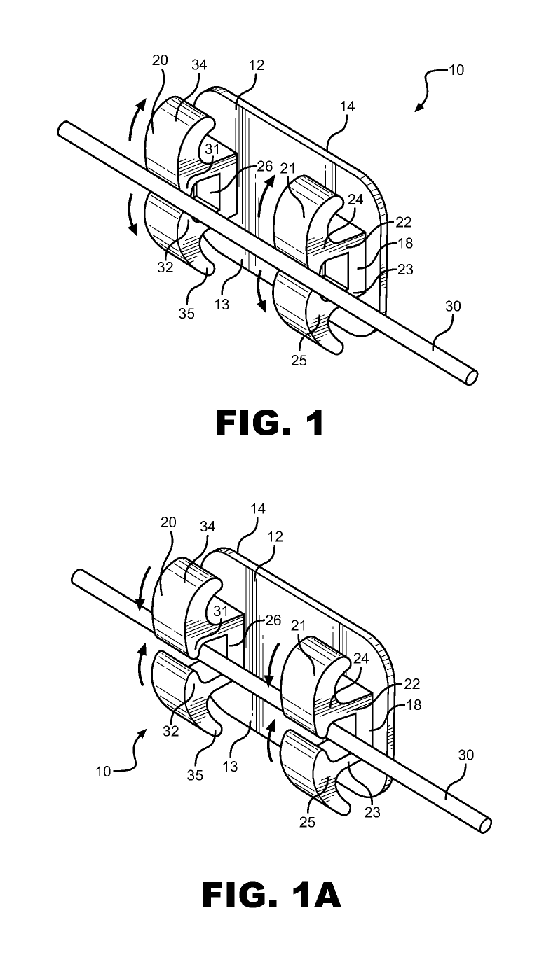

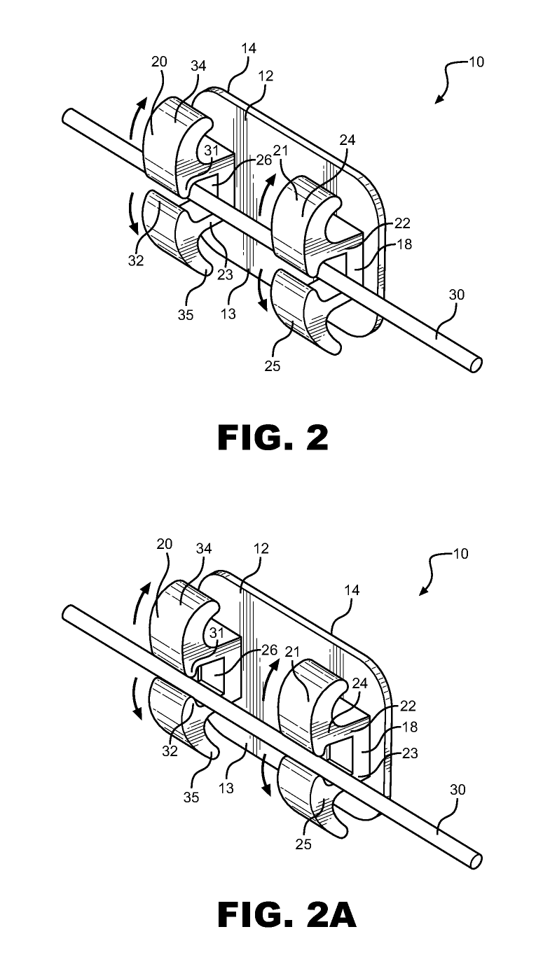

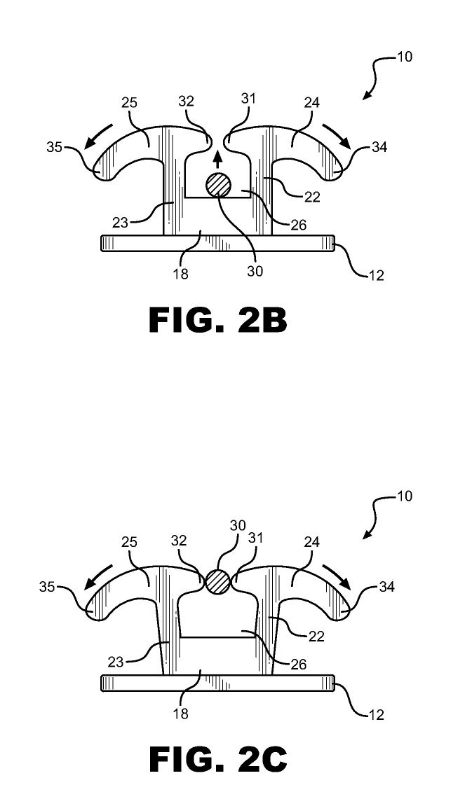

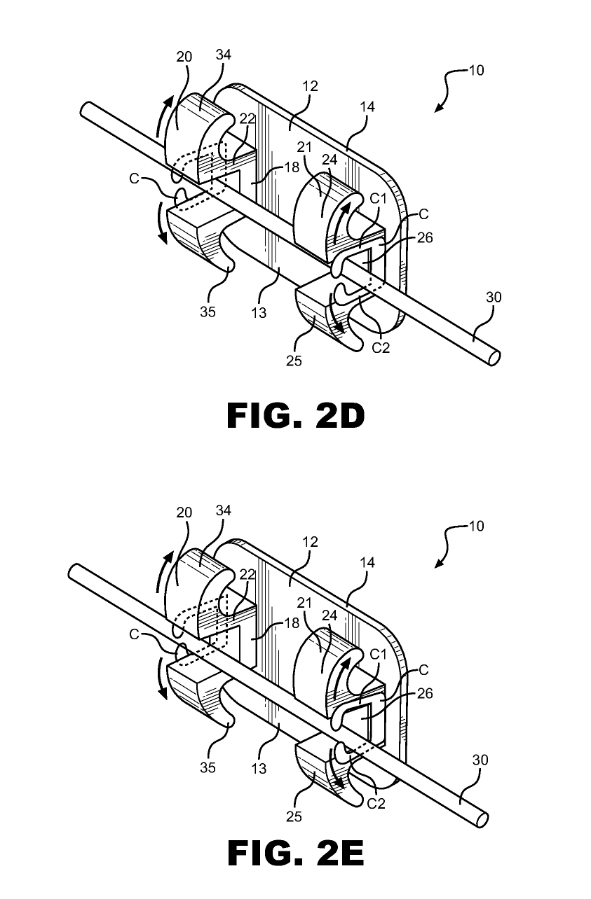

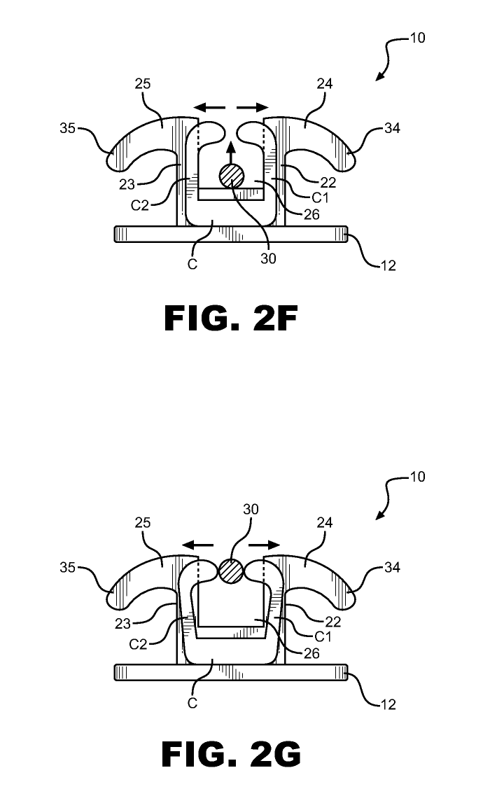

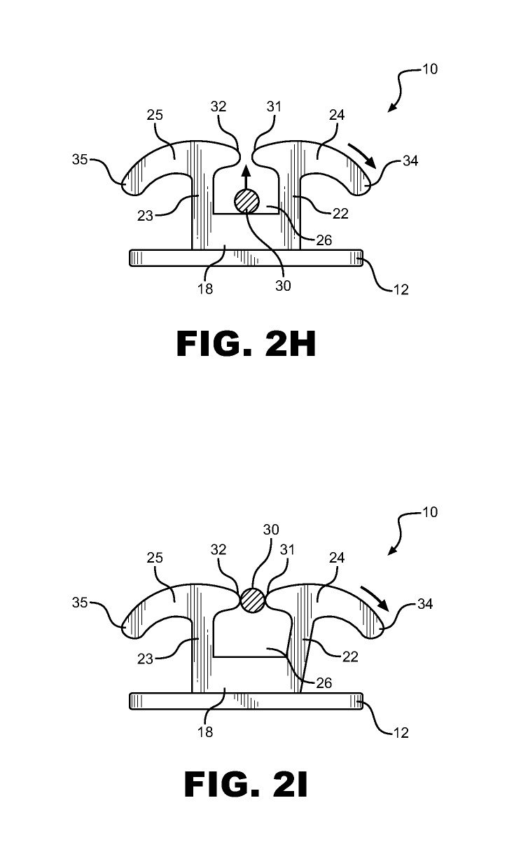

An orthodontic bracket 10 comprises a body structure including a contoured base 12 with a front surface 13 and a rear tooth engaging surface 14. The rear surface 14 is generally slightly concavely contoured so as to match the surface contour of a patient's tooth. The bracket 10 further comprises a retentive component, such as a tie wing, clip, or latch, for retaining an archwire. As shown in at least FIGS. 1 and 2, the bracket 10 is preferably a twin bracket having a pair of spaced opposing tie wings 20 and 21. However, the bracket 10 may be any type of orthodontic bracket, including a single tie wing bracket, and the bracket 10 may include any number of tie wings, which may be positioned in various positions on the bracket 10. Further, the bracket 10 may include attachments or features, such as Kobayashi hooks, removeable hook pins, clips, latches, ligature wires, directional force elastics, elastomeric ligatures, elastomeric power chains, uprighting springs, slots, such as vertical slots, hooks, central recesses, scribe lines, such as vertical scribe lines, and identification recesses, such as colored identification recesses.

Each of the tie wings 20 and 21 includes a base portion 18 from which extend a pair of tie wing posts 22 and 23. Alternatively, the tie wings 20 and 21 are formed such that the posts extend upwardly from the front surface 13 of the bracket base 12. Each of the tie wing posts 22 and 23 includes an upper head portion 24 and 25, respectively. Each pair of the generally parallel posts 22 and 23 define an archwire guide slot 26 of approximately 0.018 to 0.022 inch therebetween to slidingly engage an archwire 30.

The bracket 10 is self-ligating, so at least a portion of the bracket 10, namely the retentive component, is formed from a shape memory material. The shape memory material is preferably a nickel-titanium material, but any suitable material, such as metallic materials, including alloys, and non-metallic materials, including resins and polymer-type materials, that exhibits a shape memory may be used. In the preferred embodiment, both of the opposing pair of tie wings 20 and 21 are at least partially formed of a material which allows the tie wings 20 and 21 to flex to permit insertion or removal of the archwire 30 relative to the guide slot 26. When the posts 22 and 23 are flexed from a predetermined original or rest position, as shown by the arrows in FIG. 1, the head portions 24 and 25 of each tie wing separate to permit the insertion or removal of the archwire 30. Once force is removed, the posts 22 and 23 return to their original predetermined position, as shown by the arrows in FIG. 1A.

In another embodiment, the retentive component is only one tie wing post 22 of each of the opposing pair of tie wings 20 and 21 that is at least partially formed of a material which allows the tie wing post 23 to flex to permit insertion or removal of the archwire 30 relative to the guide slot 26. In yet a different embodiment, if the retentive component is a generally U-shaped clip having flexible side arms, and in another embodiment, the the retentive component is a latch.

To securely retain an archwire 30 within the guide slot 26, each head portion 24 and 25 of each tie wing post 22 and 23, respectively, includes an inner opposing flange 31 and 32, respectively. The inner flanges 31 and 32 are spaced at a distance of approximately 0.010-0.014 inch which is smaller than the diameter of the archwire 30. In some embodiments, the flanges 31 and 32 may actually touch one another such that the distance is zero. Further, the inner flanges 31 and 32 may be the same size or different sizes

Each head portion 24 and 25 of each tie wing post 22 and 23, respectively, further includes an outer tie wing flange 34 and 35, respectively, which may be used in a conventional manner to secure archwires with ligature wires and other attachments during patient treatment, as necessary. In the preferred embodiments, the entire outer surface of each of the head portions 24 and 25 is shown as being generally convex with the inner flanges 31 and 32, respectively, tapering downwardly and inwardly relative to one another.

To disengage and remove the archwire 30 from the archwire guide slot 26, the present invention offers a two-step orthodontic method. The first step involves separating the retentive component of an orthodontic bracket to create a gap either between portions of the retentive component itself or between the retentive component and another portion of the bracket. With respect to the orthodontic bracket 10 shown in FIGS. 1-2C, the retentive component is the tie wings 20 and 21, which are at least partially formed from shape memory material. Since the retentive component is flexible tie wings 20 and 21, the first step involves flexing the tie wings 20 and 21 laterally outwardly to separate the head portions 24 and 25 of the tie wings 20 and 21, respectively, and create a sizeable gap between the inner flanges 31 and 32 above the archwire slot 26, as shown in FIGS. 2 and 2B.

Once there is a gap above the archwire guide slot 26, the second step of the orthodontic method involves lifting the archwire 30 from the slot 26 through the gap, as shown in FIGS. 2A and 2C. Further, depending on the position of the gap and the size of the archwire 30, the second step of the method also involves aligning archwire 30 with the gap to assure the archwire will easily pass through gap as it is lifted from the slot 26. In light of this two-step method of first separating a retentive component to create a gap and then lifting an archwire through a gap, an orthodontist can easily remove an archwire from an orthodontic bracket with less force and consequently less pain and discomfort to a patient.

In a different embodiment shown in FIGS. 2D-2G, the retentive component is a generally U-shaped clip C having flexible side arms C1 and C2, which are at least partially formed from shape memory material. Since the retentive component is a flexible clip, the first step involves flexing the side arms C1 and C2 laterally outwardly to separate the side arms C1 and C2 and create a sizeable gap between the side arms C1 and C2 above the archwire slot 26, as shown in FIGS. 2D and 2F. Once there is a gap above the archwire guide slot 26, the second step of the orthodontic method involves lifting the archwire 30 from the slot 26 through the gap, as shown in FIGS. 2E and 2G.

In a different embodiment shown in FIGS. 2H and 2I, the retentive component is at least one of the tie wing posts 22 of each of the tie wings 20 and 21, which is at least partially formed from shape memory material. Since the retentive component is a flexible tie wing post 22, the first step involves flexing the tie wing post 22 laterally outwardly to separate the head portion 24 24 of the tie wing post 22 of each of the tie wings 20 and 21 and create a sizeable gap between the inner flange 31 of the tie wing post 22 of each of the tie wings 20 and 21 and the remainder of the orthodontic bracket 10, namely the inner flange 32 of the inflexible tie wing post 23 of each of the tie wings 20 and 21, above the archwire slot 26, as shown in FIG. 2H. Once there is a gap above the archwire guide slot 26, the second step of the orthodontic method involves lifting the archwire 30 from the slot 26 through the gap, as shown in FIG. 2I.

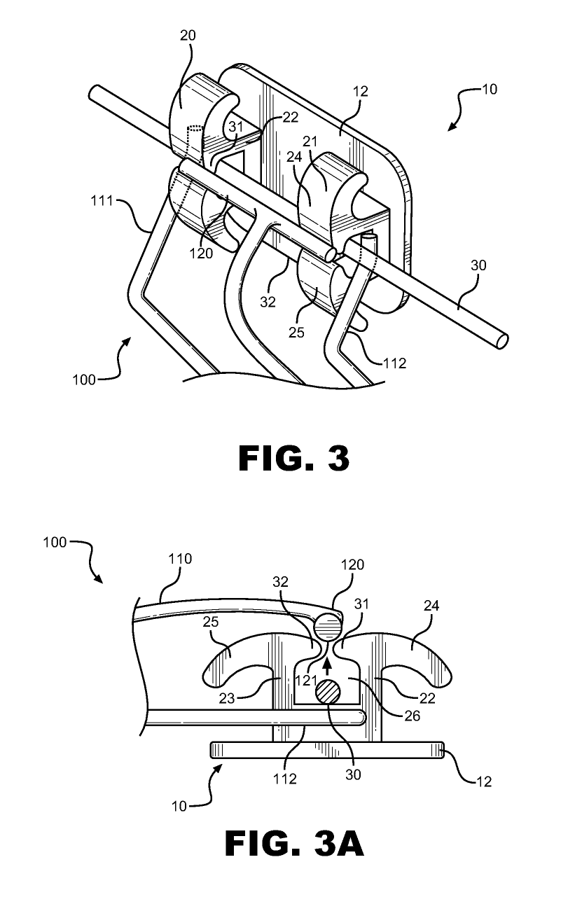

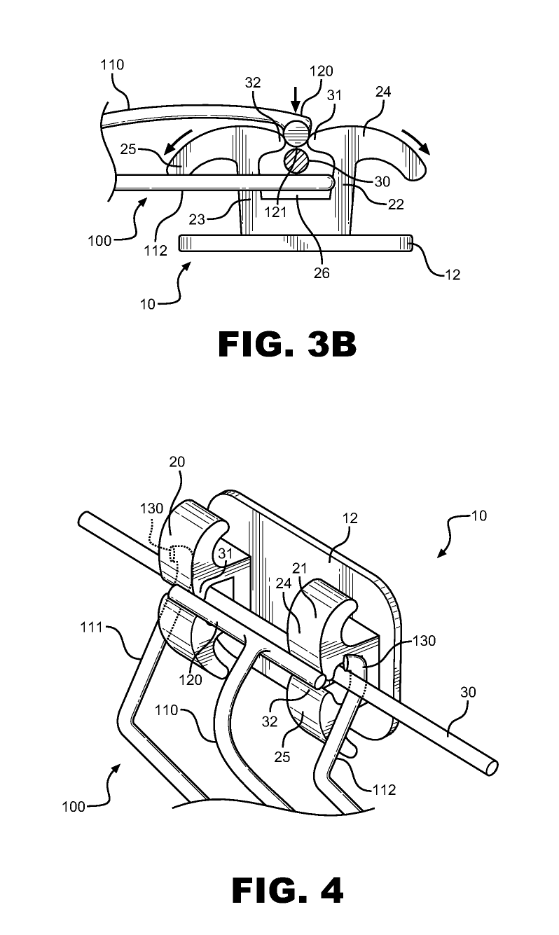

To execute the two-step orthodontic method for disengaging an archwire from a bracket, an orthodontist may use a wire disengagement tool 100. As shown in FIGS. 3, 3A, and 3B, the wire disengagement tool 100 comprises a center arm 110 and side arms 111 and 112 located on either side of the center arm 110. The center arm 110 and the side arms 111 and 112 are attached to a handle, which an orthodontist grips when using the tool 100. The handle may extend in the same plane as the center arm 110 and the side arms 111 and 112, or the handle may extend perpendicularly from the center arm 110 and the side arms 111 and 112. Further, the handle may be a unitary structure, but the handle preferably includes two moveably mounted components, wherein a first handle component is attached to the center arm 110 and a second handle component is attached to the side arms 111 and 112 so that the tool 100 acts in a plier-like manner.

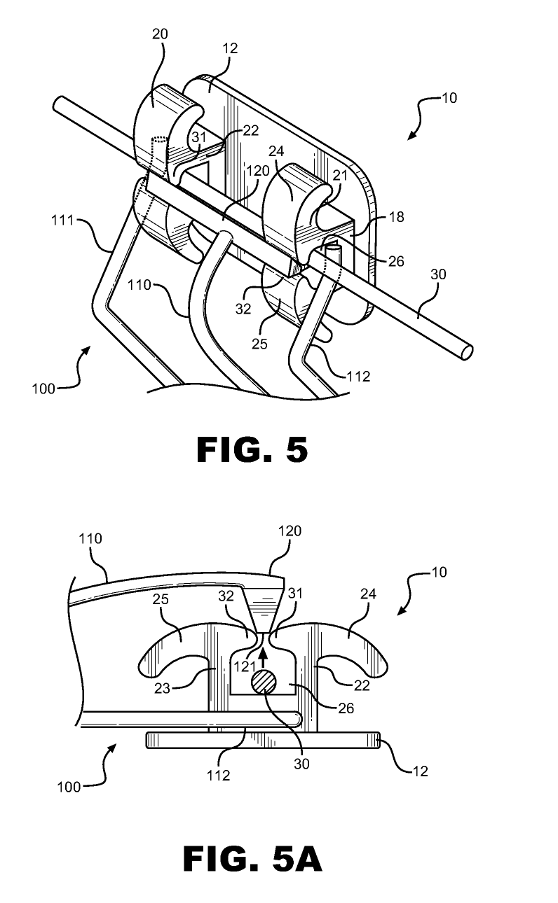

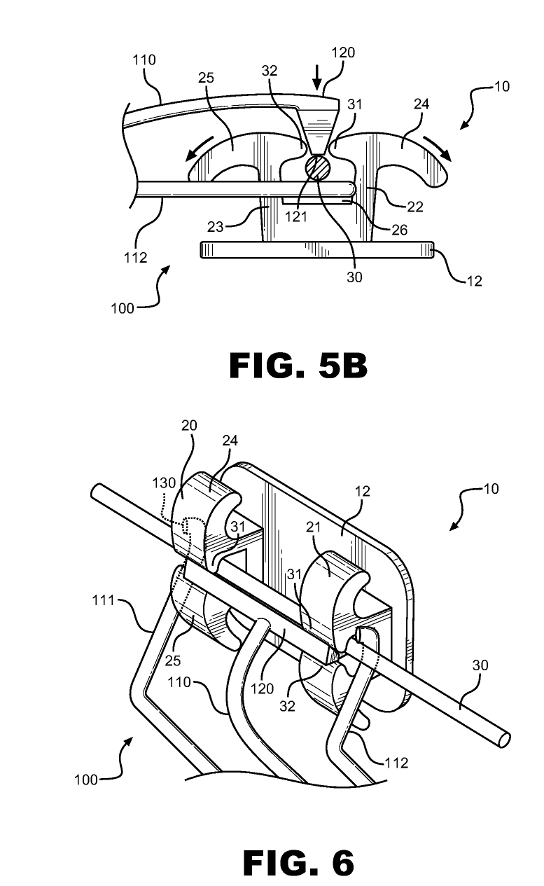

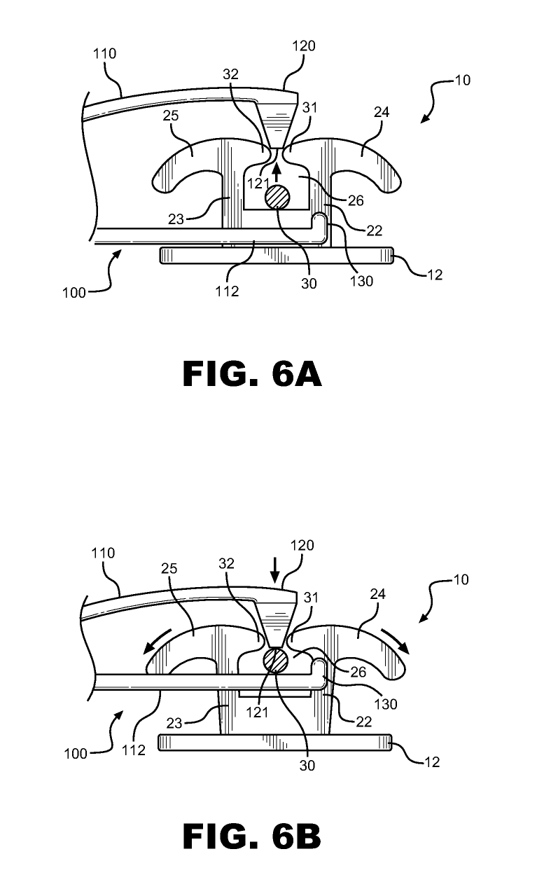

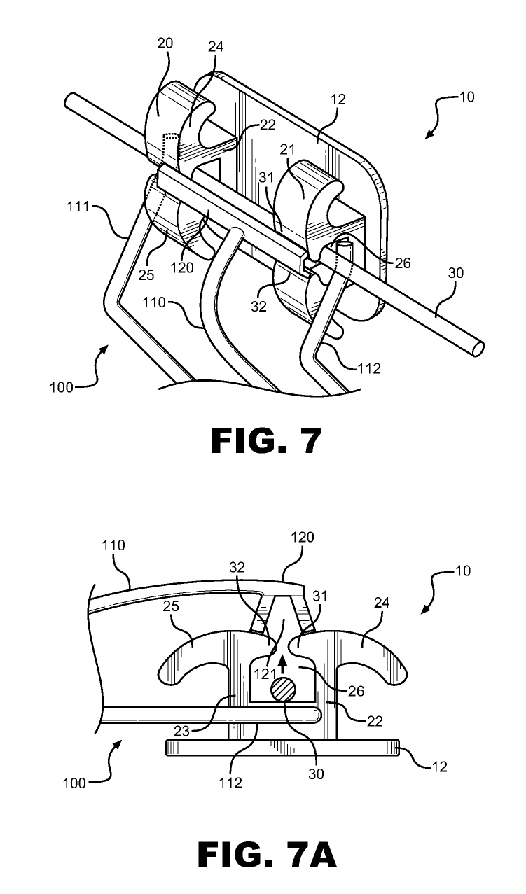

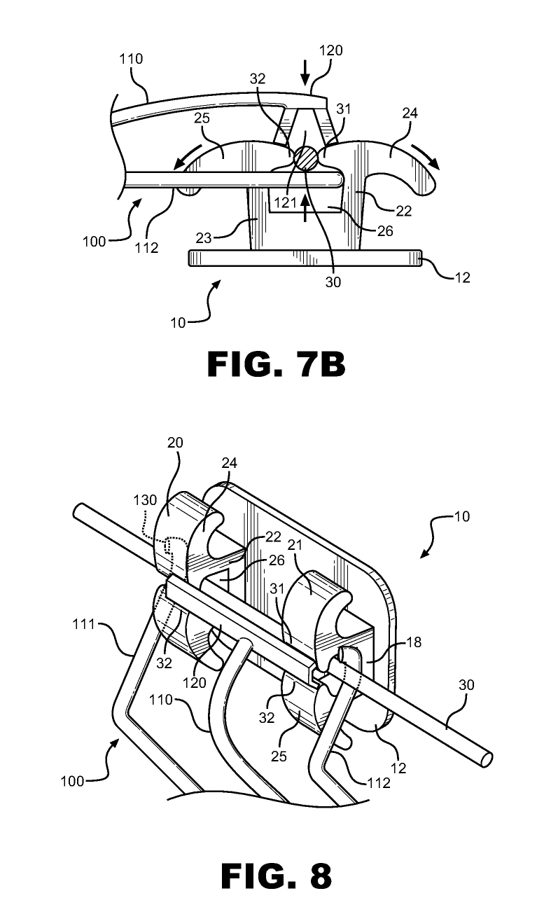

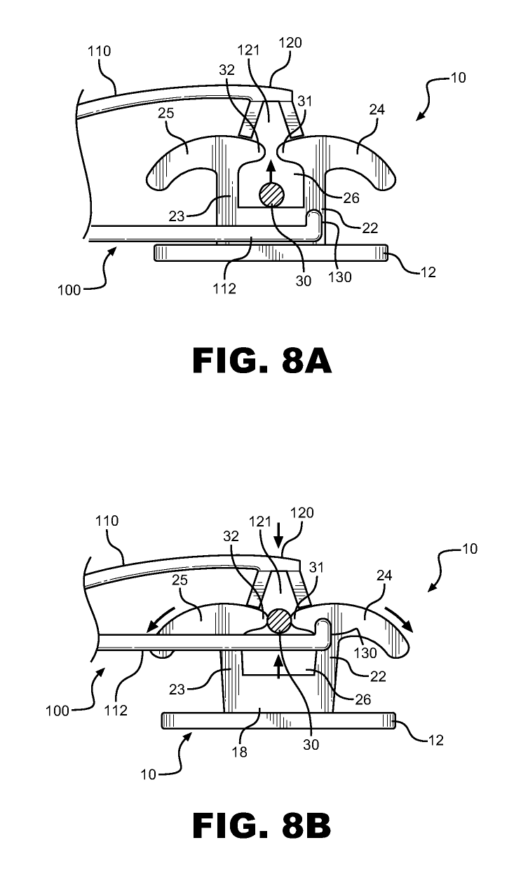

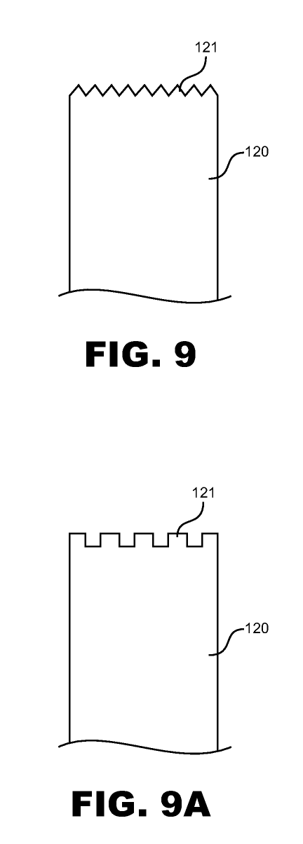

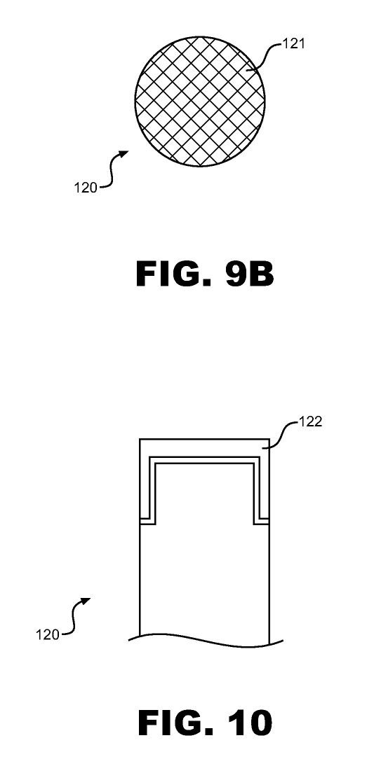

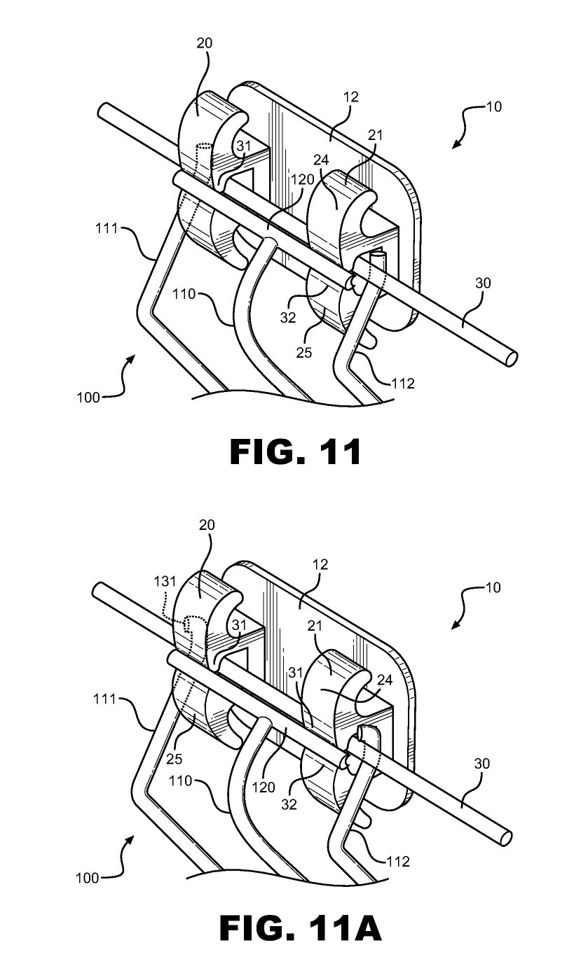

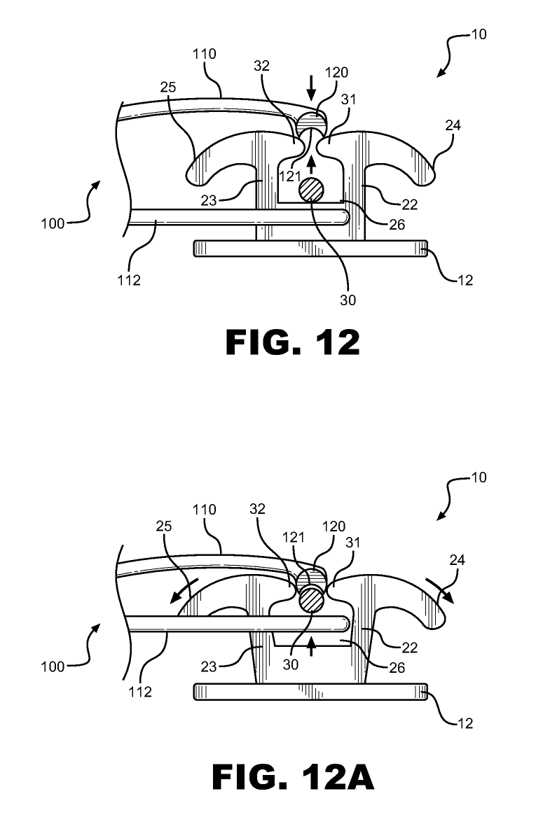

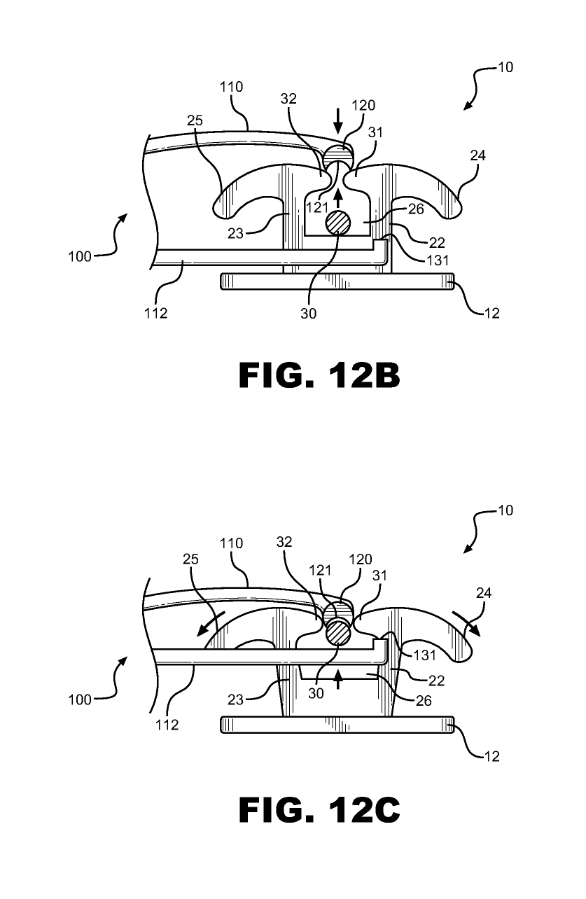

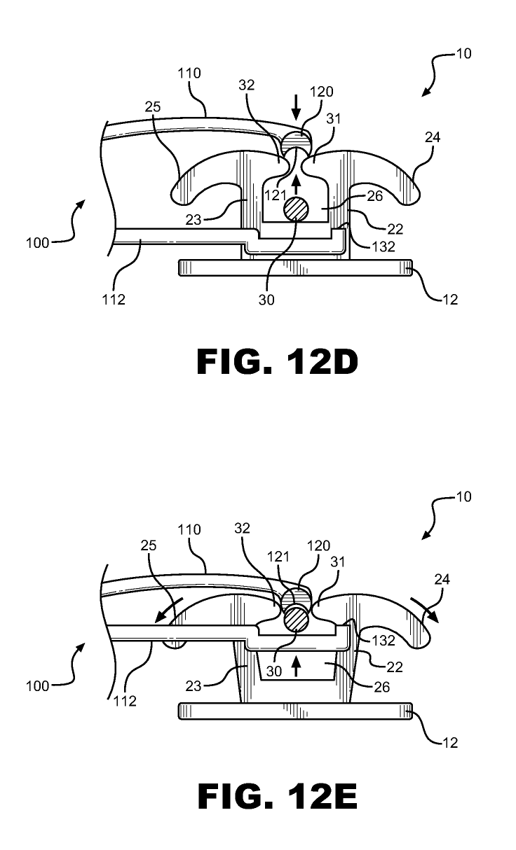

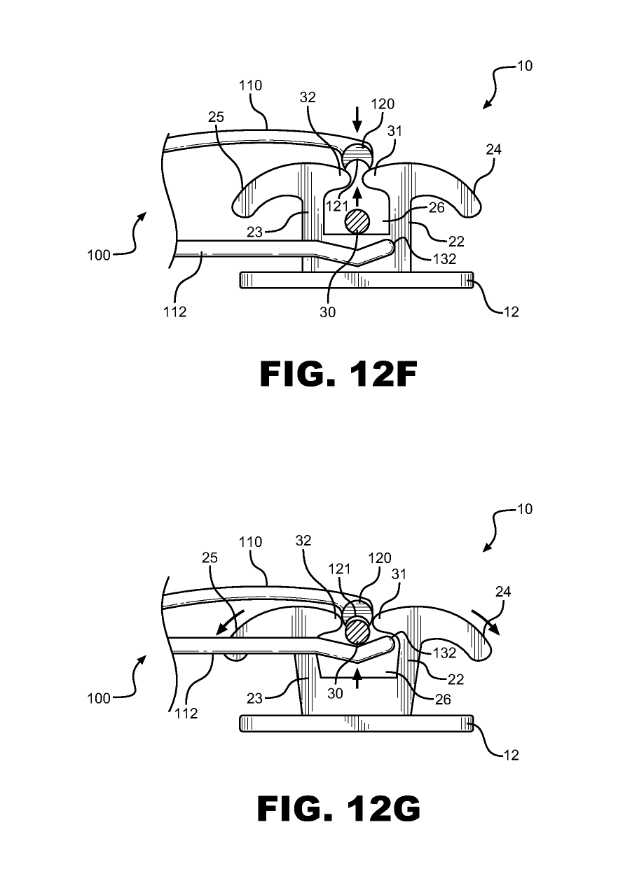

The center arm 110 includes a head portion 120, which extends transversely from the center arm 110 toward each of the side arms 111 and 112. As shown in FIGS. 3A and 3B, the head portion 120 has a generally round or convex cross-section. However, the head portion 120 may have any suitable shape and cross-section, such as a wedge shape with a triangular cross-section shown in FIGS. 5A, 5B, 6A, and 6B, a generally V-shaped cross-section shown in FIGS. 7A, 7B, 8A, and 8B, or may be slightly concave so as to correspond with a wire that is round in cross-section, as shown in FIGS. 11, 11A, 12 and 12A, square in cross-section, rectangular in cross-section, or any combination of different shapes and cross-sections. The head portion includes an engagement surface 121 which engages at least one tie wing of a bracket 10 when the tool 100 is in use. Preferably, the engagement surface 121 is a serrated or toothed surface to securely engage a tie wing, as shown in FIGS. 9, 9A, and 9B. Further, the teeth of the engagement surface 121 may be triangular in cross-section, as shown in FIG. 9A, rectangular in cross-section, as shown in FIG. 9B, or any other suitable shape or cross-section. The engagement surface 121 may include a pad or cushion 122, as shown in FIG. 10, so that the head portion 120 can more effectively contact the tie wings 20 and 21 of the bracket 10. Further, to create an even more precise engagement between the engagement surface 121 of head portion 120 and the tie wings 20 and 21, the upper portions 24 and 25 of the tie wings 20 and 21 may include depressions or recesses to receive the engagement surface 121. In addition, any suitable engagement means may be used to create a precision engagement between the engagement surface 121 and the tie wings 20 and 21 of the bracket 10.

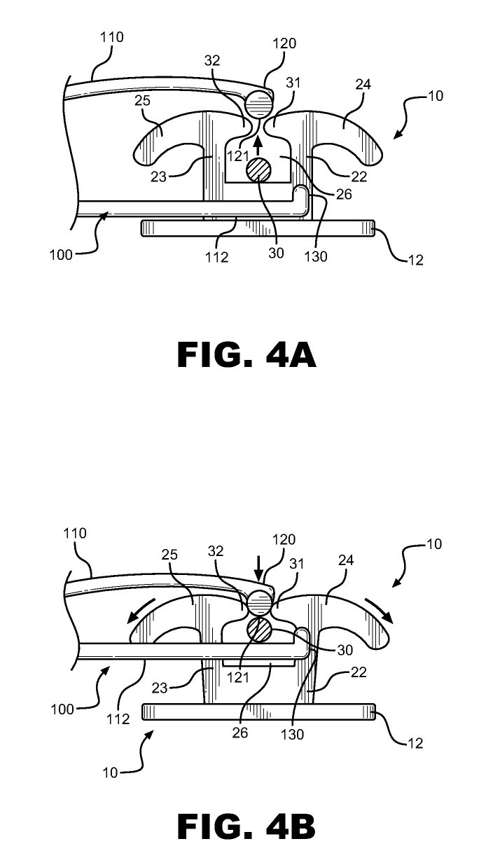

Each of the side arms 111 and 112 preferably includes a grasping means for grasping an archwire 30 when the wire disengaging tool 100 is in use. The grasping means is preferably a hook 131, as shown in FIGS. 4, 4A, 4B, 6, 6A, 6B, 8, 8A, 8B, 11A, 12B, and 12C. Another example of a grasping means is an indentation 132 in one or both of the side arms 111 and 112. Not only does the indentation 132 aid in grasping an archwire 30, but the indentation 132 may also act as a positioning means for aligning the archwire 30. The indentation 132 may be rectangular in cross-section, as shown in FIGS. 12D and 12E, V-shaped in cross-section, as shown in FIGS. 12F and 12G, or any other suitable shape that provides for grasping and aligning an archwire. In addition to the hook 131 and the indentation 132, any other suitable means for engaging an archwire 30 may be used.

To use the wire disengagement tool 100 to disengage and remove an archwire 30 from an archwire slot 26 of an orthodontic bracket 10, an orthodontist separates the two components of the plier-like handle to create a space between the center arm 110 and the side arms 111 and 112. The orthodontist then places the tool 100 against the bracket 10 so that the side arms 111 and 112 are positioned underneath the archwire 30 on either side of the bracket 10. The orthodontist also places the center arm 110 so that it is parallel to the bracket base 12 and between the retentive component, namely tie wings 20 and 21, so that the head portion 120 of the center arm 110 engages the upper portions 24 and 25 of the tie wings 20 and 21. When the head portion 120 contacts the upper portions 24 and 25 of the tie wings 20 and 21, the engaging surface 121 of the head portion 120 contacts the inner flanges 31 and 32 of the upper portions 24 and 25, respectively.

Once the orthodontist positions the tool 100 on the bracket 10, the orthodontist squeezes the two components of the plier-like handle together, which forces the center arm 110 downwardly toward the side arms 111 and 112 and the archwire slot 26. As a result of the downward force, the head portion 120 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, as shown in FIG. 3B, which makes the archwire 30 in the archwire slot 26 accessible. To increase this wedge-like lateral force, the orthodontist may choose to use the embodiment of the wire disengagement tool 100 having a head portion 120 with a triangular cross-section, as shown in FIGS. 5-6B.

In addition to the forcing the center arm 110 downwardly, the squeezing of the handle concurrently forces the side arms 111 and 112 upwardly toward the center arm 110. Consequently, as the head portion 120 of the center arm 110 maintains the tie wings in flexed, outwardly-extended position, the side arms 111 and 112 lift the archwire 30 toward the head portion 120 so that the archwire 30 is retained in a friction fit between the head portion 120 and the side arms 111 and 112. To assure the archwire 30 is securely maintained between the head portion 120 of the center arm 110 and the side arms, an orthodontist may choose to use the embodiment of the tool 100 wherein the head portion has a V-shaped cross-section, as shown in FIGS. 7-8B, or a concave surface, as shown in FIGS. 11 and 12-12A. An orthodontist may also choose to use grasping means 131 to assure the archwire 30 is secured.

After the archwire 30 is retained between the head portion 120 and the side arms 111 and 112, the orthodontist can lift the archwire 30 vertically from the archwire slot 26 through the space between the tie wings 20 and 21 created by the head portion 120 of the center arm 110. To facilitate the removal of the wire 30, an orthodontist may elect to use the embodiment of the tool 100 having an aligning means 132 to assure the wire 30 passes through the space between the inner flanges 31 and 32 of the tie wings 20 and 21, respectively, as shown in FIGS. 12D-12G. The orthodontist then removes the wire disengaging tool 100 from the bracket, and the tie wings 20 and 21 return to the original rest positions. To release the archwire 30 from the tool 100, the orthodontist separates the two handle components, which causes the center arm 110 and side arms 111 and 112 to move apart.

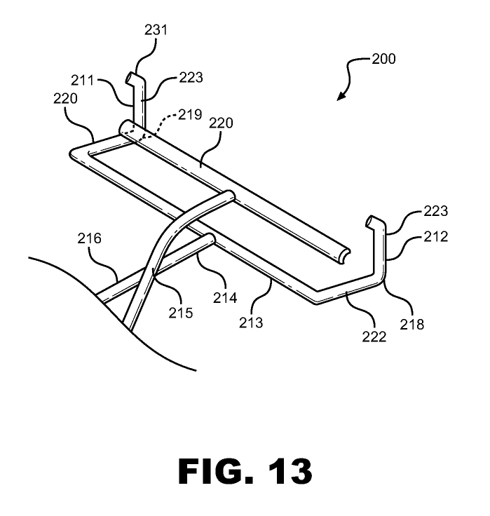

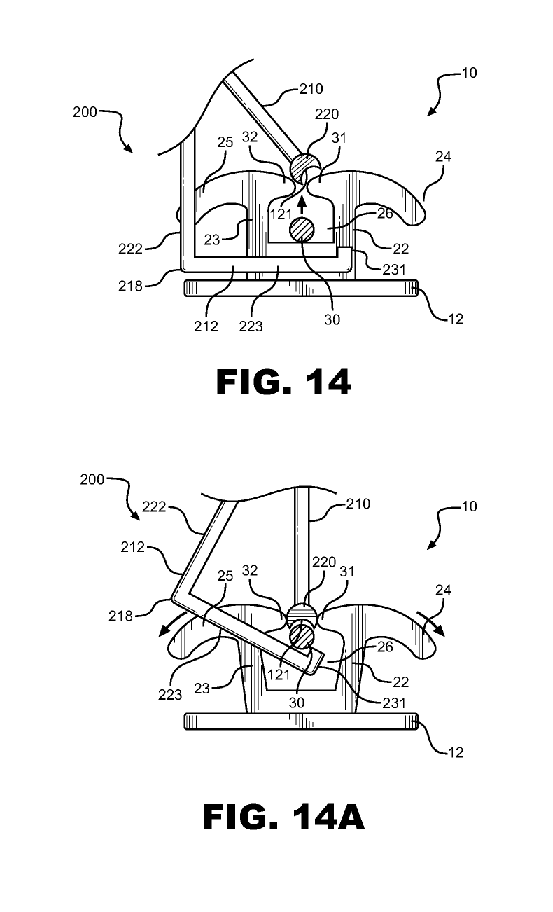

An alternative embodiment of a wire disengagement tool in accordance with the present invention is shown in FIGS. 13-14A. The tool 200 is very similar to the tool 100 shown in FIGS. 3-12G. The tool 200 comprises a center arm 210 and side arms 211 and 212 located on either side of the center arm 110. The center arm 210 includes a head portion 220, which extends transversely from the center arm 210 toward each of the side arms 211 and 212. In the embodiment shown in FIGS. 13-14A, the head portion 220 has a concave surface. However, the head portion 220 may have any suitable shape and cross-section, as discussed with respect to the head portion 120 of the tool 100. The head portion 210 includes an engagement surface 221 which engages at least one tie wing of a bracket 10 when the tool 200 is in use. Like the engagement surface 121, the engagement surface 221 may be a serrated or toothed surface or may include a pad or cushion. Each of the side arms 211 and 212 preferably includes a grasping means for grasping an archwire 30 when the wire disengaging tool 200 is in use, and the grasping means is preferably a hook 231.

The side arms 211 and 212 are connected by a connection bar 213. Further, each of the side arms 211 and 212 include a first arm portion 222 and a second arm portion 223. The first arm portion 222 extends from a first end of each of the side arms 211 and 212 that is connected to the connection bar 213 to bends 217 and 218, located approximately mid-length of each of the side arms 211 and 212. The second arm portion 223 extends from the bend points 217 and 218, respectively, to a second end of each of the side arms 211 and 212 that is opposite the connection bar 213.

The connection bar 213 and side arms 211 and 212 are connected to the center arm 210 via a side arm control bar 214, which is pivotally connected to the center arm 210 at a pivot point 215. As a result, side arm control bar 214 and the center arm 210 form a plier-like handle 216 that allows an orthodontist to not only grip the tool 200, but also move the side arms 211 and 212 and the center arm 210 relative to each other. Further, the plier-like handle 216 extends perpendicularly to the head portion 220.

While the tool 200 is very similar to the tool 100, a distinction between the two embodiments is the orientation of the center arm relative to the side arms. With regard to the tool 100, the orientation of the center arm 110 and side arms 111 and 112 allows the center arm to be substantially parallel to the bracket base 12 when the tool engages the bracket 10, as shown in FIGS. 3A and 3B, such that an orthodontist can approach the bracket 10 from the side. Unlike the tool 100, the orientation of the center arm 210 and side arms 211 and 212 allows the center arm 210 to be at approximately a 45° angle to the bracket base 12. This position allows an orthodontist to more easily place the head portion 220 between the inner flanges 31 and 32 of the head portions 24 and 25 of the tie wings 21 and 22, respectively.

To use the wire disengagement tool 200 to disengage and remove an archwire 30 from an archwire slot 26 of an orthodontic bracket 10, an orthodontist moves the two components of the plier-like handle 216, namely the side arm control bar 214 and the center arm 210, apart about the pivot point 215 to create a space between the center arm 210 and the side arms 211 and 212. The orthodontist then places the tool 200 against the bracket 10 so that the side arms 211 and 212 are positioned underneath the archwire 30, as shown in FIG. 14. The orthodontist also places the center arm 210 between the retentive component, namely tie wings 20 and 21, so that the head portion 220 of the center arm 210 engages the upper portions 24 and 25 of the tie wings 20 and 21. In this position, due the orientation of the center arm 210 and the side arms 211 and 212, the center arm is positioned at approximately a 45° angle to the bracket base 12.

Once the orthodontist positions the tool 200 on the bracket 10, the orthodontist squeezes the side arm control bar 214 and the center arm 210 of the plier-like handle 216 together, which forces the center arm 210 downwardly toward the side arms 211 and 212 and the archwire slot 26 and rotates the handle 216 approximately 45° so that the center arm 210 is perpendicular to the bracket base 12 and directly above the archwire slot 26, as shown in FIG. 14A. As a result of the downward force, the head portion 220 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

In addition to the forcing the center arm 210 downwardly, the squeezing of the plier-like handle 216 concurrently forces the side arms 211 and 212 upwardly toward the center arm 210. Consequently, as the head portion 220 of the center arm 210 maintains the tie wings in flexed, outwardly-extended position, the side arms 211 and 212 lift the archwire 30 toward the head portion 220 so that the archwire 30 is retained in a friction fit between the head portion 220 and the side arms 211 and 212. After the archwire 30 is retained between the head portion 220 and the side arms 211 and 212 and the orthodontist rotates the tool 200 approximately 45° to assure the center arm 210 is perpendicular to the bracket base 12, the orthodontist can the easily lift the archwire 30 vertically from the archwire slot 26 through the space between the tie wings 20 and 21 created by the head portion 220 of the center arm 210. Consequently, this embodiment allows the orthodontist to use both a scissor-like motion between the center arm 210 and the side arms 211 and 212 and rotational motion to easily disengage the wire 30 from the slot 26.

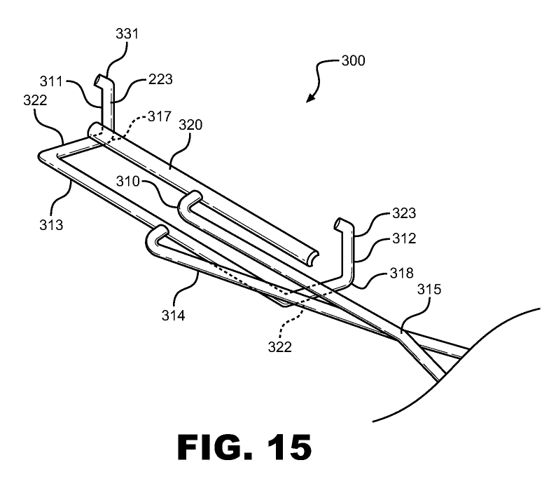

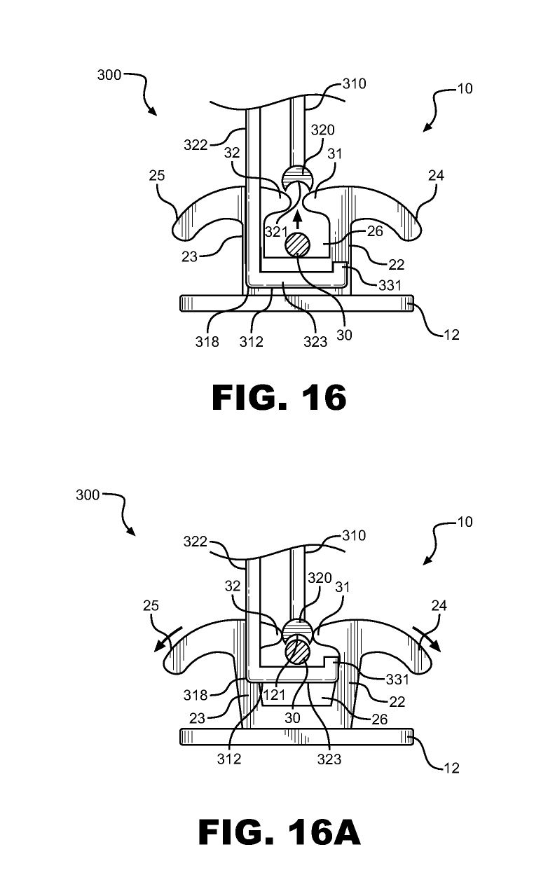

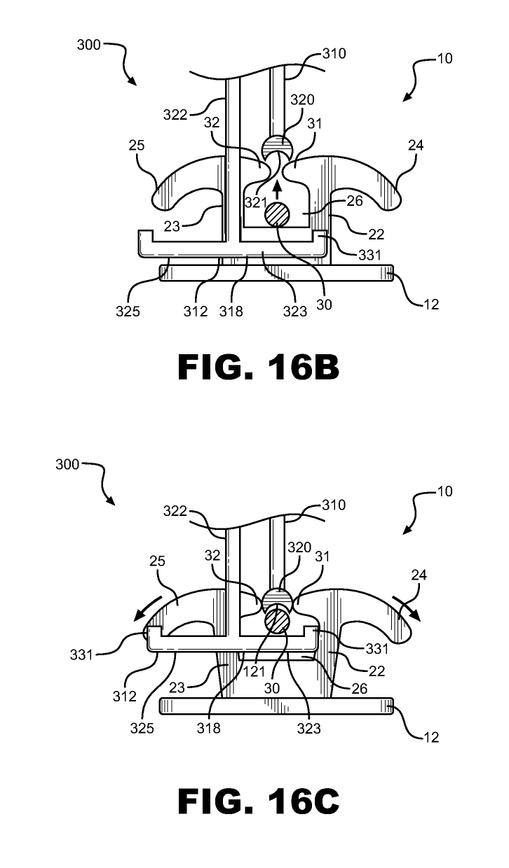

Another embodiment of a wire disengagement tool in accordance with the present invention is shown in FIGS. 15-16C. The tool 300 is similar to the tool 100 and tool 200 described above. The tool 300 comprises a center arm 310 and side arms 311 and 312 located on either side of the center arm 310. The center arm 310 includes a head portion 320, which extends transversely from the center arm 310 toward each of the side arms 311 and 312. In the embodiment shown in FIGS. 15-16C, the head portion 320 has a concave surface. However, the head portion 320 may have any suitable shape and cross-section, as discussed with respect to the head portion 120 of the tool 100. The head portion includes an engagement surface 321 which engages at least one tie wing of a bracket 10 when the tool 300 is in use Like the engagement surface 121, the engagement surface 321 may be a serrated or toothed surface or may include a pad or cushion. Each of the side arms 311 and 312 preferably includes a grasping means for grasping an archwire 30 when the wire disengaging tool 300 is in use, and the grasping means is preferably a hook 331, as shown in FIGS. 16 and 16A.

The side arms 311 and 312 are connected by a connection bar 313, and each of the side arms 311 and 312 include a first arm portion 322 and a second arm portion 323. The first arm portion 322 extends from a first end of each of the side arms 311 and 312 that is connected to the connection bar 313 to bends 317 and 318, located approximately mid-length of each of the side arms 311 and 312. The second arm portion 323 extends from the bend points 317 and 318, respectively, to a second end of each of the side arms 311 and 312 that is opposite the connection bar 313.

In addition to the first arm portion 322 and the second arm portion 323, each of the side arms 311 and 312 may also include a third arm portion 325, as shown in FIGS. 16B and C. Like the second arm portion 323, the third arm portion 325 extends from the bends 317 and 318, but in a direction opposite the second arm portion. The benefit of having the third arm portion 325 is an orthodontist can use the tool 300 on either side of the mouth without having to change the orientation of the tool 300 in his or her hand.

The connection bar 313 and side arms 311 and 312 are connected to the center arm 310 via a side arm control bar 314, which is pivotally connected to the center arm 310 at a pivot point 315. As a result, side arm control bar 314 and the center arm 310 form a plier-like handle 316 that allows an orthodontist to not only grip the tool 300, but also move the side arms 311 and 312 and the center arm 310 relative to each other. Further the plier-like handle 316 extends in a direction that is parallel to the head portion 310.

While the tool 300 is very similar to the tool 100, a distinction between the two embodiments is the orientation of the center arm relative to the side arms. With regard to the tool 100, the orientation of the center arm 110 and side arms 111 and 112 allows the center arm to be substantially parallel to the bracket base 12 when the tool engages the bracket 10, as shown in FIGS. 3A and 3B, such that an orthodontist can approach the bracket 10 from the side. Unlike the tool 100, the orientation of the center arm 310 and side arms 311 and 312 allows the center arm 310 to be substantially perpendicular to the bracket base 12 when an orthodontist places the tool 300 on a bracket 10 to enable the orthodontist to approach the bracket from the top.

To use the wire disengagement tool 300 to disengage and remove an archwire 30 from an archwire slot 26 of an orthodontic bracket 10, an orthodontist moves the two components of the plier-like handle 316, namely the side arm control bar 314 and the center arm 310, apart about the pivot point 315 to create a space between the center arm 310 and the side arms 311 and 312. The orthodontist then places the tool 300 against the bracket 10 so that the side arms 311 and 312 are positioned underneath the archwire 30, as shown in FIGS. 16 and 16B. The orthodontist also places the center arm 310 between the retentive component, namely tie wings 20 and 21, so that the head portion 320 of the center arm 310 engages the upper portions 24 and 25 of the tie wings 20 and 21. In this position, the center arm 310 is generally perpendicular to the bracket base 12.

Once the orthodontist positions the tool 300 on the bracket 10, the orthodontist squeezes the side arm control bar 314 and the center arm 310 of the plier-like handle 316 together, which forces the center arm 310 downwardly toward the side arms 311 and 312 and the archwire slot 26. As a result of the downward force, the head portion 320 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

In addition to the forcing the center arm 310 downwardly, the squeezing of the plier-like handle 316 concurrently forces the side arms 311 and 312 upwardly toward the center arm 310. Consequently, as the head portion 320 of the center arm 310 maintains the tie wings in flexed, outwardly-extended position, the side arms 311 and 312 lift the archwire 30 toward the head portion 320 so that the archwire 30 is retained in a friction fit between the head portion 320 and the side arms 311 and 312. After the archwire 30 is retained between the head portion 320 and the side arms 311 and 312, the orthodontist can the easily lift the archwire 30 vertically from the archwire slot 26 through the space between the tie wings 20 and 21 created by the head portion 320 of the center arm 310.

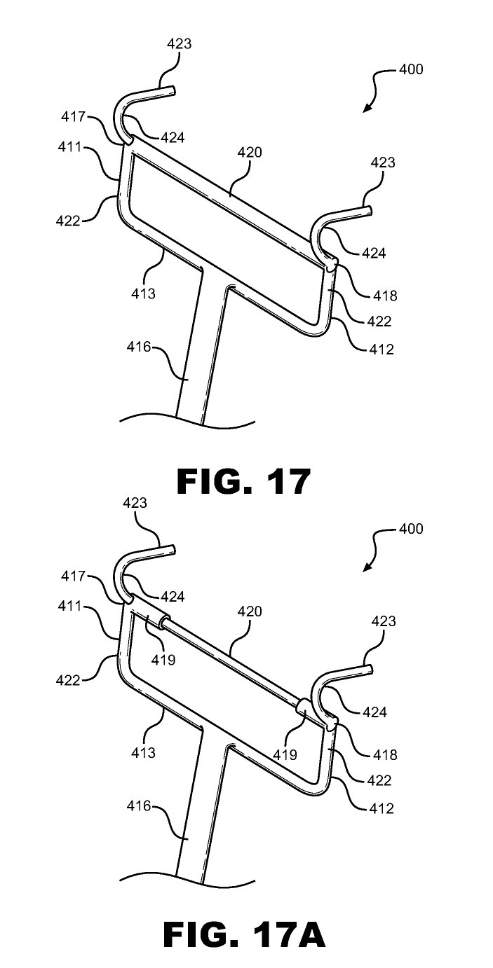

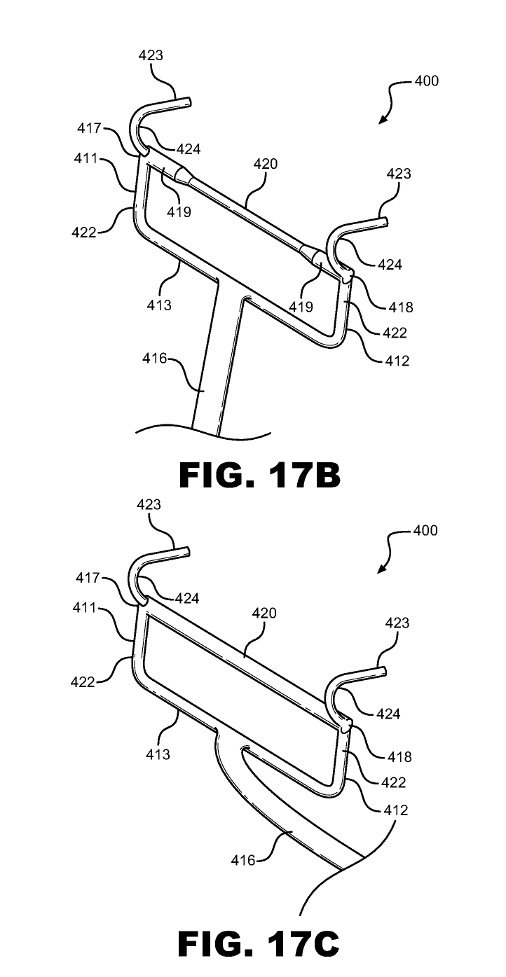

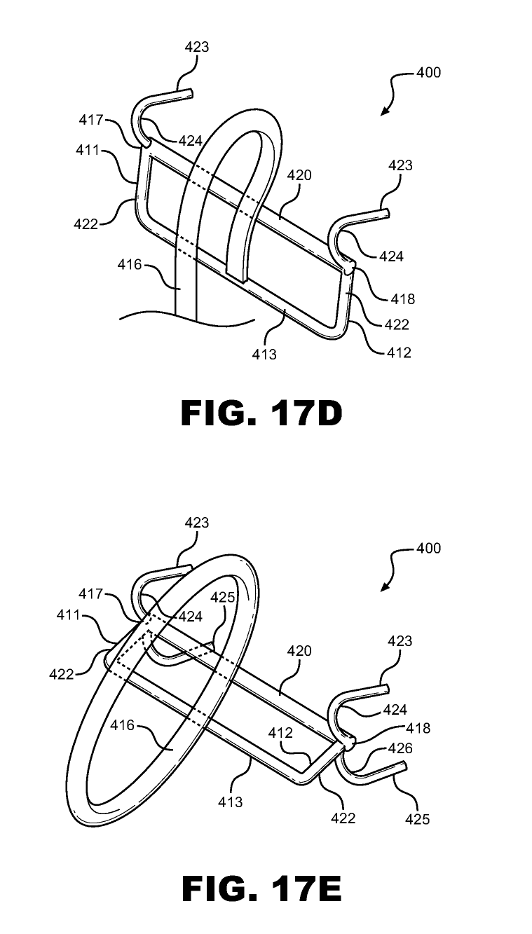

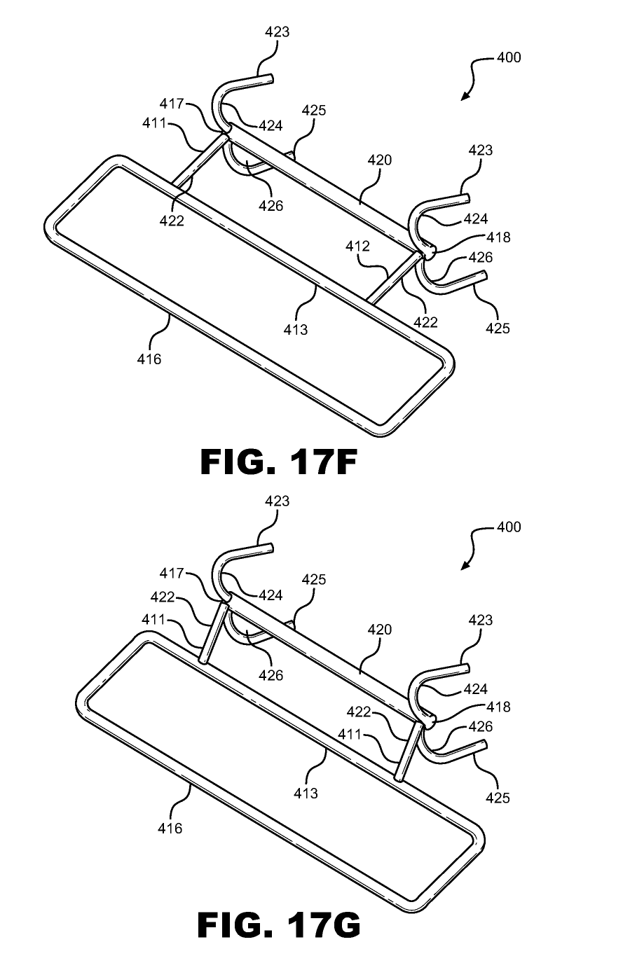

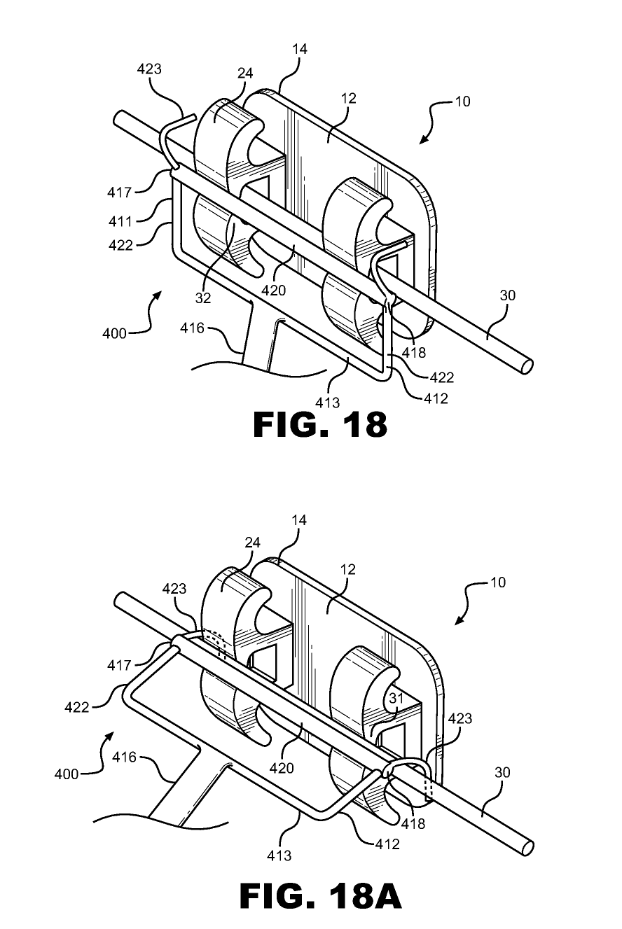

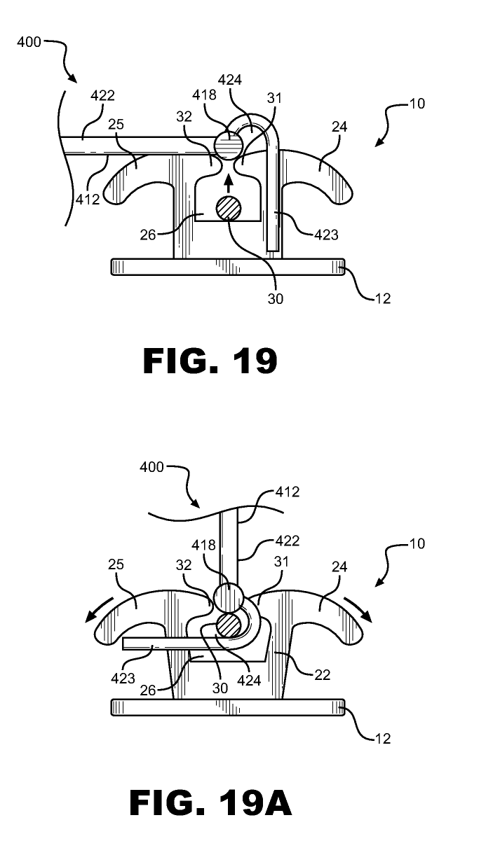

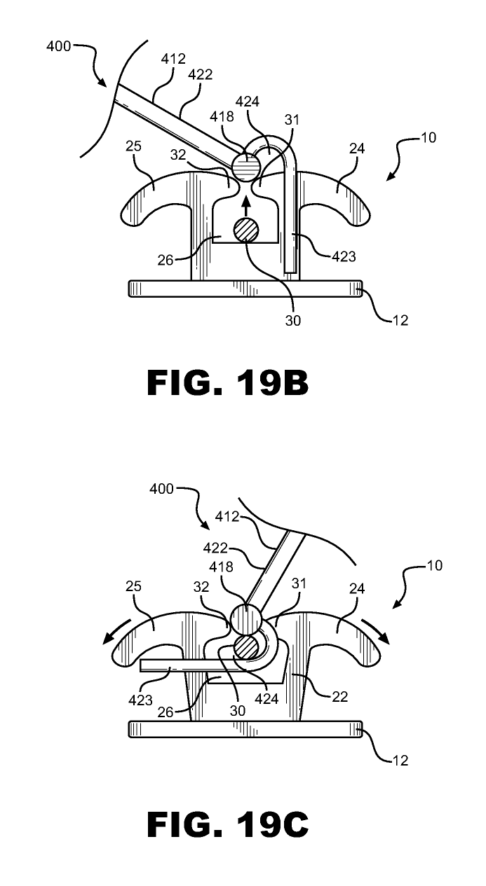

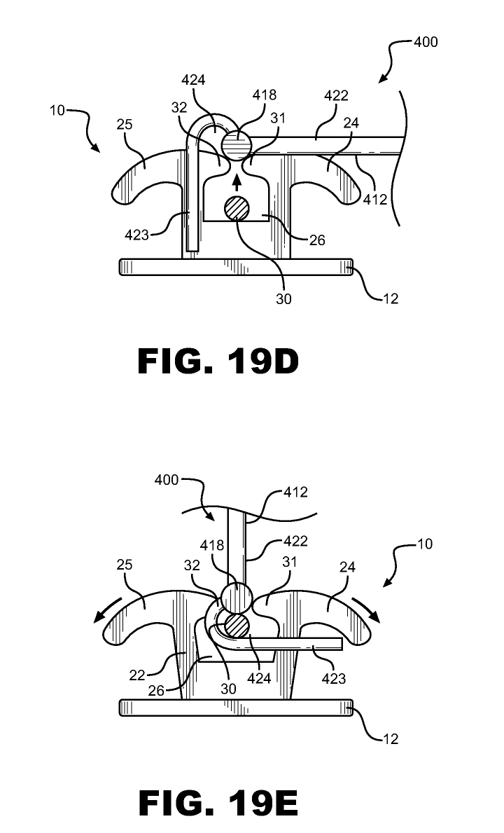

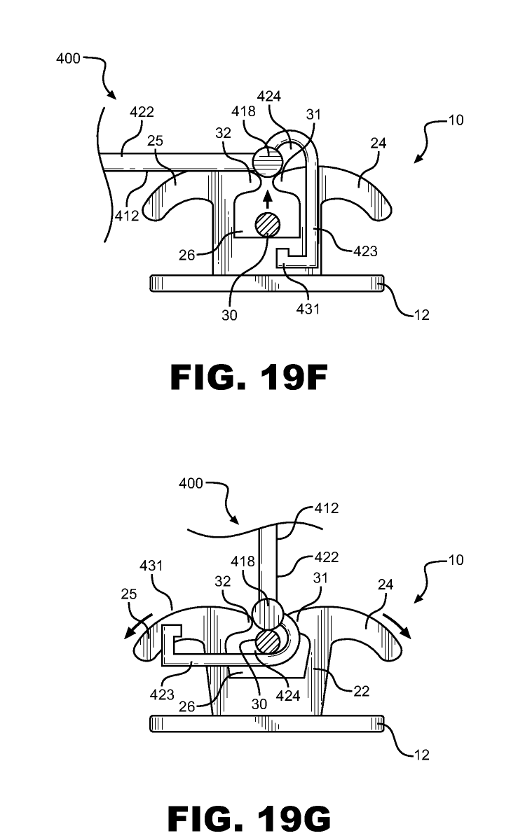

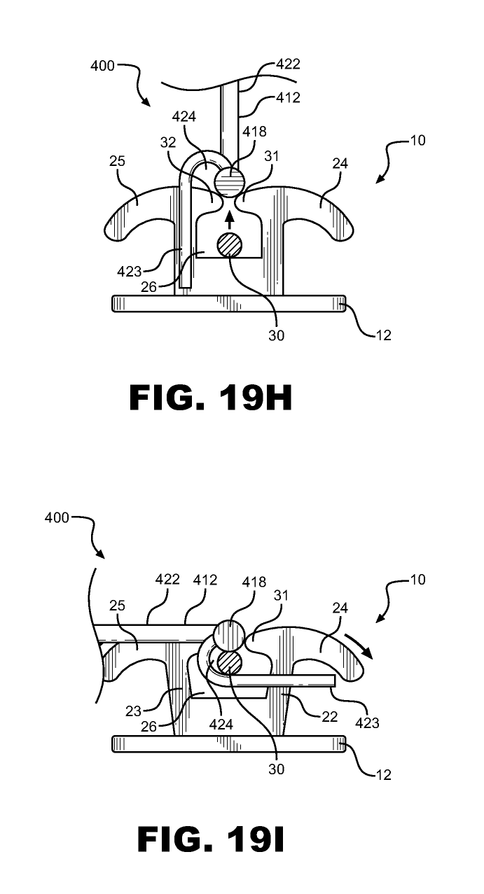

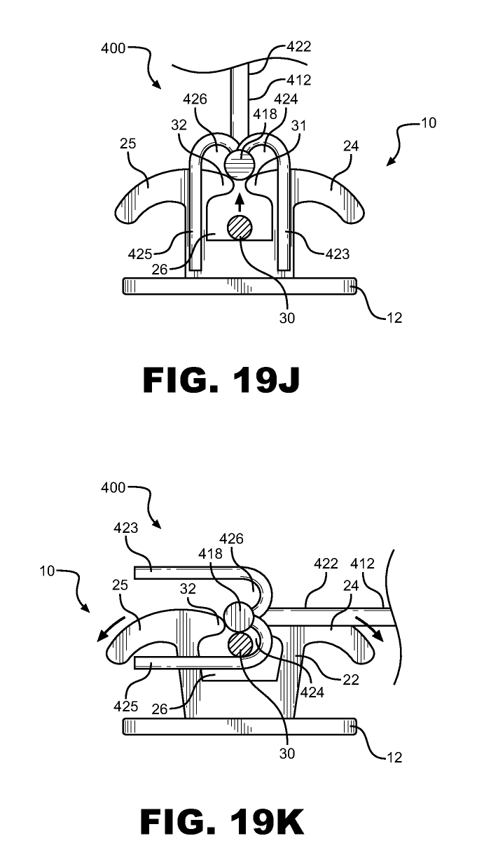

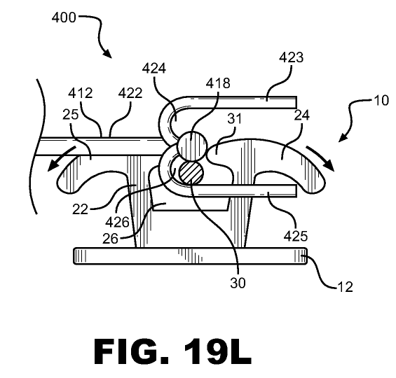

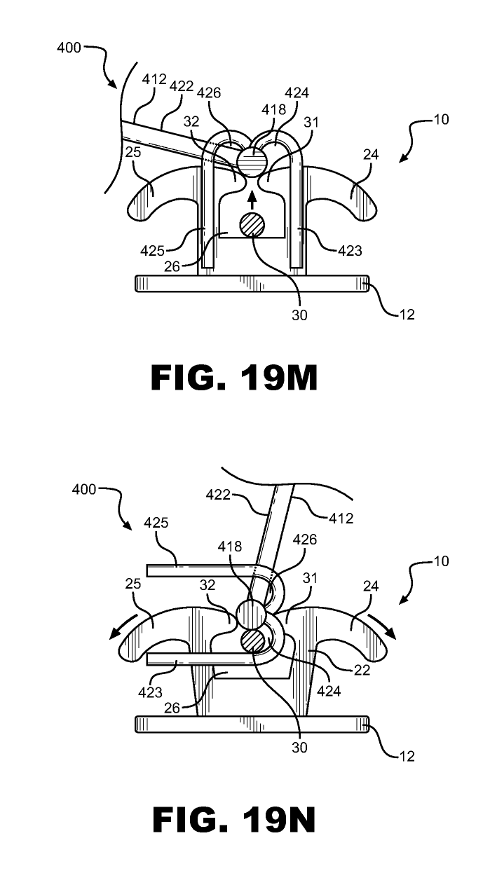

Another embodiment of a wire disengagement tool in accordance with the present invention is shown in FIGS. 17-21E. Unlike tools 100, 200, and 300, the tool 400 only uses a rotational motion, as opposed to a plier-like motion, to release an archwire 30 from a slot 26. The tool 400 comprises side arms 411 and 412 which are connected by a connection bar 413. Like other embodiments, each of the side arms 411 and 412 preferably includes a grasping means for grasping an archwire 30 when the wire disengaging tool 400 is in use, and the grasping means is preferably a hook 431, as shown in FIGS. 19F and 19G. The tool 400 further comprises a head portion 420 which extends between the side arms 411 and 412 and is fixedly connected to the side arms 411 and 412 at pivot points 417 and 418, respectively. Since the head portion 420 is connected to each of the side arms 411 and 412, the tool 400 does not have a center arm.

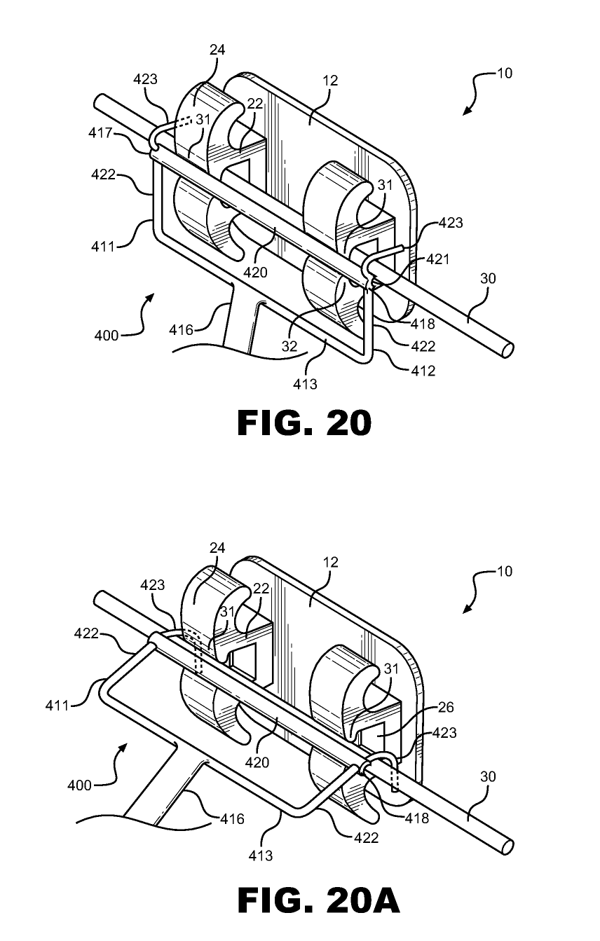

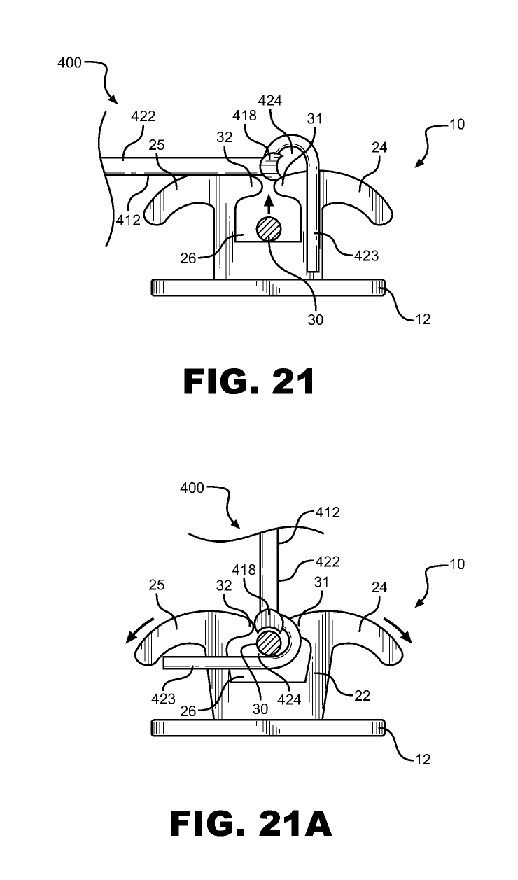

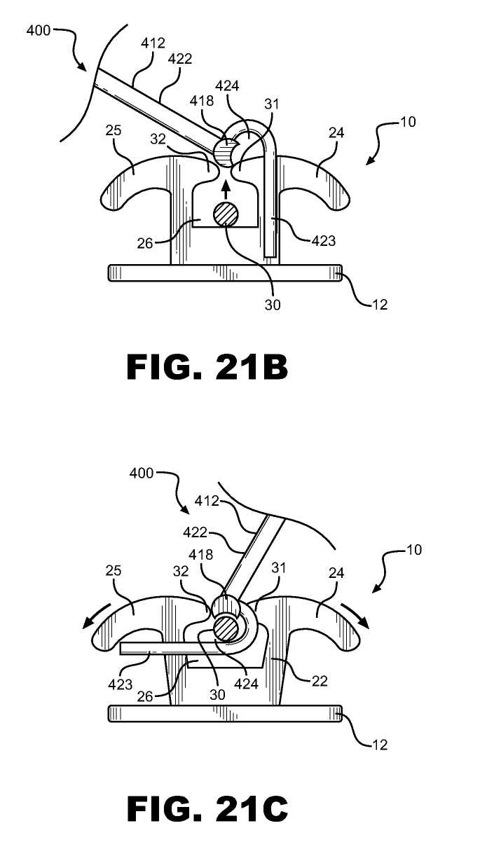

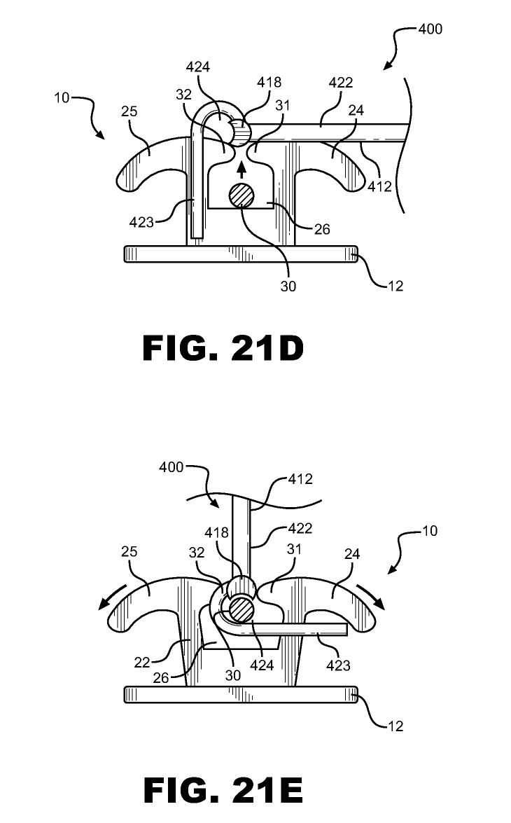

In the embodiment shown in FIGS. 17-19N the head portion 420 has a round surface, and the embodiment shown in FIGS. 20-21E, the head portion 420 has a concave surface. However, the head portion 420 may have any suitable shape and cross-section, as discussed with respect to the head portion 120 of the tool 100. The head portion includes an engagement surface 421 which engages at least one tie wing of a bracket 10 when the tool 400 is in use. Like the engagement surface 121, the engagement surface 421 may be a serrated or toothed surface or may include a pad or cushion.

Further, as shown in FIG. 17A, the head portion 420 may include an area of increased thickness 419 adjacent each of the pivot points 417 and 418. Further, these areas of increased thickness 419 may be tapered, as shown in FIG. 17B. The areas of increased thickness 419 create a larger gap when they engage the retentive component of an orthodontic bracket to further facilitate to the removal of the archwire.

Each of the side arms 411 and 412 include a first arm portion 422 extending from a first end of each of the side arms 411 and 412 that is connected to the connection bar 413 to the pivot points 417 and 418, respectively. Further, one or both of the side arms 411 and 412 also includes a second arm portion 423 extending from the pivot points 417 and 418, respectively, to a second end of each of the side arms 411 and 412 that is opposite the connection bar 413. The first arm portion 422 is a generally straight and extends substantially perpendicularly to the connection bar 413 and the head portion 420. The second arm portion 423 is curved and extends generally perpendicularly from the first arm portion 422, as well as substantially perpendicularly from the head portion 420. Further, since the second arm portion 423 of each of the side arms 411 and 412 is bent and extends perpendicularly from the first arm portion 422, a clearance 424 is created in the second arm portion 423.

In addition to the first arm portion 422 and the second arm portion 423, one or both of the side arms 411 and 412 may also include a third arm portion 425, as shown in FIGS. 17E-G. Like the second arm portion 423, the third arm portion 425 is curved and extends generally perpendicularly from the first arm portion 422, as well as substantially perpendicularly from the head portion 420. However, the third arm portion is 425 is bent in a direction opposite the bend of the second arm portion 423. Since the third arm portion 425 of each of the side arms 411 and 412 is also bent in a direction opposite the second arm portion 423 and extends perpendicularly from the first arm portion 422, a clearance 426 is created in the third arm portion 425.

The tool 420 also includes a handle 416, which is connected to the connection bar 413. The handle 416 may extend perpendicularly from the connection bar 413, as shown in FIGS. 17-17B, or the handle 416 may extend generally parallel to the connection bar 413, as shown in FIG. 17C. Further, the handle 416 may be bent, as shown in FIG. 17D, or the handle 416 may be a ring, as shown in FIG. 17E. Similarly, the handle 416 may be a hollow rectangular shape, as shown in FIGS. 17F-17G. In fact, the handle 416 can be positioned in any suitable orientation or be any suitable shape which allows an orthodontist to rotate to the tool 400 to remove an archwire from a bracket. [Is there any benefit in having a tool where the handle attaches directly to the head portion, so as to eliminate the first arm portion of each of the side arms?]

Since the tool 400 uses a rotational motion to separate a retentive component of an orthodontic bracket and remove an archwire therefrom, the position of the head portion 420 relative second arm portion 423 of each of the side arms 411 and 412 allows an orthodontist to approach the retentive component at various angles. For example, as shown in FIGS. 19, 19D and 19F, the orientation of the head portion 420 and the second arm portion 423 allow an orthodontist to approach the bracket from the side, meaning the first arm portion 422 is generally parallel to the bracket base 12 when the tool 400 engages the bracket 10. Another orientation of the head portion 420 relative the second arm portion 423 allows the first arm portion 422 to be at approximately a 45° angle when the tool 400 engages the bracket, as shown in FIGS. 19B and 19M. Similarly, yet another orientation of the head portion 420 relative to the second arm portion 423 of the side arms 411 and 412 causes the first arm portion 422 to be generally perpendicular to the bracket base 12, as shown in FIGS. 19H and 19J, so an orthodontist can approach the bracket 10 from the top.

To use the wire disengagement tool 400 to disengage and remove an archwire 30 from an archwire slot 26 of an orthodontic bracket 10, an orthodontist places the tool 400 against the bracket 10 so that the head portion 420 engages the retentive component, namely the upper portions 24 and 25 of the tie wings 20 and 21, respectively. Once the head portion 420 engages the retentive component, the pivot points 417 and 418 of each of the side arms 411 and 412 will likewise engage the retentive component and be positioned at the top of the archwire slot 26, as shown in FIGS. 19, 19B, 19D, 19F, 19H, 19J, 19M, 21, 21B and 21D. When the pivot points 417 and 418 are located above the archwire slot 26, the second arm portion 423 of each of the side arms 411 and 412 will be located adjacent the archwire slot 26, as also shown in these Figures. Similarly, if the tool 400 includes a third arm portion 425 on at least one of the side arms 411 and 412, then the third arm portion 425 will also be adjacent the archwire slot 25 on a side opposite the second arm portion, as shown in FIGS. 19J and 19M.

Once the orthodontist positions the tool 400 on the bracket 10, the orthodontist applies a slight downward force to urge the head portion 420 between the retentive components of the bracket 10. As a result of the downward force, the head portion 420 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

Simultaneous with the application of a downward force, the orthodontist rotates the handle 416 so that the head portion 420 pivots about the pivot points 417 and 418 approximately 90° in a direction to move the second arm portion 423 of each of the side arms 411 and 412 from a position adjacent the archwire slot 26 to a position underneath the slot 26, as shown in FIGS. 19A, 19C, 19E, 19G, 19I, 19K, 19L, 19N, 21A, 21C and 21E. Not only does this rotational motion move the second arm portions 423 underneath the archwire 26 and subsequently underneath the archwire 30 therein, but it also causes the archwire to move into the clearance 424 of each of the side arms 411 and 412, as also shown in these Figures.

If the tool 400 includes a third arm portion 425 on at least one of the side arms 411 and 412 and the orientation of the head portion 420 and the second arm portion 423 allow the tool 400 to approach the bracket 10 from the top, as shown in FIG. 19J, then the orthodontist can rotate the handle 416 approximately 90° in either direction. Specifically, if the orthodontist rotates the handle 90° in a first direction, then the second arm portion 423 will be positioned under the slot 26 and the archwire 30 will be retained in the clearance 424, as shown in FIG. 19K. If the orthodontist rotates the handle approximately 90° in the opposite direction, then the third arm portion 425 will be positioned under the slot 26 and the archwire 30 will be retained in the clearance 426, as shown in FIG. 19L. Thus, the third arm portion 425 gives an orthodontist more flexibility by allowing the orthodontist to rotate to the tool 400 in either direction to extract the wire 30 from the archwire slot 26.

Once the archwire 30 is retained in the clearance 424 of the side arms 411 and 412, the orthodontist can the easily lift the archwire 30 vertically from the archwire slot 26 through the space between the tie wings 20 and 21 created by the head portion 420. Consequently, this embodiment allows the orthodontist to use rotational motion to easily disengage the wire 30 from the slot 26.

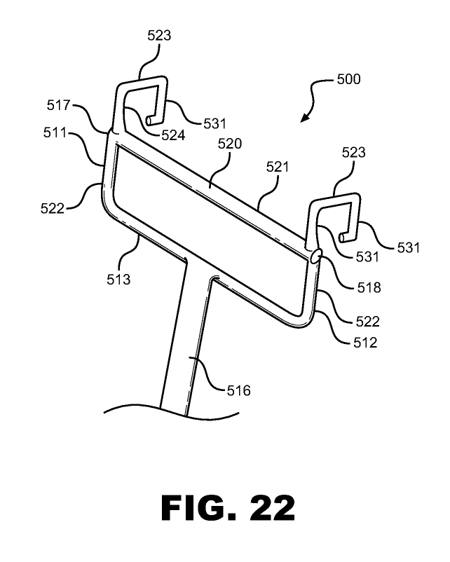

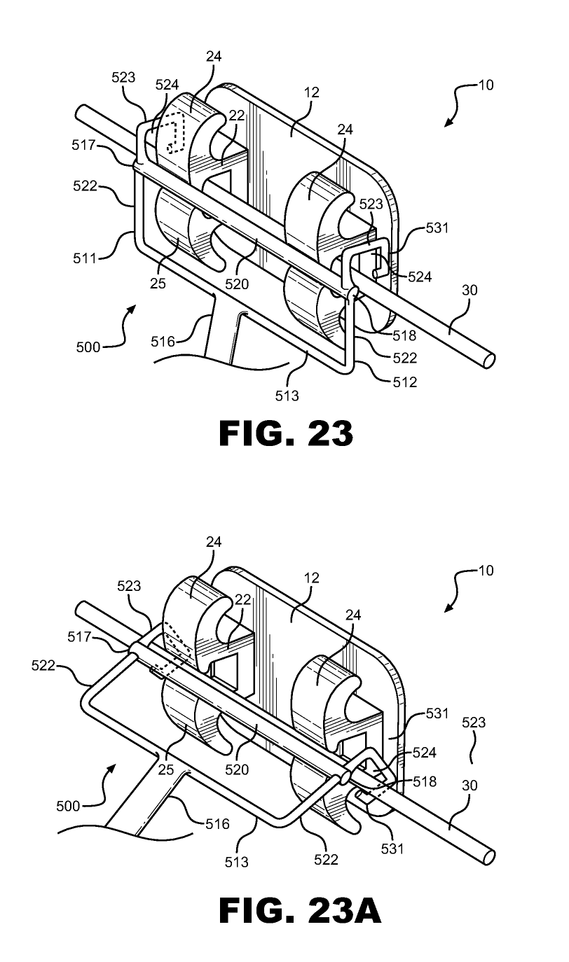

Another embodiment of a wire disengagement tool in accordance with the present invention is shown in FIGS. 22-24A. The tool 500 is similar to the tool 400 described above. Like the tool 400, the tool 500 comprises side arms 511 and 512 which are connected by a connection bar 513 Like other embodiments, each of the side arms 511 and 512 preferably includes a grasping means for grasping an archwire 30 when the wire disengaging tool 500 is in use, and the grasping means is preferably a hook 531. The tool 500 further comprises a head portion 520 which extends between the side arms 511 and 512 and is fixedly connected to the side arms 511 and 512 at pivot points 517 and 518, respectively.

In the embodiment shown in FIGS. 22-24A, the head portion 520 has a round surface. However, the head portion 520 may have a concave surface, any suitable shape and cross-section, or any suitable combination of shapes and cross-sections, as discussed with respect to the head portion 120 of the tool 100. The head portion includes an engagement surface 521 which engages at least one tie wing of a bracket 10 when the tool 500 is in use Like the engagement surface 121, the engagement surface 521 may be a serrated or toothed surface or may include a pad or cushion. The head portion 520 may also include an area of increased thickness adjacent each of the pivot points 517 and 518, similar to the embodiment of the tool 400 shown in FIGS. 17A. Further, these areas of increased thickness may be tapered, as shown with respect to the tool 400 in FIG. 17B.

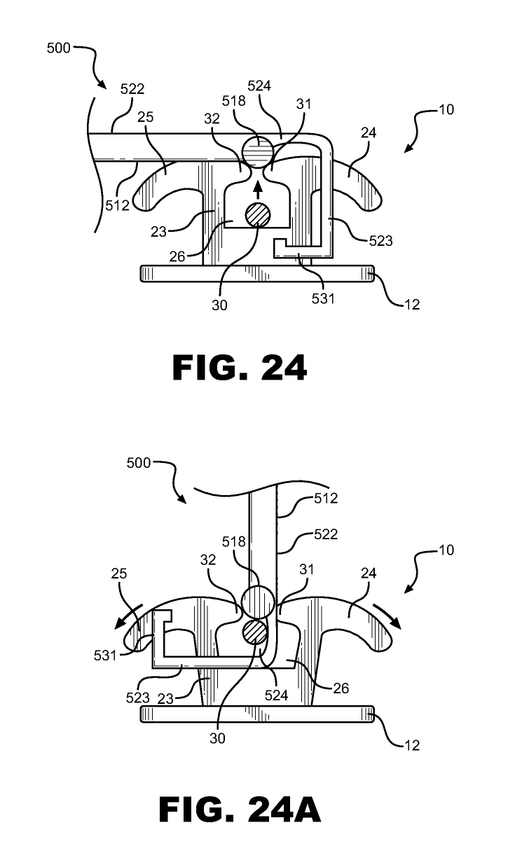

Each of the side arms 511 and 512 include a first arm portion 522 extending from a first end of each of the side arms 511 and 512 that is connected to the connection bar 513 to the pivot points 517 and 518, respectively. Further, one or both of the side arms 511 and 512 also includes a second arm portion 523 extending from the pivot points 517 and 518, respectively, to a second end of each of the side arms 511 and 512 that is opposite the connection bar 513. The first arm portion 522 is a generally straight and extends substantially perpendicularly to the connection bar 513 and the head portion 520. The second arm portion 523 is curved and extends generally perpendicularly from the first arm portion 522, as well as substantially perpendicularly from the head portion 520. Since the second arm portion 523 of each of the side arms 511 and 512 is bent and extends perpendicularly from the first arm portion 522, a clearance 524 is created in the second arm portion 523. Unlike the clearance 424 associated with the tool 400, the apex of the clearance 525 of the tool 500 does extend above the first arm portion 522 so as to create a smooth and level surface across the junction of the first arm portion 522 and the second arm portion 523, as shown in FIGS. 24 and 24A. In addition to the first arm portion 522 and the second arm portion 523, one or both of the side arms 511 and 512 may also include a third arm portion, as discussed above with respect to the tool 400.

The tool 500 also includes a handle 516, which is connected to the connection bar 513. The handle 516 may extend perpendicularly from the connection bar 513 may extend generally parallel to the connection bar 513. Further, the handle 516 may be bent, as shown in FIG. 17D with respect to the tool 400, or the handle 516 may be a ring, as shown in FIG. 17E with respect to the tool 400. Similarly, the handle 516 may be a hollow rectangular shape, as shown in FIGS. 17F-17G with respect to the tool 400. In fact, the handle 516 can be positioned in any suitable orientation or be any suitable shape which allows an orthodontist to rotate to the tool 500 to remove an archwire from a bracket, Moreover, like the tool 400, the tool 500 uses a rotational motion to separate a retentive component of an orthodontic bracket and remove an archwire therefrom, so the position of the head portion 520 relative second arm portion 523 of each of the side arms 511 and 512 allows an orthodontist to approach the retentive component at various angles, as explained above with respect to tool 400.

To use the wire disengagement tool 500 to disengage and remove an archwire 30 from an archwire slot 26 of an orthodontic bracket 10, an orthodontist places the tool 500 against the bracket 10 so that the head portion 520 engages the retentive component, namely the upper portions 24 and 25 of the tie wings 20 and 21, respectively. Once the head portion 520 engages the retentive component, the pivot points 517 and 518 of each of the side arms 511 and 512 will likewise engage the retentive component and be positioned at the top of the archwire slot 26, as shown in FIG. 24. When the pivot points 517 and 518 are located above the archwire slot 26, the second arm portion 523 of each of the side arms 511 and 512 will be located adjacent the archwire slot 26, as also shown FIG. 24.

Once the orthodontist positions the tool 500 on the bracket 10, the orthodontist applies a slight downward force to urge the head portion 520 between the retentive components of the bracket 10. As a result of the downward force, the head portion 520 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

Simultaneous with the application of a downward force, the orthodontist rotates the handle 516 so that the head portion 520 pivots about the pivot points 517 and 518 approximately 90° in a direction to move the second arm portion 523 of each of the side arms 511 and 512 from a position adjacent the archwire slot 26 to a position underneath the slot 26, as shown in FIG. 24A. Not only does this rotational motion move the second arm portions 523 underneath the archwire 26 and subsequently underneath the archwire 30 therein, but it also causes the archwire to move into the clearance 524 of each of the side arms 511 and 512, as also shown in FIG. 24A. Once the archwire 30 is retained in the clearance 524 of the side arms 511 and 512, the orthodontist can the easily lift the archwire 30 vertically from the archwire slot 26 through the space between the tie wings 20 and 21 created by the head portion 520. Consequently, this embodiment allows the orthodontist to use rotational motion to easily disengage the wire 30 from the slot 26.

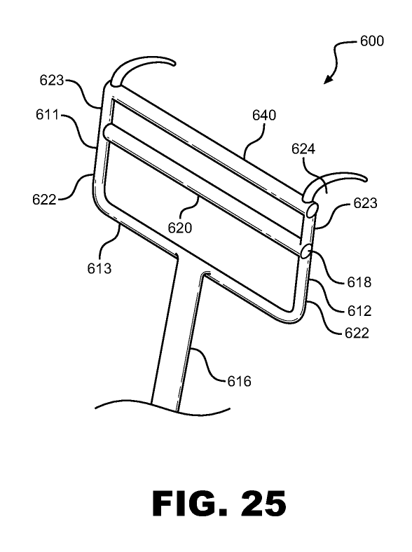

Another embodiment of a wire disengagement tool in accordance with the present invention is shown in FIGS. 25-27A. The tool 600 is also similar to the tool 400 described above. Like the tool 400, the tool 600 comprises side arms 611 and 612 which are connected by a connection bar 613 Like other embodiments, each of the side arms 611 and 612 preferably includes a grasping means for grasping an archwire 30 when the wire disengaging tool 600 is in use, and the grasping means is preferably a hook 631. The tool 600 further comprises a head portion 620 which extends between the side arms 611 and 612 and is fixedly connected to the side arms 611 and 612 at pivot points 617 and 516, respectively. The head portion includes an engagement surface 521 which engages at least one tie wing of a bracket 10 when the tool 500 is in use Like the engagement surface 121, the engagement surface 521 may be a serrated or toothed surface or may include a pad or cushion. The head portion 620 may also include an area of increased thickness adjacent each of the pivot points 617 and 618, similar to the embodiment of the tool 400 shown in FIGS. 17A. Further, these areas of increased thickness may be tapered, as shown with respect to the tool 400 in FIG. 17B.

Each of the side arms 611 and 612 include a first arm portion 622 extending from a first end of each of the side arms 611 and 612 that is connected to the connection bar 613 to the pivot points 617 and 618, respectively. Further, one or both of the side arms 611 and 612 also includes a second arm portion 623 extending from the pivot points 617 and 618, respectively, to a second end of each of the side arms 611 and 612 that is opposite the connection bar 613. The first arm portion 622 is a generally straight and extends substantially perpendicularly to the connection bar 613 and the head portion 620. The second arm portion 623 is curved and extends generally perpendicularly from the first arm portion 622, as well as substantially perpendicularly from the head portion 620. Since the second arm portion 623 of each of the side arms 611 and 612 is bent and extends perpendicularly from the first arm portion 622, a clearance 624 is created in the second arm portion 623. In addition to the first arm portion 622 and the second arm portion 623, one or both of the side arms 611 and 612 may also include a third arm portion, as discussed above with respect to the tool 400.

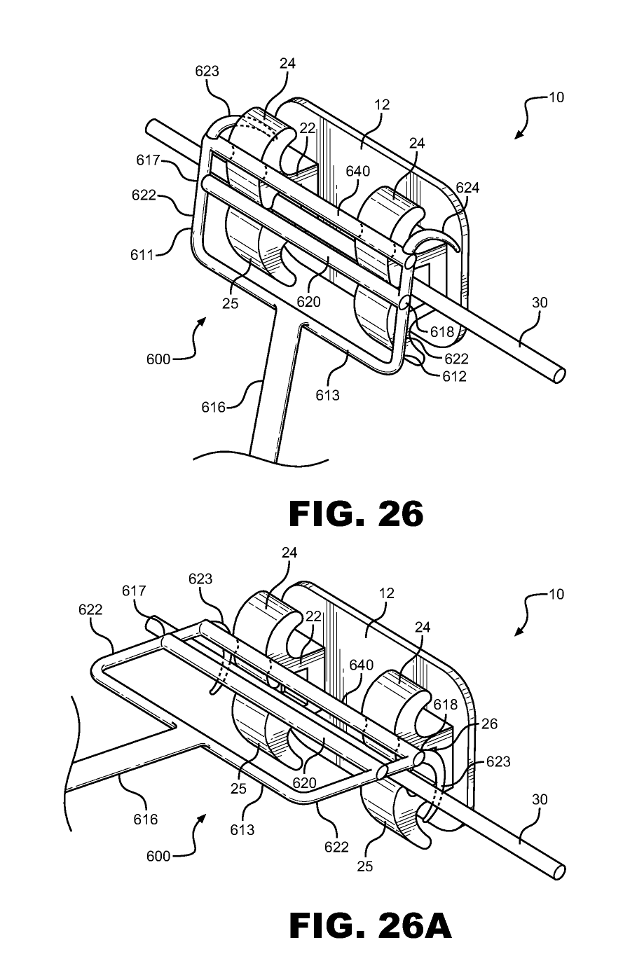

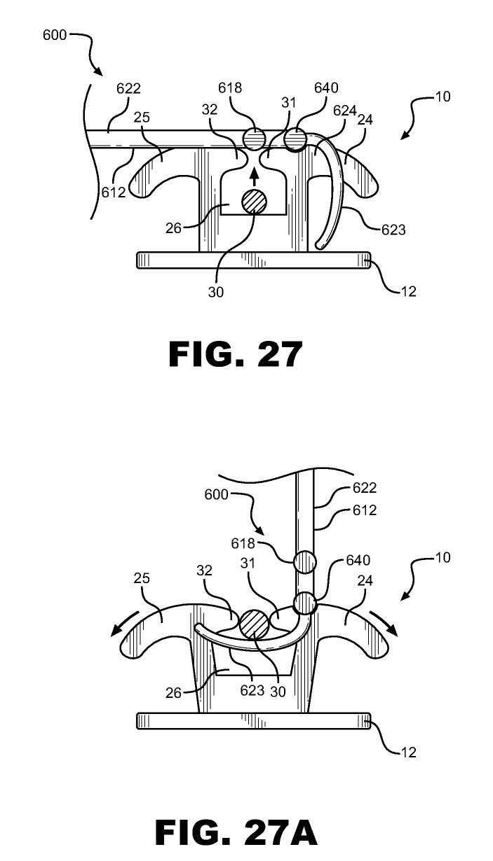

In addition the head portion 620, the tool 600 also includes a pivot bar 640. The pivot bar 640 is parallel the head portion 620 and attaches to the second arm portions 623 at a spaced distance from the pivots 617 and 618 of each of the side arms 611 and 612, respectively. The pivot bar 640 is designed to cooperate with recesses located in at least one head portion of each of the tie wings 20 and 21 of the bracket 10, as shown in FIGS. 26-27A.

The tool 600 also includes a handle 616, which is connected to the connection bar 613. The handle 616 may extend perpendicularly from the connection bar 613 may extend generally parallel to the connection bar 513. Further, the handle 616 may be bent, as shown in FIG. 17D with respect to the tool 400, or the handle 616 may be a ring, as shown in FIG. 17E with respect to the tool 400. Similarly, the handle 616 may be a hollow rectangular shape, as shown in FIGS. 17F-17G with respect to the tool 400. In fact, the handle 616 can be positioned in any suitable orientation or be any suitable shape which allows an orthodontist to rotate to the tool 600 to remove an archwire from a bracket. Moreover, like the tools 400 and 500, the tool 600 uses a rotational motion to separate a retentive component of an orthodontic bracket and remove an archwire therefrom, so the position of the head portion 620 relative second arm portion 623 of each of the side arms 611 and 612 allows an orthodontist to approach the retentive component at various angles, as explained above with respect to tool 400.

To use the wire disengagement tool 600 to disengage and remove an archwire 30 from an archwire slot 26 of an orthodontic bracket 10, an orthodontist places the tool 600 against the bracket 10 so that the head portion 620 engages the retentive component, namely the inner flanges 31 and 32 of the upper portions 24 and 25 of the tie wings 20 and 21, respectively, and the pivot bar 640 rests in the recesses located in at least one of the head portions 24 of the tie wings 20 and 21. Once the head portion 620 engages the retentive component, the pivot points 617 and 618 of each of the side arms 611 and 612 will likewise engage the retentive component and be positioned at the top of the archwire slot 26, as shown in FIG. 27. When the pivot points 617 and 618 are located above the archwire slot 26, the second arm portion 623 of each of the side arms 611 and 612 will be located adjacent the archwire slot 26, as also shown FIG. 27.

Once the orthodontist positions the tool 600 on the bracket 10, the orthodontist applies a slight downward force to urge the head portion 620 between the retentive components of the bracket 10. As a result of the downward force, the head portion 620 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

Simultaneous with the application of a downward force, the orthodontist rotates the handle 616 so that the pivot bar 640 pivots within the recesses in the at least one upper portion 24 of the tie wings 20 and 21 approximately 90° in a direction to move the second arm portion 623 of each of the side arms 611 and 612 from a position adjacent the archwire slot 26 to a position underneath the slot 26, as shown in FIG. 27A. Not only does this rotational motion move the second arm portions 623 underneath the archwire 26 and subsequently underneath the archwire 30 therein, but it also causes the archwire to move into the clearance 624 of each of the side arms 611 and 612, as also shown in FIG. 27A. Once the archwire 30 is retained in the clearance 624 of the side arms 611 and 612, the orthodontist can the easily lift the archwire 30 vertically from the archwire slot 26 through the space between the tie wings 20 and 21 created by the head portion 620.

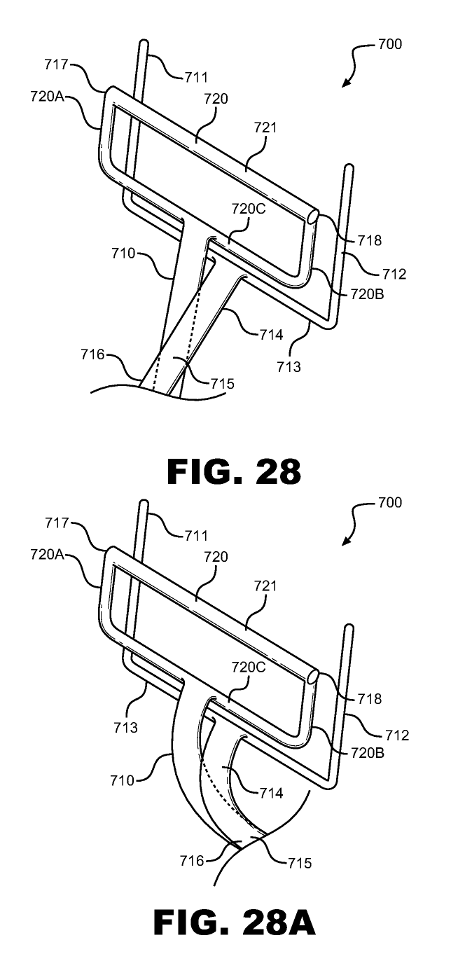

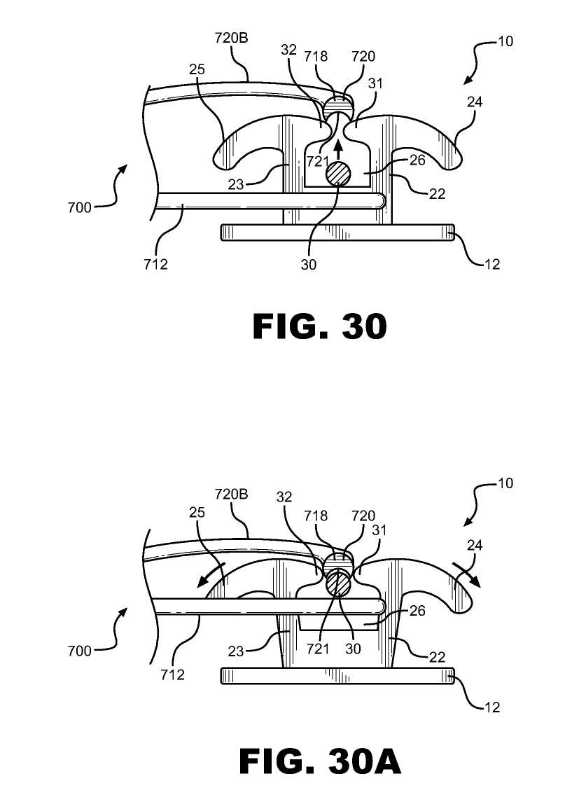

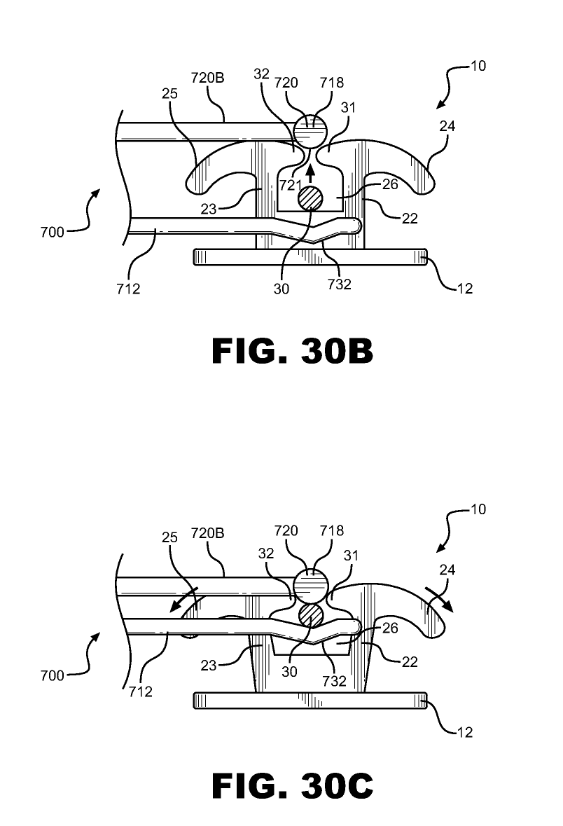

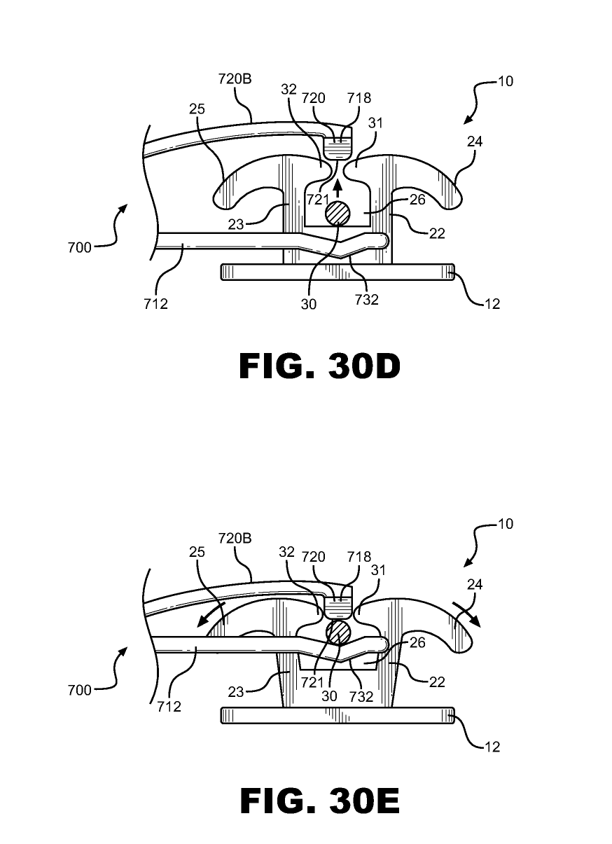

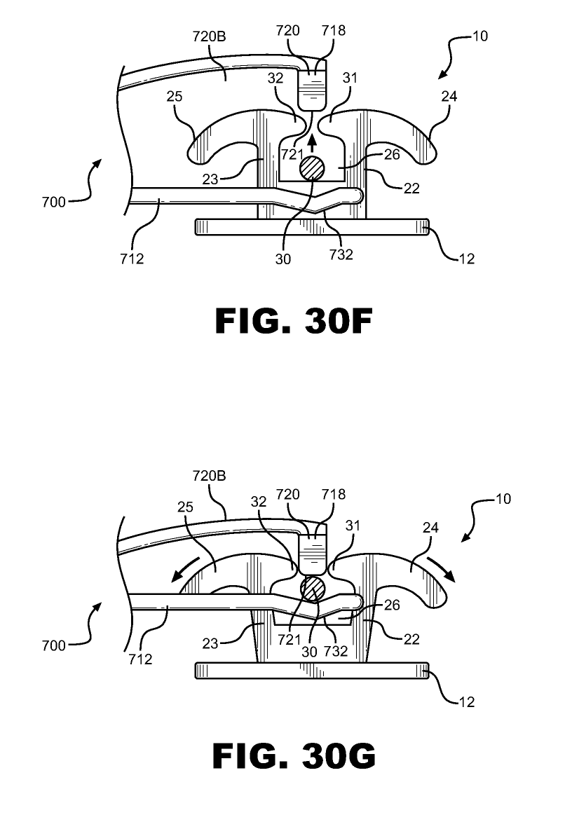

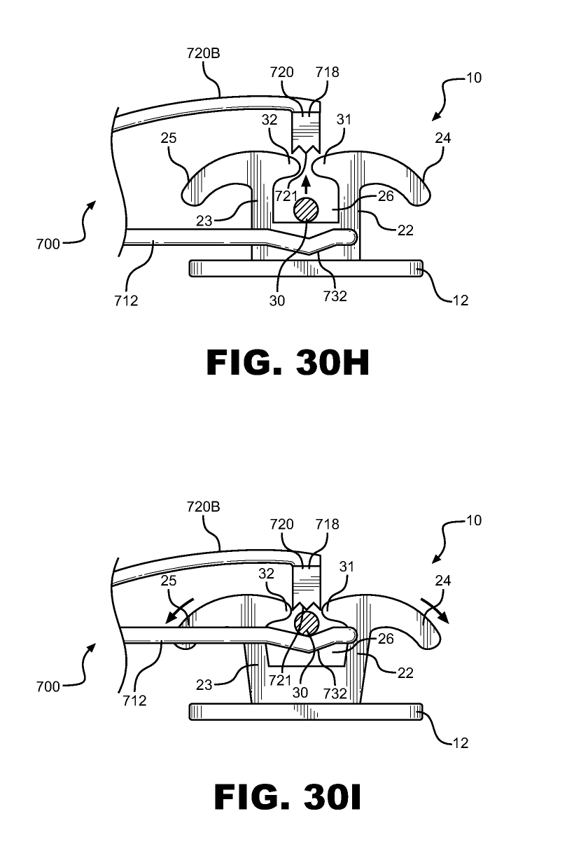

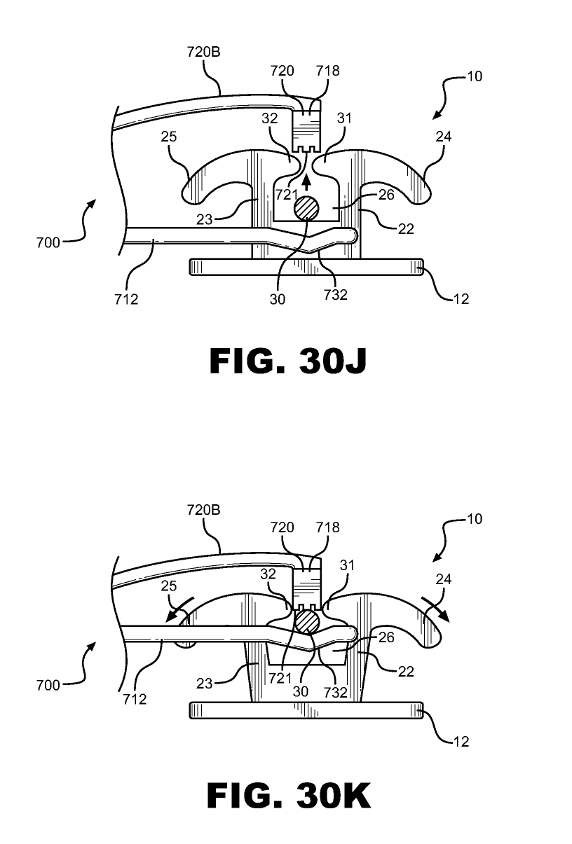

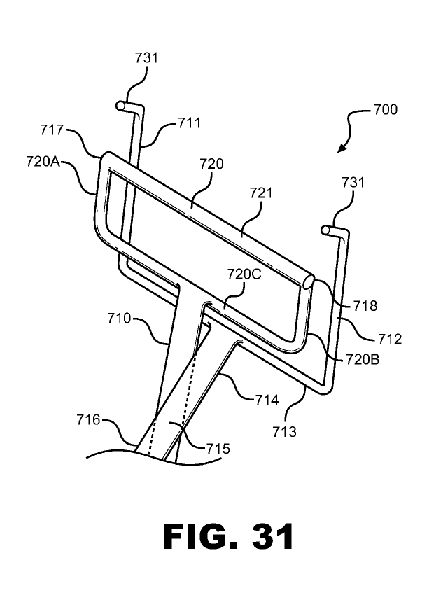

Another embodiment of a wire disengagement tool in accordance with the present invention is shown in FIGS. 28-34A. The tool 700 is essentially a hybrid of the tool 100 and the tool 400 and allows an orthodontist to use a plier-like motion, a rotational motion, or both to remove an archwire from an archwire slot. The tool 700 comprises a center arm 710 and side arms 711 and 712 located on either side of the center arm 710. The center arm 710 includes a head portion 720, which is connected to the center arm 710 via center arm side bars 710a and 710b and center arm connection bar 710c. Specifically, the center arm connection bar 710c is attached to the center arm 710 and extends transversely from the center arm 710. Each of the ends of the center arm connection bar 710c connect to first ends of the center arm side arms bars 710a and 710b, respectfully. The second and opposite ends of the center arm side bars 710a and 710b each connect to the head portion 720 at pivot points 717 and 718, respectively, so that the head portion 720 extends between the center arm side bars 710a and 710b. Consequently, the head portion 720 is essentially parallel to the center arm connection bar 710c. Further, the orientation of the center arm 710 and side arms 711 and 712 allows the center arm 710 to be substantially parallel to the bracket base 12 when the tool engages the bracket 10, as shown in FIGS. 30-30K, 33-33C, and 34-34A, such that an orthodontist can approach the bracket 10 from the side.

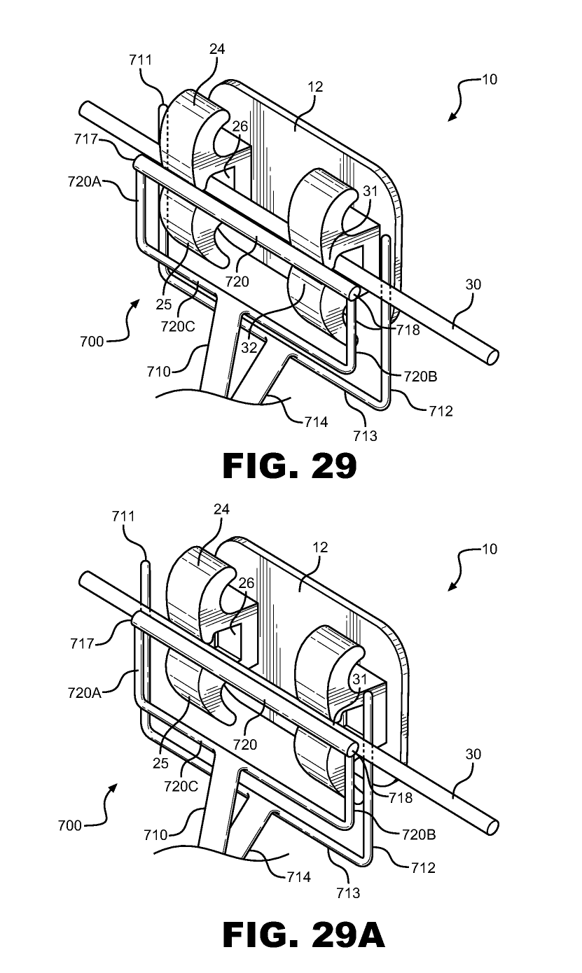

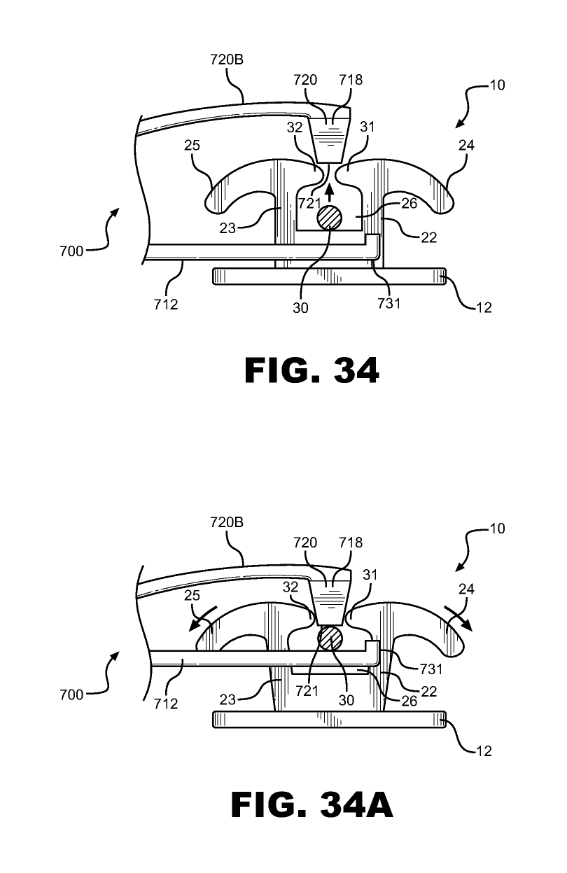

In the embodiment shown in FIGS. 28-29A, the head portion 720 has a round surface. However, the head portion 720 may have a concave surface, as shown in FIGS. 30-30A, a generally square-shaped cross-section, which preferably includes rounded corners, as shown in FIGS. 30D-30E, a generally rectangular-shaped cross-section, which preferably includes rounded corners, as shown in FIGS. 30E-30G, a wedge shape with a triangular cross-section, as shown in FIGS. 34-34A, a convex surface, any suitable shape and cross-section, or combination of shapes and a cross-sections, as discussed with respect to the head portion 120 of the tool 100. The head portion includes an engagement surface 721 which engages at least one tie wing of a bracket 10 when the tool 700 is in use Like the engagement surface 121, the engagement surface 721 may be a serrated or toothed surface or may include a pad or cushion. The teeth of the engagement surface 121 may be triangular in cross-section, as shown in FIGS. 30H-I, rectangular in cross-section, as shown in FIGS. 30J-30K, or any other suitable shape or cross-section. The head portion 720 may also include an area of increased thickness adjacent each of the pivot points 717 and 718, similar to the embodiment of the tool 400 shown in FIG. 17A. Further, these areas of increased thickness may be tapered, as shown with respect to the tool 400 in FIG. 17B.

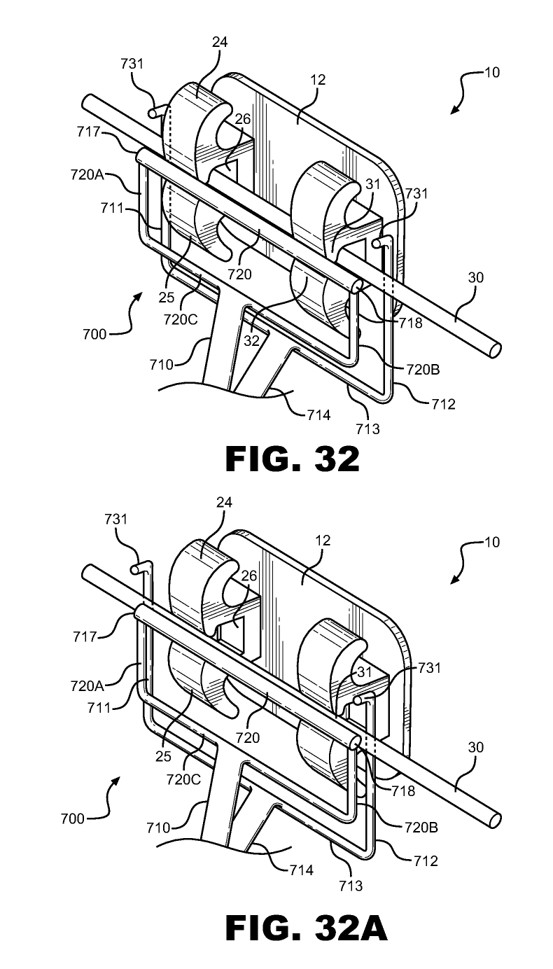

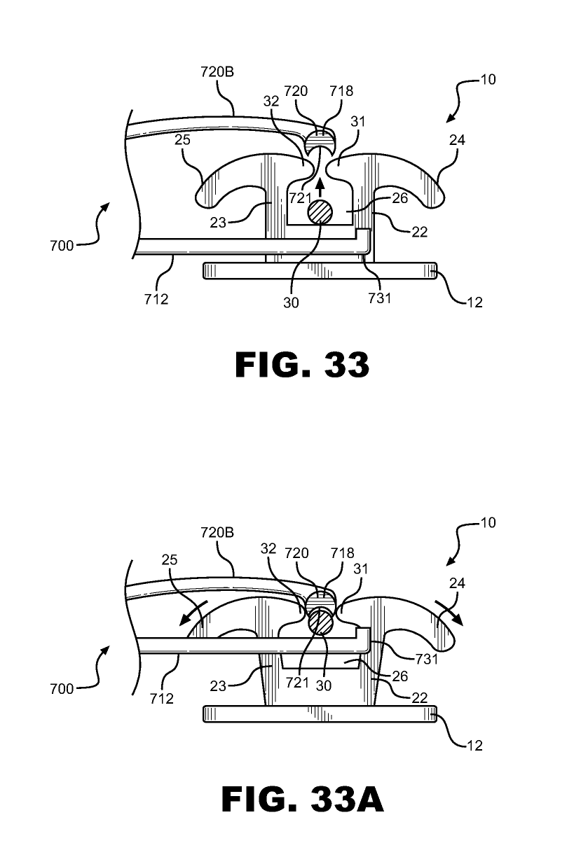

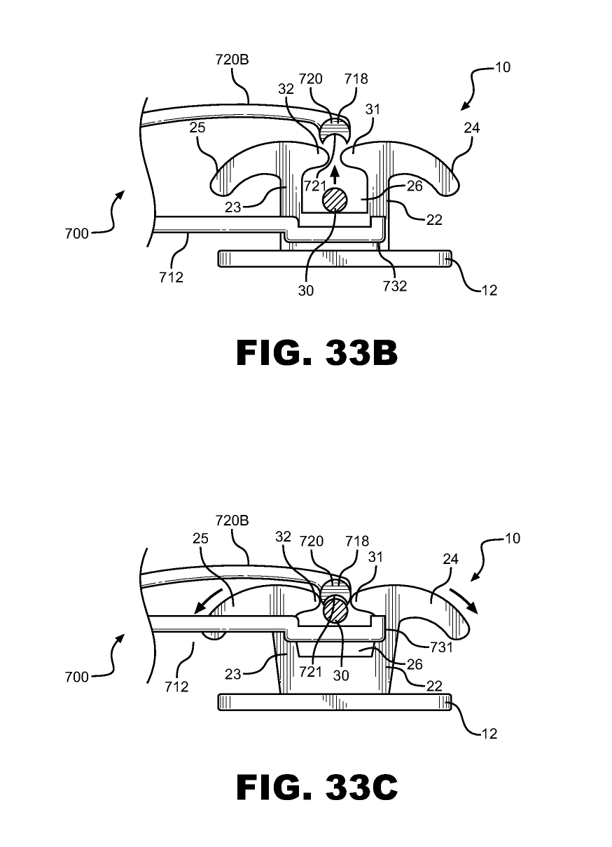

The side arms 711 and 712 are connected by a connection bar 713. Further, each of the side arms 711 and 712 preferably includes a grasping means for grasping an archwire 30 when the wire disengaging tool 700 is in use, and the grasping means is preferably a hook 731, as shown in FIGS. 32-34A. Another example of a grasping means is an indentation 732 in one or both of the side arms 711 and 712. Not only does the indentation 732 aid in grasping an archwire 30, but the indentation 732 may also act as a positioning means for aligning the archwire 30. The indentation 732 may be rectangular in cross-section, as shown in FIGS. 33B and 33C, V-shaped in cross-section, as shown in FIGS. 30B and 30C, or any other suitable shape that provides for grasping and aligning an archwire. In addition to the hook 731 and the indentation 732, any other suitable means for engaging an archwire 30 may be used.

The connection bar 713 and side arms 711 and 712 are connected to the center arm 710 via a side arm control bar 714, which is pivotally connected to the center arm 710 at a pivot point 715. As a result, side arm control bar 714 and the center arm 710 form a plier-like handle 716 that allows an orthodontist to not only grip the tool 700, but also move the side arms 711 and 712 and the center arm 710 relative to each other. Further, the plier-like handle 716 can extend substantially perpendicularly to the head portion 720, as shown in FIG. 28, generally parallel to the head portion 720, as shown in FIG. 28A, and in any suitable direction relative the head portion 720.

To use the wire disengagement tool 700 to disengage and remove an archwire 30 from an archwire slot 26 of an orthodontic bracket 10, an orthodontist moves the two components of the plier-like handle 716, namely the side arm control bar 714 and the center arm 710, apart about the pivot point 715 to create a space between the center arm 710 and the side arms 711 and 712. The orthodontist then places the tool 700 against the bracket 10 so that the side arms 711 and 712 are positioned underneath the archwire 30, as shown in FIGS. 29, 30, 30B, 3233, 33B and 34. The orthodontist also places the center arm 710 between the retentive component, namely tie wings 20 and 21, so that the head portion 720 of the center arm 710 engages the upper portions 24 and 25 of the tie wings 20 and 21. Once the head portion 720 engages the retentive component, the pivot points 717 and 718 of each of the side arms 711 and 712 will likewise engage the retentive component and be positioned at the top of the archwire slot 26, as also shown in these Figures. In this position, the center arm 710 is generally parallel to the bracket base 12.

Once the orthodontist positions the tool 700 on the bracket 10, as described above, the orthodontist squeezes the side arm control bar 714 and the center arm 710 of the plier-like handle 716 together, which forces the center arm 710 downwardly toward the side arms 711 and 712 and the archwire slot 26. As a result of the downward force, the head portion 720 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

In addition to the forcing the center arm 710 downwardly, the squeezing of the plier-like handle 716 concurrently forces the side arms 711 and 712 upwardly toward the center arm 710, as shown in FIGS. 29A, 30A, 30C, 32A, 33A, 33C, and 34A. Consequently, as the head portion 720 of the center arm 710 maintains the tie wings in flexed, outwardly-extended position, the side arms 711 and 712 lift the archwire 30 toward the head portion 720 so that the archwire 30 is retained in a friction fit between the head portion 720 and the side arms 711 and 712. Simultaneous with the application of the force to the handle 716 to create a scissor-like motion between the center arm 710 and the side arm control bar 714, the orthodontist can rotate the handle 716 so that so that the head portion 720 pivots about the pivot points 717 and 718 to assure the archwire 30 is secured between the head portion 720 and the side arms 711 and 712. After the archwire 30 is retained between the head portion 720 and the side arms 711 and 712 and the orthodontist rotates the tool 700 as necessary, the orthodontist can the easily lift the archwire 30 vertically from the archwire slot 26 through the space between the tie wings 20 and 21 created by the head portion 720 of the center arm 710. Consequently, this embodiment allows the orthodontist to use both a scissor-like motion between the center arm 710 and the side arms 711 and 712 and rotational motion to easily disengage the wire 30 from the slot 26.

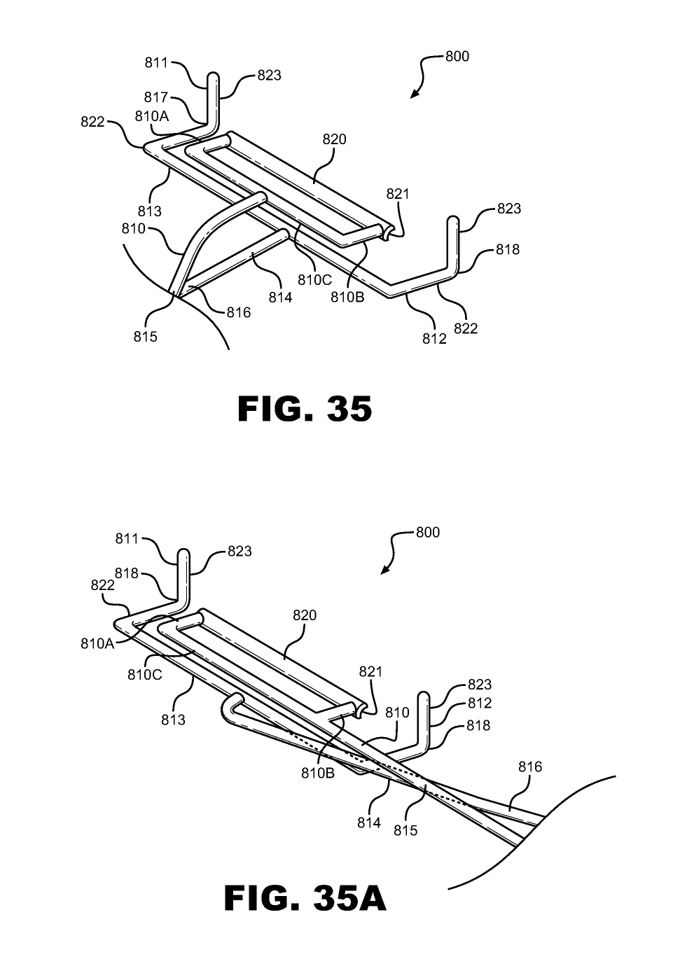

Another embodiment of a wire disengagement tool in accordance with the present invention is shown in FIGS. 35-38E. The tool 800 is similar to the tool 700 shown in FIGS. 28-34A. The tool 800 comprises a center arm 810 and side arms 811 and 812 located on either side of the center arm 810. The center arm 810 includes a head portion 820, which is connected to the center arm 810 via center arm side bars 810a and 810b and center arm connection bar 810c. Specifically, the center arm connection bar 810c is attached to the center arm 810 and extends transversely from the center arm 810. Each of the ends of the center arm connection bar 810c connect to first ends of the center arm side arms bars 810a and 810b, respectfully. The second and opposite ends of the center arm side bars 810a and 810b each connect to the head portion 820 so that the head portion 820 extends between and may extend past the center arm side bars 810a and 810b. Consequently, the head portion 820 is essentially parallel to the center arm connection bar 810c.

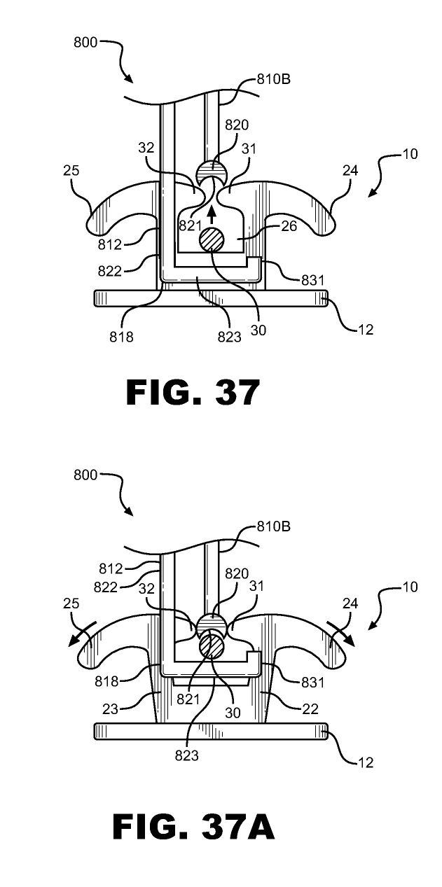

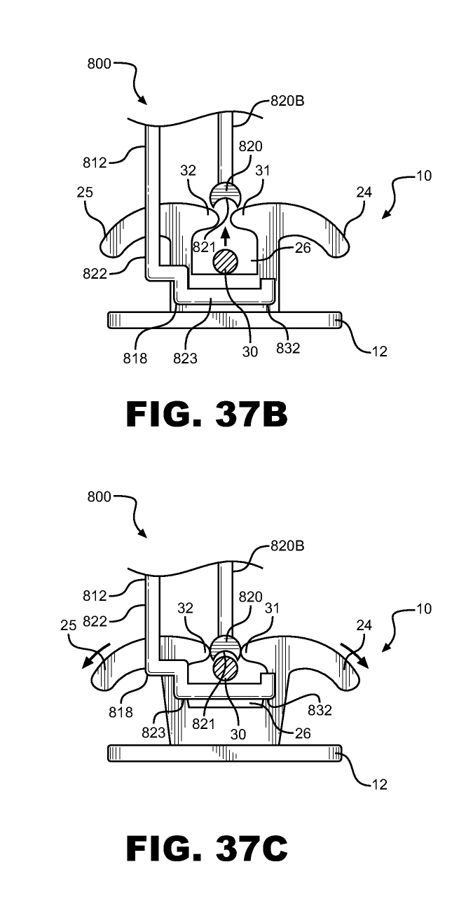

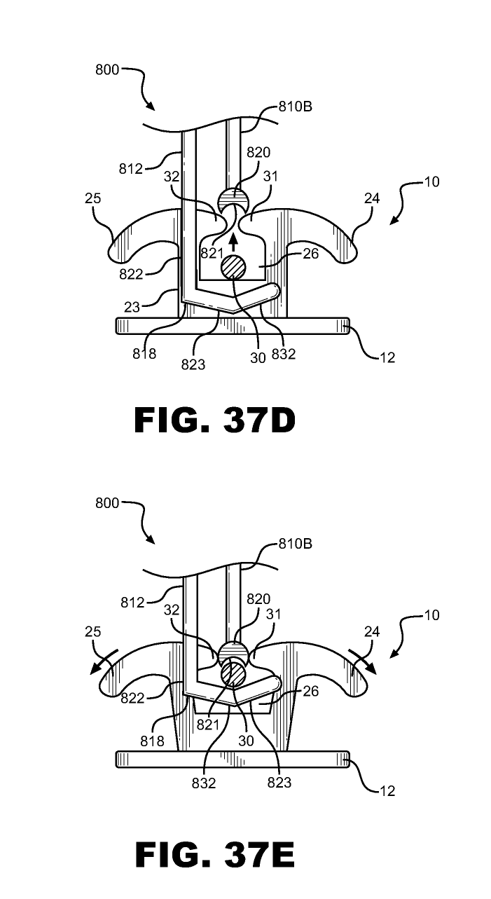

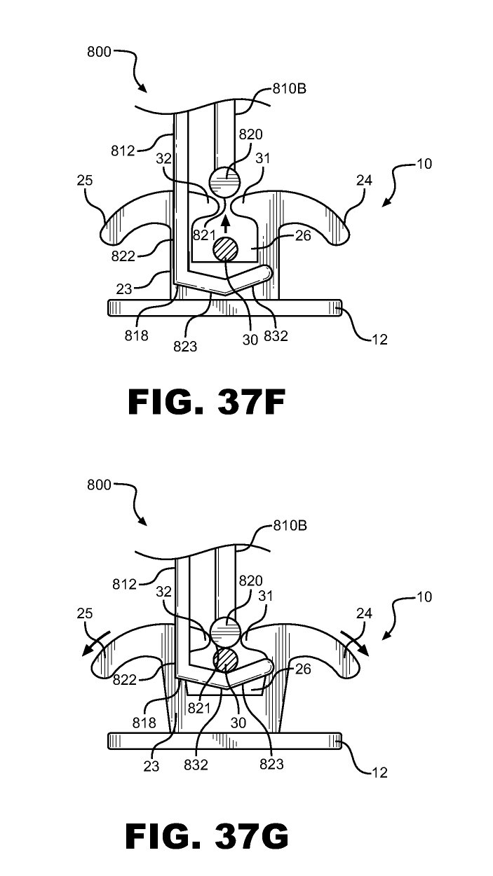

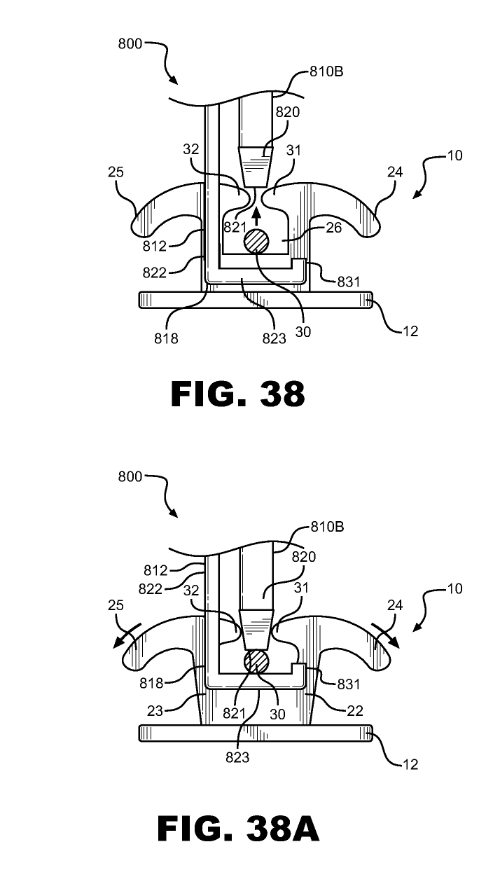

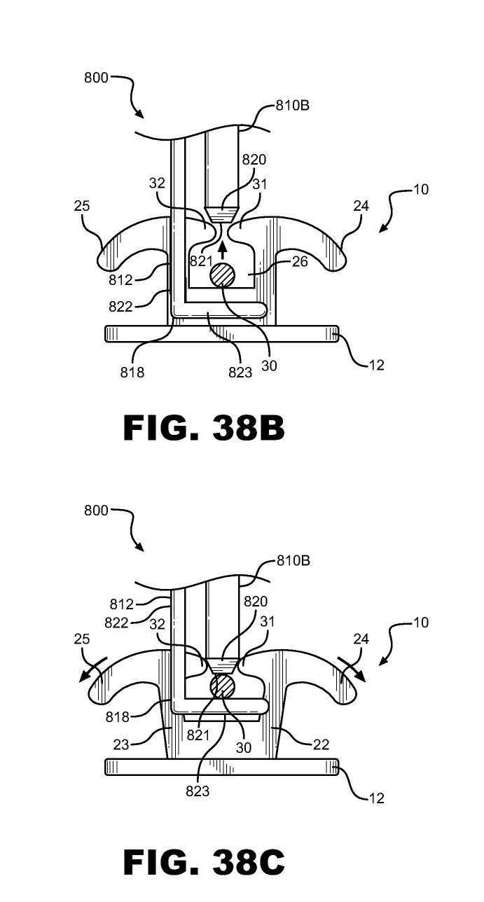

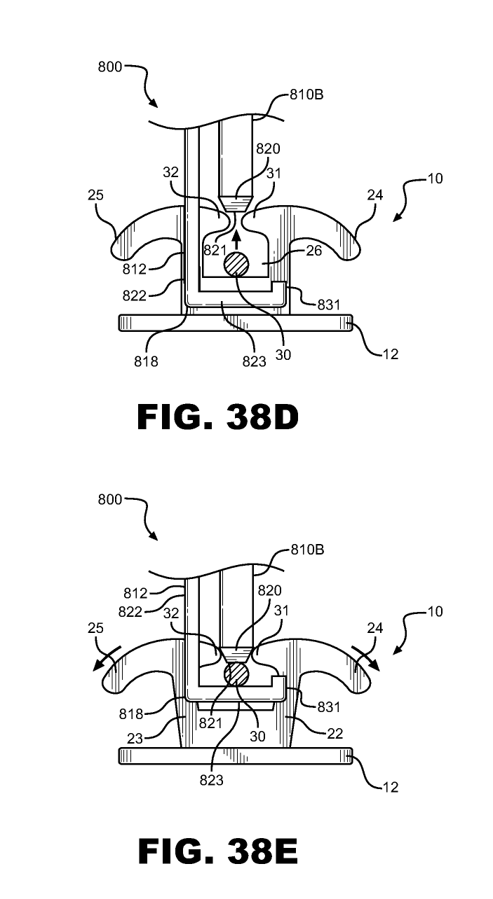

In the embodiment shown in FIGS. 35-37E, the head portion 820 has a concave surface. However, the head portion 820 may have a round surface, as shown in FIGS. 37F and 37G, a wedge shape with a triangular cross-section, as shown in FIGS. 38 and 38A, a truncated wedge shape with a generally trapezoidal cross-section, as shown in FIGS. 38B-38E, a convex surface, a generally square cross-section, a rectangular cross-section, any suitable shape and cross-section, or combination of shapes and cross-sections. The head portion 820 includes an engagement surface 821 which engages at least one tie wing of a bracket 10 when the tool 800 is in use Like the engagement surface 121, the engagement surface 821 may be a serrated or toothed surface or may include a pad or cushion.

The side arms 811 and 812 are connected by a connection bar 813. Each of the side arms 811 and 812 include a first arm portion 822 and a second arm portion 823. The first arm portion 822 extends from a first end of each of the side arms 811 and 812 that is connected to the connection bar 813 to bends 817 and 818, located approximately mid-length of each of the side arms 811 and 812. The second arm portion 823 extends from the bend points 817 and 818, respectively, to a second end of each of the side arms 811 and 812 that is opposite the connection bar 813.

Further, each of the side arms 811 and 812 preferably includes a grasping means for grasping an archwire 30 when the wire disengaging tool 800 is in use, and the grasping means is preferably a hook 831, as shown in FIGS. 37, 37A, 38, 38A, 38D, and 38E. Another example of a grasping means is an indentation 832 in the second arm portion 823 of one or both of the side arms 811 and 812. Not only does the indentation 832 aid in grasping an archwire 30, but the indentation 832 may also act as a positioning means for aligning the archwire 30. The indentation 832 may be rectangular in cross-section, as shown in FIGS. 37B and 37C, V-shaped in cross-section, as shown in FIGS. 37D-37G, or any other suitable shape that provides for grasping and aligning an archwire. In addition to the hook 831 and the indentation 832, any other suitable means for engaging an archwire 30 may be used.

The connection bar 813 and side arms 811 and 812 are connected to the center arm 810 via a side arm control bar 814, which is pivotally connected to the center arm 810 at a pivot point 815. As a result, side arm control bar 814 and the center arm 810 form a plier-like handle 816 that allows an orthodontist to not only grip the tool 800, but also move the side arms 811 and 812 and the center arm 810 relative to each other. Further, the plier-like handle 816 can extend substantially perpendicularly to the head portion 820, as shown in FIG. 35, generally parallel to the head portion 820, as shown in FIG. 35A, and in any suitable direction relative the head portion 820.

While the tool 800 is very similar to the tool 700, a distinction between the two embodiments is the orientation of the center arm relative to the side arms. With regard to the tool 700, the orientation of the center arm 710 and side arms 711 and 712 allows the center arm 710 to be substantially parallel to the bracket base 12 when the tool engages the bracket 10, as shown in FIGS. 30, 30A, 30B, 30C, 33, 33A, 33B, 33C, 34 and 34A, such that an orthodontist can approach the bracket 10 from the side. Unlike the tool 700, the orientation of the center arm 810 allows the center arm 810 to be substantially perpendicular to the bracket base 12 when an orthodontist places the tool 800 on a bracket 10 to enable the orthodontist to approach the bracket from the top, as shown in FIGS. 37-38E.

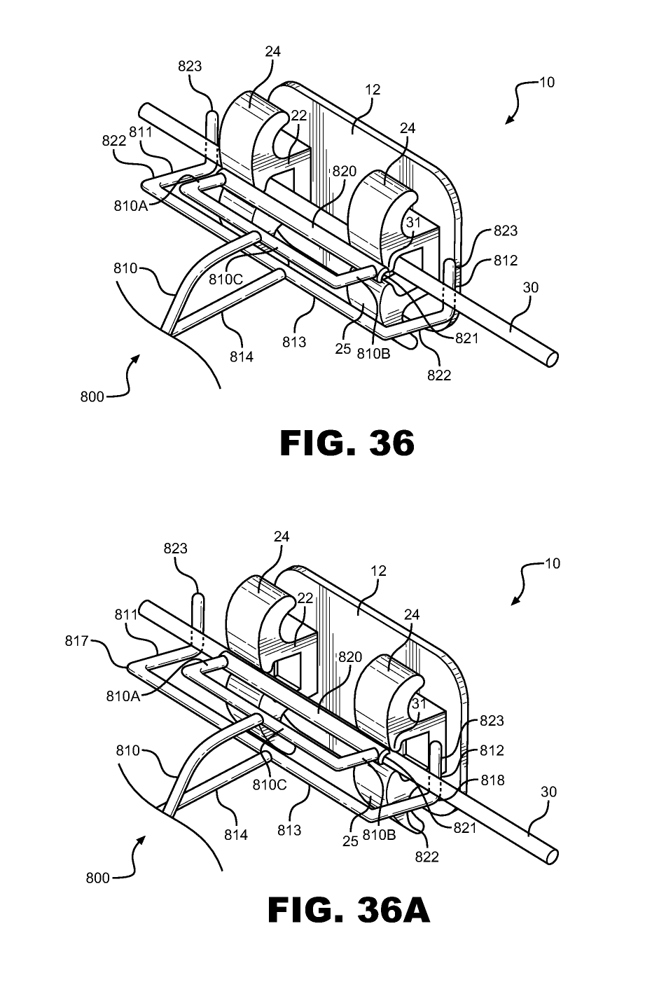

To use the wire disengagement tool 800 to disengage and remove an archwire 30 from an archwire slot 26 of an orthodontic bracket 10, an orthodontist moves the two components of the plier-like handle 816, namely the side arm control bar 814 and the center arm 810, apart about the pivot point 815 to create a space between the center arm 810 and the side arms 811 and 812. The orthodontist then places the tool 800 against the bracket 10 so that the first arm portion 822 is adjacent the wire 30 and the second arm portion 823 of the side arms 811 and 812 are positioned underneath the archwire 30, as shown in FIGS. 36, 37, 37B, 37D, 37F, 38, 38B, and 38D. The orthodontist also places the center arm 810 between the retentive component, namely tie wings 20 and 21, so that the head portion 820 of the center arm 810 engages the upper portions 24 and 25 of the tie wings 20 and 21. In this position, the center arm 810 is generally perpendicular to the bracket base 12.

Once the orthodontist positions the tool 800 on the bracket 10, as described above, the orthodontist squeezes the side arm control bar 814 and the center arm 810 of the plier-like handle 816 together, which forces the center arm 810 downwardly toward the side arms 811 and 812 and the archwire slot 26. As a result of the downward force, the head portion 820 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

In addition to the forcing the center arm 810 downwardly, the squeezing of the plier-like handle 816 concurrently forces the second arm portion 823 of the side arms 811 and 812 upwardly toward the center arm 810, as shown in FIGS. 36A, 37A, 37C, 37E, 37G, 38A, 38C and 38E. Consequently, as the head portion 820 of the center arm 810 maintains the tie wings in flexed, outwardly-extended position, the second arm portion 823 of the side arms 811 and 812 lift the archwire 30 toward the head portion 820 so that the archwire 30 is retained in a friction fit between the head portion 820 and the side arms 811 and 812. Simultaneous with the application of the force to the handle 816 to create a scissor-like motion between the center arm 810 and the side arm control bar 814, the orthodontist can rotate the handle 816 to assure the archwire 30 is secured between the head portion 820 and the second arm portion 823 of the side arms 811 and 812. After the archwire 30 is retained between the head portion 820 and the side arms 811 and 812 and the orthodontist rotates the tool 800 as necessary, the orthodontist can the easily lift the archwire 30 vertically from the archwire slot 26 through the space between the tie wings 20 and 21 created by the head portion 820 of the center arm 810.

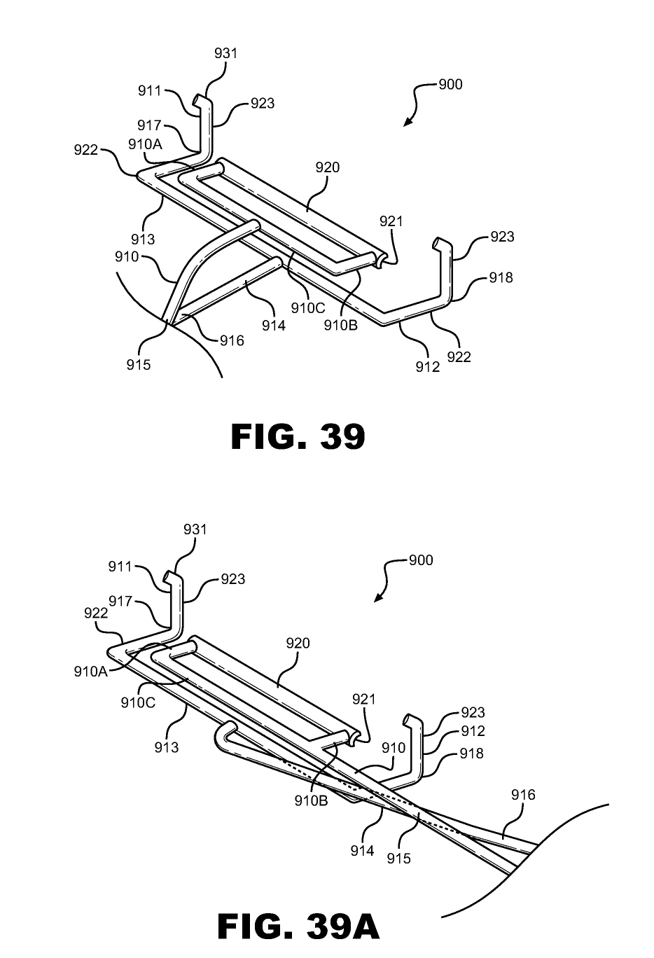

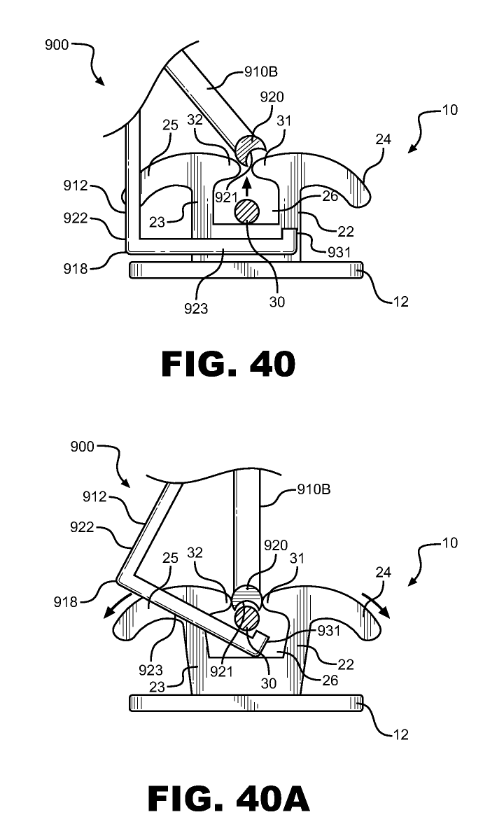

Yet another alternate embodiment of a wire disengagement tool in accordance with the present invention is shown in FIGS. 39-40A. The tool 900 is similar to the tool 700 shown in FIGS. 28-34A. The tool 900 comprises a center arm 910 and side arms 911 and 912 located on either side of the center arm 910. The center arm 910 includes a head portion 920, which is connected to the center arm 910 via center arm side bars 910a and 810b and center arm connection bar 810c. Specifically, the center arm connection bar 910c is attached to the center arm 910 and extends transversely from the center arm 910. Each of the ends of the center arm connection bar 910c connect to first ends of the center arm side arms bars 910a and 910b, respectfully. The second and opposite ends of the center arm side bars 910a and 910b each connect to the head portion 920 so that the head portion 920 extends between and may extend past the center arm side bars 910a and 910b. Consequently, the head portion 920 is essentially parallel to the center arm connection bar 910c.

In the embodiment shown in FIGS. 39-40A, the head portion 920 has a concave surface. However, the head portion 920 may have a round surface, a convex surface, a wedge shape, a truncated wedge shape, a square shape, a rectangular shape, any suitable shape and cross-section, or combination of suitable shapes and cross-sections. The head portion 920 includes an engagement surface 921 which engages at least one tie wing of a bracket 10 when the tool 900 is in use Like the engagement surface 121, the engagement surface 921 may be a serrated or toothed surface or may include a pad or cushion.

The side arms 911 and 912 are connected by a connection bar 913. Each of the side arms 911 and 912 include a first arm portion 922 and a second arm portion 923. The first arm portion 922 extends from a first end of each of the side arms 911 and 912 that is connected to the connection bar 913 to bends 917 and 918, located approximately mid-length of each of the side arms 911 and 912. The second arm portion 923 extends from the bend points 917 and 918, respectively, to a second end of each of the side arms 911 and 912 that is opposite the connection bar 913. Further, each of the side arms 911 and 912 preferably includes a grasping means for grasping an archwire 30 when the wire disengaging tool 900 is in use, and the grasping means is preferably a hook 931. Another example of a grasping means is an indentation in the second arm portion 923 of one or both of the side arms 911 and 912. Not only does the indentation aid in grasping an archwire 30, but the indentation may also act as a positioning means for aligning the archwire 30. The indentation may be rectangular in cross-section, V-shaped in cross-section, or any other suitable shape that provides for grasping and aligning an archwire. In addition to the hook 931 and the indentation, any other suitable means for engaging an archwire 30 may be used.

The connection bar 913 and side arms 911 and 912 are connected to the center arm 910 via a side arm control bar 914, which is pivotally connected to the center arm 910 at a pivot point 915. As a result, side arm control bar 914 and the center arm 910 form a plier-like handle 916 that allows an orthodontist to not only grip the tool 900, but also move the side arms 911 and 912 and the center arm 910 relative to each other. Further, the plier-like handle 916 can extend substantially perpendicularly to the head portion 920, as shown in FIG. 39, generally parallel to the head portion 920, as shown in FIG. 39A, and in any suitable direction relative the head portion 920.

While the tool 900 is very similar to the tool 700, a distinction between the two embodiments is the orientation of the center arm relative to the side arms. Unlike the tool 700, the orientation of the center arm 910 of the tool 900 allows the center arm 910 to be at approximately a 45° angle to the bracket base 12, as shown in FIGS. 40 and 40A.

To use the wire disengagement tool 900 to disengage and remove an archwire 30 from an archwire slot 26 of an orthodontic bracket 10, an orthodontist moves the two components of the plier-like handle 916, namely the side arm control bar 914 and the center arm 910, apart about the pivot point 915 to create a space between the center arm 910 and the side arms 911 and 912. The orthodontist then places the tool 900 against the bracket 10 so that the first arm portion 922 is adjacent the wire 30 and the second arm portion 923 of the side arms 911 and 912 are positioned underneath the archwire 30, as shown in FIG. 40. The orthodontist also places the center arm 810 between the retentive component, namely tie wings 20 and 21, so that the head portion 920 of the center arm 910 engages the upper portions 24 and 25 of the tie wings 20 and 21. In this position, due the orientation of the center arm 910 and the side arms 911 and 912, the center arm is positioned at approximately a 45° angle to the bracket base 12.

Once the orthodontist positions the tool 900 on the bracket 10, as described above, the orthodontist squeezes the side arm control bar 914 and the center arm 910 of the plier-like handle 916 together, which forces the center arm 910 downwardly toward the side arms 911 and 912 and the archwire slot 26 and rotates the handle 916 approximately 45° so that the center arm 910 is perpendicular to the bracket base 12 and directly above the archwire slot 26, as shown in FIG. 40A. As a result of the downward force, the head portion 920 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

In addition to the forcing the center arm 910 downwardly, the squeezing of the plier-like handle 916 concurrently forces the second arm portion 923 of the side arms 911 and 912 upwardly toward the center arm 910, as shown in FIG. 40A. Consequently, as the head portion 920 of the center arm 910 maintains the tie wings in flexed, outwardly-extended position, the second arm portion 923 of the side arms 911 and 912 lift the archwire 30 toward the head portion 920 so that the archwire 30 is retained in a friction fit between the head portion 920 and the side arms 911 and 912. Simultaneous with the application of the force to the handle 916 to create a scissor-like motion between the center arm 910 and the side arm control bar 914, the orthodontist can rotate the handle 916 to assure the archwire 30 is secured between the head portion 920 and the second arm portion 923 of the side arms 911 and 912. After the archwire 30 is retained between the head portion 920 and the side arms 911 and 912 and the orthodontist rotates the tool 900 as necessary, the orthodontist can the easily lift the archwire 30 vertically from the archwire slot 26 through the space between the tie wings 20 and 21 created by the head portion 920 of the center arm 910.

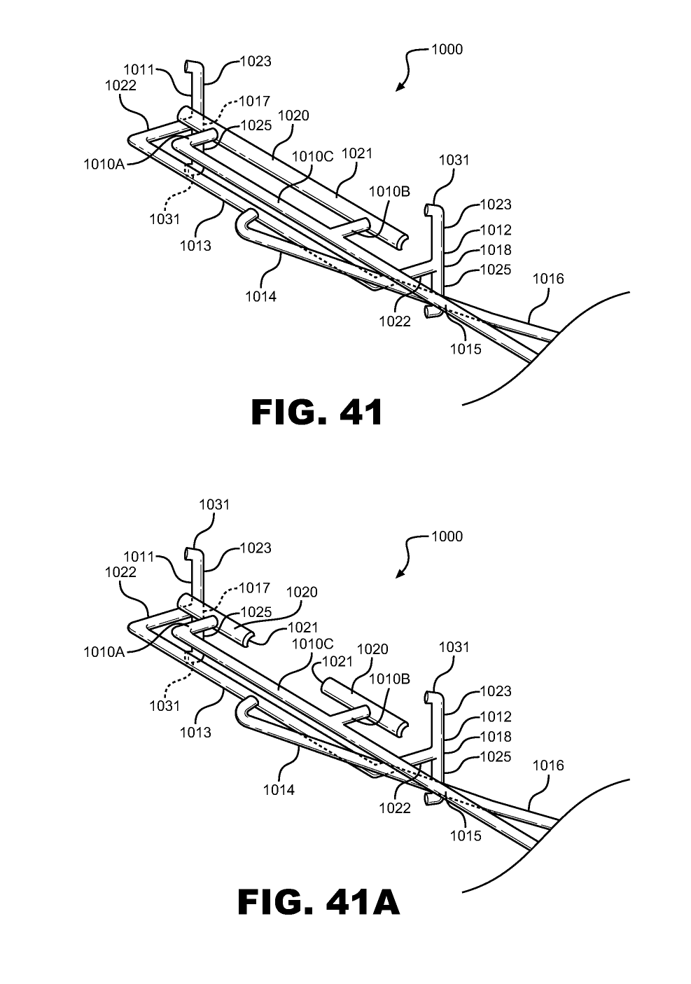

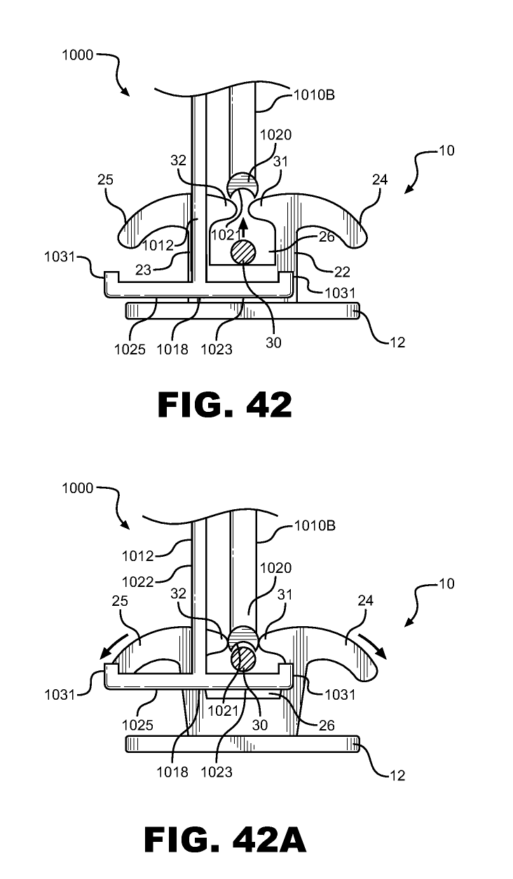

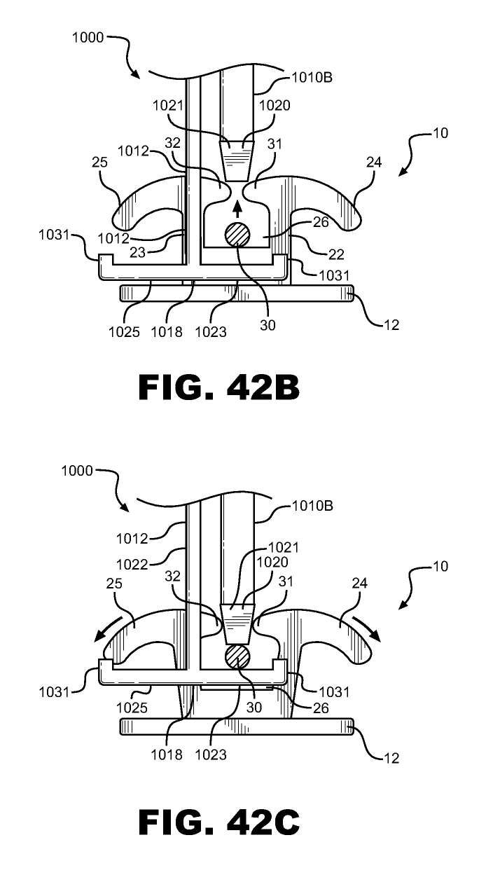

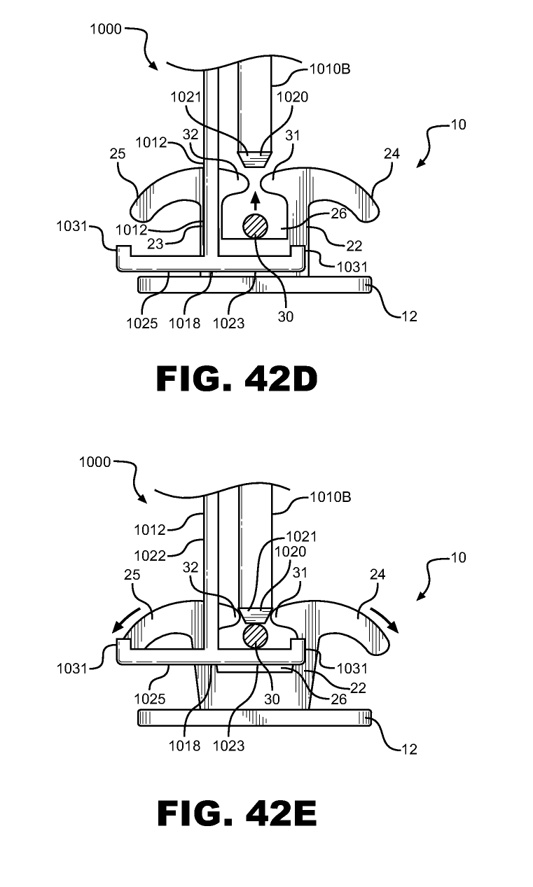

An alternate embodiment of a wire disengagement tool in accordance with the present invention is shown in FIGS. 41-42E. The tool 1000 is similar to the tool 900 shown in FIGS. 39-40A. The tool 1000 comprises a center arm 1010 and side arms 1011 and 1012 located on either side of the center arm 1010. The center arm 1010 includes a head portion 1020, which is connected to the center arm 1010 via center arm side bars 1010a and 1010b and center arm connection bar 1010c. Specifically, the center arm connection bar 1010c is attached to the center arm 1010 and extends transversely from the center arm 1010.

Each of the ends of the center arm connection bar 1010c connect to first ends of the center arm side arms bars 1010a and 1010b, respectfully. The second and opposite ends of the center arm side bars 1010a and 1010b each connect to the head portion 1020 so that the head portion 1020 extends between and may extend past the center arm side bars 1010a and 1010b. Consequently, the head portion 1020 is essentially parallel to the center arm connection bar 1010c. The head portion 1020 may also be split, as shown in FIG. 41A such that a first part of the head portion 1020 is attached to the center arm side bar 1010a and a second part of the head portion 1020 is attached the center arm side bar 1010b.

In the embodiment shown in FIGS. 41-42A, the head portion 1020 has a concave surface. However, the head portion 1020 may have a round surface, a convex surface, a wedge shape with a triangular cross-section, as show in FIGS. 42B and 42C, a truncated wedge shape, as shown in FIGS. 42D and 42E, a square shape, a rectangular shape, any suitable shape and cross-section, or combination of suitable shapes and cross-sections. The head portion 1020 includes an engagement surface 1021 which engages at least one tie wing of a bracket 10 when the tool 1000 is in use. Like the engagement surface 121, the engagement surface 1021 may be a serrated or toothed surface or may include a pad or cushion.

The side arms 1011 and 1012 are connected by a connection bar 1013. Each of the side arms 1011 and 1012 include a first arm portion 1022 and a second arm portion 1023. The first arm portion 1022 extends from a first end of each of the side arms 1011 and 1012 that is connected to the connection bar 1013 to bends 1017 and 1018, located approximately mid-length of each of the side arms 1011 and 1012. The second arm portion 1023 extends from the bend points 1017 and 1018, respectively, to a second end of each of the side arms 1011 and 1012 that is opposite the connection bar 1013. Further, each of the side arms 1011 and 1012 preferably includes a grasping means for grasping an archwire 30 when the wire disengaging tool 1000 is in use, and the grasping means is preferably a hook 1031.

In addition to the first arm portion 1022 and the second arm portion 1023, each of the side arms 1011 and 1012 may also include a third arm portion 1025, as shown in FIGS. 42-42E. Like the second arm portion 1023, the third arm portion 1025 extends from the bends 1017 and 1018, but in a direction opposite the second arm portion 1023. The benefit of having the third arm portion 1025 is an orthodontist can use the tool 1000 on either side of the mouth without having to change the orientation of the tool 1000 in his or her hand.

The connection bar 1013 and side arms 1011 and 1012 are connected to the center arm 1010 via a side arm control bar 1014, which is pivotally connected to the center arm 1010 at a pivot point 1015. As a result, side arm control bar 1014 and the center arm 1010 form a plier-like handle 1016 that allows an orthodontist to not only grip the tool 1000, but also move the side arms 1011 and 1012 and the center arm 1010 relative to each other. Further, the plier-like handle 1016 preferably extends generally parallel to the head portion 1020.

To use the wire disengagement tool 1000 to disengage and remove an archwire 30 from an archwire slot 26 of an orthodontic bracket 10, an orthodontist moves the two components of the plier-like handle 1016, namely the side arm control bar 1014 and the center arm 1010, apart about the pivot point 1015 to create a space between the center arm 1010 and the side arms 1011 and 1012. The orthodontist then places the tool 1000 against the bracket 10 so that the first arm portion 1022 is adjacent the wire 30 and the second arm portion 1023 of the side arms 1011 and 1012 are positioned underneath the archwire 30, as shown in FIGS. 42, 42B, and 42D. The orthodontist also places the center arm 1010 between the retentive component, namely tie wings 20 and 21, so that the head portion 1020 of the center arm 1010 engages the upper portions 24 and 25 of the tie wings 20 and 21. In this position, the center arm 1010 is generally perpendicular to the bracket base 12.

Once the orthodontist positions the tool 1000 on the bracket 10, as described above, the orthodontist squeezes the side arm control bar 1014 and the center arm 1010 of the plier-like handle 1016 together, which forces the center arm 1010 downwardly toward the side arms 1011 and 1012 and the archwire slot 26. As a result of the downward force, the head portion 1020 creates a wedge-like lateral force against the inner flanges 31 and 32 of the upper portions 24 and 25, respectively, of each of the tie wings 20 and 21 to cause the tie wings 20 and 21 to flex laterally and outwardly to create a gap between the inner flanges 31 and 32 the tie wings 20 and 21, respectively, above the archwire slot 26, which makes the archwire 30 in the archwire slot 26 accessible.

In addition to the forcing the center arm 1010 downwardly, the squeezing of the plier-like handle 1016 concurrently forces the second arm portion 1023 of the side arms 1011 and 1012 upwardly toward the center arm 1010, as shown in FIGS. 42A, 42C, and 42E. Consequently, as the head portion 1020 of the center arm 1010 maintains the tie wings in flexed, outwardly-extended position, the second arm portion 1023 of the side arms 1011 and 1012 lift the archwire 30 toward the head portion 1020 so that the archwire 30 is retained in a friction fit between the head portion 1020 and the side arms 1011 and 1012. Simultaneous with the application of the force to the handle 1016 to create a scissor-like motion between the center arm 1010 and the side arm control bar 1014, the orthodontist can rotate the handle 1016 to assure the archwire 30 is secured between the head portion 1020 and the second arm portion 1023 of the side arms 1011 and 1012. After the archwire 30 is retained between the head portion 1020 and the side arms 1011 and 1012 and the orthodontist rotates the tool 1000 as necessary, the orthodontist can the easily lift the archwire 30 vertically from the archwire slot 26 through the space between the tie wings 20 and 21 created by the head portion 1020 of the center arm 1010.

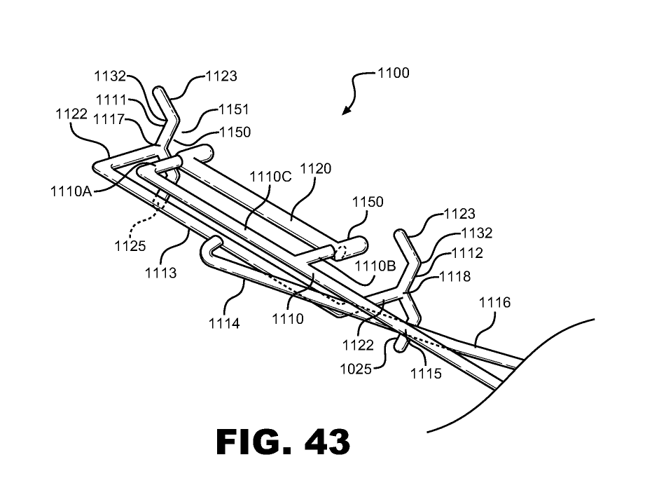

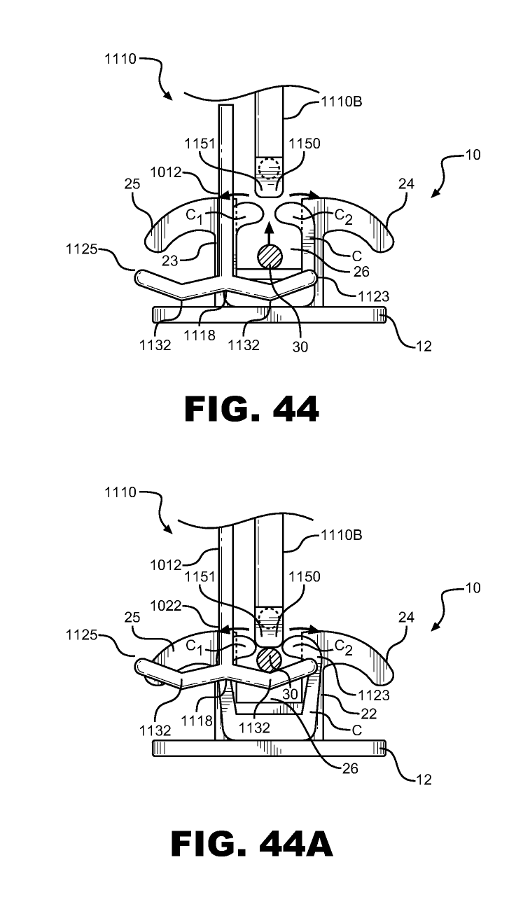

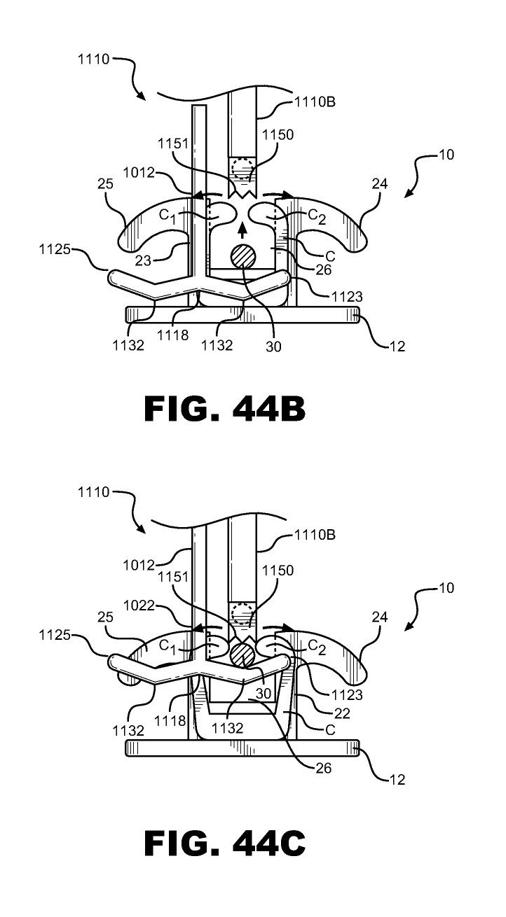

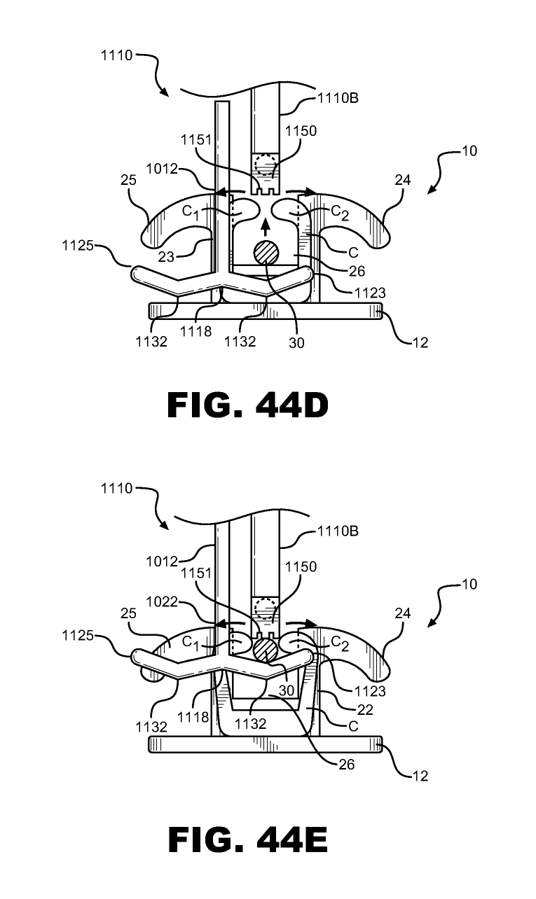

Yet another embodiment of a wire disengagement tool in accordance with the present invention is shown in FIGS. 43-44E. The tool 1100 is similar to the tool 1000 shown in FIGS. 41-42E. The tool 1100 comprises a center arm 1110 and side arms 1111 and 1112 located on either side of the center arm 1110. The center arm 1110 includes a head portion 1120, which is connected to the center arm 1110 via center arm side bars 1110a and 1110b and center arm connection bar 1110c. Specifically, the center arm connection bar 1110c is attached to the center arm 1110 and extends transversely from the center arm 1110.

Each of the ends of the center arm connection bar 1110c connect to first ends of the center arm side arms bars 1110a and 1110b, respectfully. The second and opposite ends of the center arm side bars 1110a and 1110b each connect to the head portion 1120 so that the head portion 1120 extends between and may extend past the center arm side bars 1110a and 1110b. Consequently, the head portion 1120 is essentially parallel to the center arm connection bar 1110c. The head portion 1120 may also be split, as discussed with respect to the tool 1000.

In the embodiment shown in FIGS. 43-44E, the head portion 1120 has a round surface. However, the head portion 1120 may have a convex surface, a wedge shape with a triangular cross-section, a truncated wedge shape, a square shape, a rectangular shape, any suitable shape and cross-section, or combination of suitable shapes and cross-sections. The head portion 1120 includes an engagement surface 1121 which engages at least one tie wing of a bracket 10 when the tool 1100 is in use. In addition to the engagement surface 1121, the head portion 1120 also includes projections 1151 on each end of the head portion 1120. The projections 1151 engage clips C located aside the tie wings 20 and 21 of the bracket 10. Each of the projections 1151 may be any suitable shape and cross-section or combination of suitable shapes and cross-sections for engaging the clips C. In the embodiment shown in FIGS. 43-44A, the projections 1151 each have a rectangular cross-section, which preferably includes rounded corners. Further, like the head portion 1120, each of the projections 1150 includes an engagement surface 1151 which engages at a retentive clip C when the tool 1100 is in use. The engagement surface 1151 may be a serrated or toothed surface or may include a pad or cushion. The teeth of the engagement surface 1151 may be triangular in cross-section, as shown in FIGS. 44B-C, rectangular in cross-section, as shown in FIGS. 44D-E, or any other suitable shape or cross-section. As a result of the head portion 1120 and the projections 1150, the tool 1100 enables an orthodontist to simultaneously engage both the tie wings 20 and 21 and clips of the bracket 10.

The side arms 1111 and 1112 are connected by a connection bar 1113. Each of the side arms 1111 and 1112 include a first arm portion 1122 and a second arm portion 1123. The first arm portion 1122 extends from a first end of each of the side arms 1111 and 1112 that is connected to the connection bar 1113 to bends 1117 and 1118, located approximately mid-length of each of the side arms 1111 and 1112. The second arm portion 1123 extends from the bend points 1117 and 1118, respectively, to a second end of each of the side arms 1111 and 1112 that is opposite the connection bar 1113. Further, each of the side arms 1111 and 1112 may include include a grasping means for grasping an archwire 30 when the wire disengaging tool 1100 is in use. The grasping means may be a hook or an indentation 1132 in one or both of the side arms 1111 and 1112. Not only does the indentation 1132 aid in grasping an archwire 30, but the indentation 1132 may also act as a positioning means for aligning the archwire 30. In the embodiment shown in FIGS. 43-44E, the indentation 1132 is V-shaped in cross-section. However, the indentation 1132 may be rectangular in cross-section or any other suitable shape that provides for grasping and aligning an archwire. Aside from a hook and the indentation 1132, any other suitable means for grasping and positioning an archwire 30 may be used.

In addition to the first arm portion 1122 and the second arm portion 1123, each of the side arms 1111 and 1112 also includes a third arm portion 1125. Like the second arm portion 1123, the third arm portion 1125 extends from the bends 1117 and 1118, but in a direction opposite the second arm portion 1123. Further, the third arm portion 1125 includes an aligning and grasping means, namely indentation 1132.

The connection bar 1113 and side arms 1111 and 1112 are connected to the center arm 1110 via a side arm control bar 1114, which is pivotally connected to the center arm 1110 at a pivot point 1115. As a result, side arm control bar 1114 and the center arm 1110 form a plier-like handle 1116 that allows an orthodontist to not only grip the tool 1100, but also move the side arms 1111 and 1112 and the center arm 1110 relative to each other. Further, the plier-like handle 1116 preferably extends generally parallel to the head portion 1120.

To use the wire disengagement tool 1100 to disengage and remove an archwire 30 from an archwire slot 26 of an orthodontic bracket 10, an orthodontist moves the two components of the plier-like handle 1116, namely the side arm control bar 1114 and the center arm 1110, apart about the pivot point 1115 to create a space between the center arm 1110 and the side arms 1111 and 1112. The orthodontist then places the tool 1100 against the bracket 10 so that the first arm portion 1122 is adjacent the wire 30 and the second arm portion 1123 of the side arms 1111 and 1112 are positioned underneath the archwire 30, as shown in FIGS. 44, 44B, and 44D. If the orthodontist uses the tool 1100 on an opposite side of the mouth, then the third arm portion 1125, as opposed to the second arm portion 1123, will be positioned beneath the archwire 30.

The orthodontist simultaneously places the center arm 1110 between the tie wings 20 and 21, so that the head portion 1120 of the center arm 1110 engages the upper portions 24 and 25 of the tie wings 20 and 21. In this position, the center arm 1110 is generally perpendicular to the bracket base 12. Further, while in this position, not only does the head portion 1120 of the center arm 1110 engage the tie wings 20 and 21, but the projections 1150 of the head portion 1120 engage the upper portions of flexible side arms C1 and C2 of the clips C on either side of the bracket 10.

Once the orthodontist positions the tool 1100 on the bracket 10, as described above, the orthodontist squeezes the side arm control bar 1114 and the center arm 1110 of the plier-like handle 1116 together, which forces the center arm 1110 downwardly toward the side arms 1111 and 1112 and the archwire slot 26. As a result of the downward force, the projections 1150 of the head portion 1120 creates a wedge-like lateral force against the side arms C1 and C2 of the clips C to cause the arms C1 and C2 to flex laterally and outwardly to create a gap between the arms C1 and C2 of the clips C above the archwire slot 26, which makes the archwire 30 in the archwire slot 26 accessible.

In addition to the forcing the center arm 1110 downwardly, the squeezing of the plier-like handle 1116 concurrently forces the second arm portion 1123 of the side arms 1111 and 1112 upwardly toward the center arm 1110, as shown in FIGS. 44A, 44C, and 44E. Consequently, as the projections 1150 of the head portion 1020 maintain the clips C in flexed, outwardly-extended positions, the second arm portion 1123 of the side arms 1111 and 1112 lift the archwire 30 toward the head portion 1120 so that the archwire 30 is retained in a friction fit between the projections 1150 and the side arms 1111 and 1112. Simultaneous with the application of the force to the handle 1116 to create a scissor-like motion between the center arm 1110 and the side arm control bar 1114, the orthodontist can rotate the handle 1116 to assure the archwire 30 is secured between the projections 1150 and the second arm portion 1123 of the side arms 1111 and 1112. After the archwire 30 is retained between the head portion 1120 and the side arms 1111 and 1112 and the orthodontist rotates the tool 1100 as necessary, the orthodontist can the easily lift the archwire 30 vertically from the archwire slot 26 through the space between the side arms C1 and C2 of the clips C created by the projections 1150 of the head portion 1120 of the center arm 1110.

The foregoing description of the present invention has been presented to illustrate the principles of the invention and not to limit the invention to the particular embodiments illustrated. It is intended that the scope of the invention be defined by all of the embodiments encompassed within claims and their equivalents.

I claim:

1. An orthodontic instrument for removing an archwire retained in an archwire slot of an orthodontic bracket having a bracket base and at least one retentive component including at least one pair of retentive portions that are normally not spaced relative to one another a distance as great as at least a cross-sectional dimension of the archwire such that the retentive portions function to prevent removal of the archwire from the archwire slot, the instrument comprising:
a head portion extending from a handle and being designed to engage at least one of the retentive portions of the at least one retentive component of the orthodontic bracket;
at least one side arm carried by a handle and including at least one portion for engaging the archwire positioned within the archwire slot when said head portion is in engagement with the at least one retentive portion; and
said handle being positioned relative to the head portion and said at least one side arm so as to enable a user to engage the head portion against the at least one retentive portion of the bracket so that when the user applies a force to said handle, said head portion creates a force against the at least one retentive portion to create an enlarged gap between the at least one pair of retentive portions and said at least one side arm simultaneously engages and lifts the archwire outwardly of the archwire slot and between the enlarged gap created between the retentive portions so that the archwire can be removed from the orthodontic bracket.

2. The orthodontic instrument of claim 1, wherein said at least one side arm is designed to be placed between the archwire and the base of the bracket so that the archwire is supported between said head portion and said at least one side arm when the archwire is removed from the orthodontic bracket.

3. The orthodontic instrument of claim 1, wherein said handle includes a first component attached to said head portion and a second component attached to said at least one side arm and pivotally connected to said first component so that the orthodontic instruments acts in a plier-like manner.

4. The orthodontic instrument of claim 1, further comprising another side arm located adjacent said head portion on a side opposite said at least one side arm, wherein said at least one side arm is a first side arm and said another side arm is a second side arm.

5. The orthodontic instrument of claim 1, wherein said at least one side arm includes a grasping means for grasping the archwire.

6. The orthodontic instrument of claim 1, wherein said at least one side arm includes an aligning means for aligning the archwire relative to the retentive component.

7. The orthodontic instrument of claim 1, wherein said head portion is split into at least two pieces.

8. The orthodontic instrument of claim 1, wherein said head portion of said head portion includes an engagement surface for engaging the at least one retentive component of the bracket.

9. The orthodontic instrument of claim 8, wherein said engagement surface is concave.

10. The orthodontic instrument of claim 8, wherein said engagement surface is convex.

11. The orthodontic instrument of claim 8, wherein said engagement surface is round.

12. The orthodontic instrument of claim 8, wherein said engagement surface has a truncated wedge shape.

13. The orthodontic instrument of claim 8, wherein said engagement surface is generally rectangular in cross-section.

14. The orthodontic instrument of claim 13, wherein said engagement surface has generally rounded corners.

15. The orthodontic instrument of claim 1, wherein said head portion includes a projection on either end of said head portion, said projection having an engagement surface for engaging the at least one retentive component of the bracket.

16. The orthodontic instrument of claim 15, wherein said engagement surface is serrated.

17. The orthodontic instrument of claim 1, wherein the head portion includes at least one area of increased thickness.

18. The orthodontic instrument of claim 1, wherein at least one of said first and second side arms includes a first arm portion and a second arm portion connected to said first arm portion.

19. The orthodontic instrument of claim 18, wherein at least one of said first and second side arms further includes a third arm portion connected to said first arm portion and extending in a direction substantially opposite of said second arm portion.

20. The orthodontic instrument of claim 1, wherein the head portion is attached to a center arm, said head portion extending transversely from said center arm, said center arm extending between said head portion and said handle.

21. The orthodontic instrument of claim 20, wherein said head portion is attached to said center arm via at least one side bar and a connection bar, said at least one side bar extending transversely from said head portion with a first end of said at least one side bar being connected to said head portion near and end of said head portion, and said connection bar being connected to said at least one side bar at a second end of said at least one side bar opposite said first end and transversely extending from said at least one side bar so said connection bar is substantially parallel to said head portion.

22. The orthodontic instrument of claim 21, wherein at least one of said first and second side arms is connected to said handle via a connection bar, said connection extending generally transversely to said at least one side bar and generally parallel to said head portion.

23. The orthodontic instrument of claim 22, wherein said handle includes a first component attached to said connection bar and a second component attached to said at least one side arm and pivotally connected to said first component so that the orthodontic instruments acts in a plier-like manner.

24. The orthodontic instrument of claim 4, wherein said head portion extends between said first and second side arms.

25. The orthodontic instrument of claim 24, wherein at least one of said first and second side arms includes a first arm portion and a second arm portion connected to said first arm portion, wherein said first arm portion is generally straight, and wherein said second arm portion is generally curved.

26. The orthodontic instrument of claim 24, wherein at least one of said first and second side arms is designed to be placed adjacent said archwire when said head portion engages the at least one retentive component so that when a user rotates said handle, the archwire is supported in curve of said second arm portion.

27. The orthodontic instrument of claim 25, wherein at least one of said first and second side arms further includes a third arm portion connected said first arm portion and extending in a direction substantially opposite of said second arm portion, wherein said third arm portion is generally curved.

28. The orthodontic instrument of claim 24, further comprising a pivot bar extending between said first and second side arms, said pivot bar being substantially parallel to said head portion and adapted to rotate in recesses created in upper portions of tie wings of the orthodontic bracket.

29. A method for removing an archwire from an archwire slot of an orthodontic bracket using an instrument having a head portion and at least one arm spaced from the head portion and wherein the bracket includes a bracket base and at least one retentive component, wherein the at least one retentive component includes at least one pair of retentive portions that are normally not spaced relative to one another a distance as great as at least a cross-sectional dimension of the archwire such that the retentive portions function to prevent removal of the archwire from the archwire slot, the method comprising the steps of:
applying a force to the head portion of the instrument to create a gap between the retentive portions of a size to permit the archwire to pass between the retentive portions of the tie wings; and
simultaneously using the at least one arm to lift the archwire from the archwire slot through the gap.

30. The method of claim 29, further comprising the step of:
aligning said archwire with said gap.
